(19) United States
(12) Patent Application Publication
(10) Pub. No.: US 2014/0181943 A1
(43) Pub. Date: Jun. 26, 2014

(54) WIRELESS COMMUNICATION SYSTEM PROVIDED WITH WIRELESS COMMUNICATION TERMINAL APPARATUSES WIRELESSLY CONNECTED UNDER AUTHENTIFICATION

(71) Applicant: PANASONIC CORPORATION, OSAKA (JP)

(72) Inventors: Nobuhiko ARASHIN, Osaka (JP); Akira YAMASAKI, Osaka (JP)

(73) Assignee: PANASONIC CORPORATION, OSAKA (JP)

(21) Appl. No.: 14/193,582

(22) Filed: Feb. 28, 2014

Related U.S. Application Data
(63) Continuation of application No. PCT/JP2013/002547, filed on Apr. 15, 2013.

(30) Foreign Application Priority Data
Aug. 9, 2012 (JP) 2012-177030

(51) Int. Cl. H04W 12/06

(52) U.S. Cl. CPC H04W 12/06
USPC 726/7

(57) ABSTRACT

A first connection control part of a first wireless communication terminal apparatus compares a second network identification information included in a response frame with a first network identification information stored in a first connection information managing part in response to the response frame, and executes an authentication process with a second wireless communication terminal apparatus by using an authentication information stored in the first connection information managing part when a second network identification information included in the response frame is matched with the first network identification information stored in the first connection information managing part, and this leads to establishment of wireless connection with the second wireless communication terminal apparatus by a second communication system.

### CROSS-REFERENCE TO RELATED APPLICATIONS

This is a continuation application based on PCT application No. PCT/JP2013/002547 as filed on Apr. 15, 2013, which claims priority to Japanese patent application No. JP 2012-177030 as filed Aug. 9, 2012, the contents of which are incorporated herein by reference.

### BACKGROUND OF THE DISCLOSURE

1. Field of the Disclosure

This disclosure relates to a wireless communication system, a control method of the wireless communication system, and a wireless communication terminal apparatus, and in particular, to a wireless communication system provided with wireless communication terminal apparatuses which are wirelessly connected with each other under authentication.

2. Description of the Related Art

Conventionally, in a case where a plurality of communication systems and a plurality of communication paths are selectable in performing communications between wireless communication terminal apparatuses in a wireless communication system including a plurality of the wireless communication terminal apparatuses, a technology of switchover to suitable communication system and communication path according to the objective of communications, communication conditions, and the like has been examined. For example, the wireless terminal described in a Patent Document 1 of Japanese patent laid-open publication No. JP 2009-206803 A establishes ad hoc connection only with a specified terminal by using a service set identifier (hereinafter, referred to as an SSID) that has been already registered and a basic service set identifier (hereinafter, referred to as a BSSID) when switching the communication system with the terminal in cellular communications to ad hoc communications, and continues communications.

In general, in order to protect information transmitted and received by wireless communications between wireless communication terminal apparatuses, a connection authentication process and an encryption process are performed between the wireless communication terminal apparatuses at the time of starting wireless communications. In this case, the connection authentication process includes, for example, simplified connection authentication processes such as a connection authentication process accompanied by inputting each setting value by the user and WPS (Wi-Fi Protected Setup). When the communication system for performing communications between wireless communication terminal apparatuses is switched over as described above, it is required to perform the connection authentication process and the encryption process every time the switchover is performed in order to protect the transmitted and received information also after the switchover. Therefore, interruption of communications occurs, and this causes a possibility that the communications cannot be performed at arbitrary timing.

### SUMMARY OF THE DISCLOSURE

One non-limiting and exemplary embodiment is to provide a wireless communication system capable of performing switchover of the communication system more promptly than that of the prior art with the security of information maintained in a manner similar to that before the switchover also after the switchover of the communication system for performing communications between two wireless communication terminal apparatuses.

According to one aspect of the present disclosure, there is provided a wireless communication system including first and second wireless communication terminal apparatuses that are wirelessly connected with each other by one of a predetermined first communication system and a predetermined second communication system, by executing an authentication process by using authentication information for establishing wireless connection. The first wireless communication terminal apparatus includes a first connection information managing part, and a first connection control part. The first connection information managing part is configured to store authentication information used when the first wireless communication terminal apparatus has established wireless connection by the first communication system, and first network identification information of a first network to which the first wireless communication terminal apparatus has belonged when the first wireless communication terminal apparatus has established wireless connection by the first communication system. The first connection control part is configured to establish wireless connection by the second communication system.

The second wireless communication terminal apparatus includes a second connection information managing part, and a second connection control part. The second connection information managing part is configured to store authentication information used when the second wireless communication terminal apparatus has established wireless connection by the first communication system, and second network identification information of a second network to which the second wireless communication terminal apparatus has belonged when the second wireless communication terminal apparatus has established wireless connection by the first communication system. The second connection control part is configured to establish wireless connection by the second communication system. The first connection control part transmits a request frame that is provided for requesting establishment of wireless connection by the second communication system and includes the first network identification information, to the second wireless communication terminal apparatus. The second connection control part transmits a response frame including the second network identification information, to the first wireless communication terminal apparatus in response to the request frame.

The first connection control part compares the second network identification information included in the response frame with the first network identification information stored in the first connection information managing part in response to the response frame, and executes an authentication process with the second wireless communication terminal apparatus by using the authentication information stored in the first connection information managing part when the second network identification information included in the response frame is matched with the first network identification information stored in the first connection information managing part, thereby establishing wireless connection with the second wireless communication terminal apparatus by the second communication system.

According to the wireless communication system according to the present disclosure, the communication system can be switched over more promptly than that of the prior art with the security of information maintained in a manner similar to that before the switchover also after the switchover of the communication system for performing communications between two wireless communication terminal apparatuses.

### BRIEF DESCRIPTION OF THE DRAWINGS

These and other objects and features of the present invention will become clear from the following description taken in conjunction with the embodiments thereof with reference to the accompanying drawings throughout which like parts are designated by like reference numerals, and in which:

FIG. 1 is a block diagram showing a configuration of a wireless communication system according to a first embodiment of the present disclosure;

FIG. 2 is a table showing an authentication information set in the access point apparatus 1 of FIG. 1 and the BSSID of the access point apparatus 1;

FIG. 3 is a block diagram showing a configuration of the wireless communication terminal apparatuses 2a and 2b of FIG. 1;

FIG. 4A is a flow chart showing a first portion of the communication system switchover request process executed, by the WiGig connection control part 9 of the wireless communication terminal apparatus 2a of FIG. 3 when the wireless communication terminal apparatus 2a requests the wireless communication terminal apparatus 2b to perform switchover of the communication system for performing data communications between the wireless communication terminal apparatuses 2a and 2b from the Wi-Fi system to the WiGig system in the wireless communication system of FIG. 1;

FIG. 4B is a flow chart showing a second portion of the communication system switchover request process executed by the WiGig connection control part 9 of the wireless communication terminal apparatus 2a of FIG. 3 when the wireless communication terminal apparatus 2a requests the wireless communication terminal apparatus 2b to perform switchover of the communication system for performing data communications between the wireless communication terminal apparatuses 2a and 2b from the Wi-Fi system to the WiGig system in the wireless communication system of FIG. 1;

FIG. 5A is a flow chart showing a first portion of the communication system switchover request process executed by the WiGig connection control part 9 of the wireless communication terminal apparatus 2b of FIG. 3 when the wireless communication terminal apparatus 2a requests the wireless communication terminal apparatus 2b to perform switchover of the communication system for performing data communications between the wireless communication terminal apparatuses 2a and 2b from the Wi-Fi system to the WiGig system in the wireless communication system of FIG. 1;

FIG. 5B is a flow chart showing a second portion of the communication system switchover request process executed by the WiGig connection control part 9 of the wireless communication terminal apparatus 2b of FIG. 3 when the wireless communication terminal apparatus 2a requests the wireless communication terminal apparatus 2b to perform switchover of the communication system for performing data communications between the wireless communication terminal apparatuses 2a and 2b from the Wi-Fi system to the WiGig system in the wireless communication system of FIG. 1;

FIG. 6 is a format chart showing a format of a group owner negotiation request frame 100 transmitted at steps S5 and S6 of FIG. 4A;

FIG. 7 is a table showing a format of the network identification information field F1 of FIG. 6;

FIG. 8 is a format chart showing a format of a group owner negotiation response frame 200 transmitted at steps S26 and S27 of FIG. 5A;

FIG. 9 is a table showing a format of the network identification information field F2 of FIG. 8;

FIG. 10 is a format chart showing a format of a group owner negotiation confirmation frame 300 transmitted at steps S9 and S11 of FIG. 4B;

FIG. 11 is a table showing a format of the comparing results field F3 of FIG. 10;

FIG. 12 is a timing chart showing one example of the operation of the wireless communication system of FIG. 1;

FIG. 13A is a flow chart showing a first portion of the communication system switchover request process executed by the WiGig connection control part 9 of the wireless communication terminal apparatus 2a of FIG. 3 according to a second embodiment of the present disclosure when the wireless communication terminal apparatus 2a requests the wireless communication terminal apparatus 2b to perform switchover of the communication system for performing data communications between the wireless communication terminal apparatuses 2a and 2b from the Wi-Fi system to the WiGig system in the wireless communication system of FIG. 1;

FIG. 13B is a flow chart showing a second portion of the communication system switchover request process executed by the WiGig connection control part 9 of the wireless communication terminal apparatus 2a of FIG. 3 according to the second embodiment of the present disclosure when the wireless communication terminal apparatus 2a requests the wireless communication terminal apparatus 2b to perform switchover of the communication system for performing data communications between the wireless communication terminal apparatuses 2a and 2b from the Wi-Fi system to the WiGig system in the wireless communication system of FIG. 1;

FIG. 14A is a flow chart showing a first portion of the communication system switchover response process executed by the WiGig connection control part 9 of the wireless communication terminal apparatus 2b of FIG. 3 according to the second embodiment of the present disclosure when the wireless communication terminal apparatus 2a requests the wireless communication terminal apparatus 2b to perform switchover of the communication system for performing data communications between the wireless communication terminal apparatuses 2a and 2b from the Wi-Fi system to the WiGig system in the wireless communication system of FIG. 1;

FIG. 14B is a flow chart showing a second portion of the communication system switchover response process executed by the WiGig connection control part 9 of the wireless communication terminal apparatus 2b of FIG. 3 according to the second embodiment of the present disclosure when the wireless communication terminal apparatus 2a requests the wireless communication terminal apparatus 2b to perform switchover of the communication system for performing data communications between the wireless communication terminal apparatuses 2a and 2b from the Wi-Fi system to the WiGig system in the wireless communication system of FIG. 1;

FIG. 15 is a format chart showing a format of the probe request frame 400 transmitted at steps S42 and S43 of FIG. 13A;

FIG. 16 is a table showing a format of the network identification information field F4 of FIG. 15;

FIG. 17 is a format chart showing a format of the probe response frame 500 transmitted at steps S54 and S55 of FIG. 14A;

FIG. 18 is a table showing a format of the network identification information field F5 of FIG. 17;

FIG. 19 is a timing chart showing one example of the operation of the wireless communication system of FIG. 1 according to the second embodiment;

FIG. 20 is a block diagram showing a configuration of a wireless communication system according to a third embodiment of the present disclosure;

FIG. 21 is a block diagram showing a configuration of the wireless communication terminal apparatuses 52a and 52b of FIG. 20;

FIG. 22 is a table showing one example of a list of authentication information identifiers, authentication information and BSSIDs stored in the Wi-Fi connection list information managing part 14A of the wireless communication terminal apparatus 52a of FIG. 21, and magic values calculated by the magic value calculator part 62 of the wireless communication terminal apparatus 52a of FIG. 21;

FIG. 23 is a table showing one example of a list of authentication information identifiers, authentication information and BSSIDs stored in the Wi-Fi connection list information managing part 14A of the wireless communication terminal apparatus 52b of FIG. 21, and magic values calculated by the magic value calculator part 62 of the wireless communication terminal apparatus 52b of FIG. 21;

FIG. 24 is a format chart showing a storing method of the authentication information into the Wi-Fi connection list information managing part 14A of FIG. 21;

FIG. 25A is a flow chart showing a first portion of the communication system switchover request process executed by the WiGig connection control part 59 of the wireless communication terminal apparatus 52a of FIG. 21 when the wireless communication terminal apparatus 52a requests the wireless communication terminal apparatus 52b to perform switchover of the communication system for performing data communications between the wireless communication terminal apparatuses 52a and 52b from the Wi-Fi system to the WiGig system in the wireless communication system of FIG. 20;

FIG. 25B is a flow chart showing a second portion of the communication system switchover request process executed by the WiGig connection control part 59 of the wireless communication terminal apparatus 52a of FIG. 21 when the wireless communication terminal apparatus 52a requests the wireless communication terminal apparatus 52b to perform switchover of the communication system for performing data communications between the wireless communication terminal apparatuses 52a and 52b from the Wi-Fi system to the WiGig system in the wireless communication system of FIG. 20;

FIG. 26A is a flow chart showing a first portion of the communication system switchover response process executed by the WiGig connection control part 59 of the wireless communication terminal apparatus 52b of FIG. 21 when the wireless communication terminal apparatus 52a requests the wireless communication terminal apparatus 52b to perform switchover of the communication system for performing data communications between the wireless communication terminal apparatuses 52a and 52b from the Wi-Fi system to the WiGig system in the wireless communication system of FIG. 20;

FIG. 26B is a flow chart showing a second portion of the communication system switchover request process executed by the WiGig connection control part 59 of the wireless communication terminal apparatus 52b of FIG. 21 when the wireless communication terminal apparatus 52a requests the wireless communication terminal apparatus 52b to perform switchover of the communication system for performing data communications between the wireless communication terminal apparatuses 52a and 52b from the Wi-Fi system to the WiGig system in the wireless communication system of FIG. 20;

FIG. 27 is a format chart showing a format of the group owner negotiation request frame 100A transmitted at step S62 of FIG. 25A;

FIG. 28 is a table showing a format of the network identification information field F6 of FIG. 27;

FIG. 29 is a format chart showing a format of the group owner negotiation response frame 200A transmitted at step S73 of FIG. 26A;

FIG. 30 is a table showing a format of the network identification information field F7 of FIG. 29;

FIG. 31 is a format chart showing a format of the group owner negotiation confirmation frame 300A transmitted at steps S66 and S68 of FIG. 25B;

FIG. 32 is a table showing a format of the comparing results field F8 of FIG. 31;

FIG. 33 is a timing chart showing one example of the operation of the wireless communication system of FIG. 20;

FIG. 34A is a flow chart showing a first portion of the communication system switchover request process executed by the WiGig connection control part 59 of the wireless communication terminal apparatus 52a of FIG. 21 according to a fourth embodiment of the present disclosure when the wireless communication terminal apparatus 52a requests the wireless communication terminal apparatus 52b to perform switchover of the communication system for performing data communications between the wireless communication terminal apparatuses 52a and 52b from the Wi-Fi system to the WiGig system in the wireless communication system of FIG. 20;

FIG. 34B is a flow chart showing a second portion of the communication system switchover request process executed by the WiGig connection control part 59 of the wireless communication terminal apparatus 52a of FIG. 21 according to the fourth embodiment of the present disclosure when the wireless communication terminal apparatus 52a requests the wireless communication terminal apparatus 52b to perform switchover of the communication system for performing data communications between the wireless communication terminal apparatuses 52a and 52b from the Wi-Fi system to the WiGig system in the wireless communication system of FIG. 20;

FIG. 35A is a flow chart showing a first portion of the communication system switchover response process executed by the WiGig connection control part 59 of the wireless communication terminal apparatus 52b of FIG. 21 according to the fourth embodiment of the present disclosure when the wireless communication terminal apparatus 52a requests the wireless communication terminal apparatus 52b to perform switchover of the communication system for performing data communications between the wireless communication terminal apparatuses 2a and 2b from the Wi-Fi system to the WiGig system in the wireless communication system of FIG. 20;

FIG. 35B is a flow chart showing a second portion of the communication system switchover response process executed by the WiGig connection control part 59 of the wireless communication terminal apparatus 52b of FIG. 21 according to the fourth embodiment of the present disclosure when the wireless communication terminal apparatus 52a requests the wireless communication terminal apparatus 52b to perform switchover of the communication system for performing data communications between the wireless communication terminal apparatuses 52a and 52b from the Wi-Fi system to the WiGig system in the wireless communication system of FIG. 20;

FIG. 36 is a format chart showing a format of the probe request frame 400A transmitted at step S82 of FIG. 34A;

FIG. 37 is a table showing a format of the network identification information field F9 of FIG. 36;

FIG. 38 is a table showing a format of a probe response frame 500A transmitted at step S93 of FIG. 35A;

FIG. 39 is a table showing a format of the network identification information field F10 of FIG. 38; and

FIG. 40 is a timing chart showing one example of the operation of the wireless communication system of FIG. 20 according to the fourth embodiment.

### DETAILED DESCRIPTION OF THE EMBODIMENTS

Embodiments will be described below arbitrarily with reference to the drawings. It is noted that detailed descriptions more than necessary are sometimes omitted. For example, it is sometimes the case where detailed descriptions of well-known matters and repetitive descriptions for substantially identical configurations are omitted. This is to prevent the following description from becoming unnecessarily redundant and to facilitate easy understanding by those skilled in the art.

The inventor and others provide the accompanying drawings and the following description for sufficient understanding of the present disclosure by those skilled in the art, and do not intend to limit the subjects described in the claims for patent by them.

### First Embodiment

### Configuration of Wireless Communication System

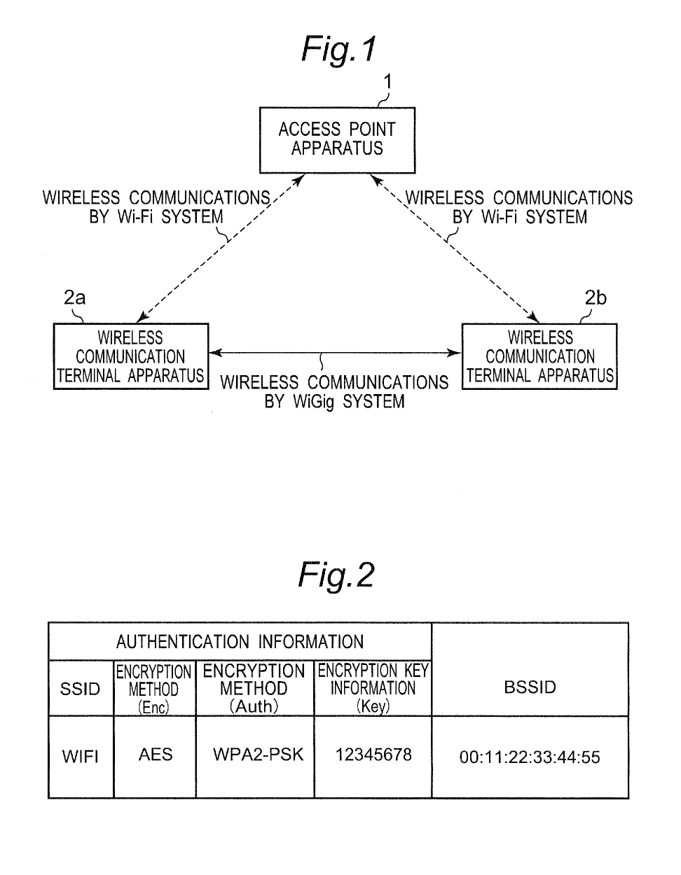

FIG. 1 is a block diagram showing a configuration of a wireless communication system according to the first embodiment of the present disclosure. Referring to FIG. 1, the wireless communication system of the present disclosure is configured to include wireless communication terminal apparatuses 2a and 2b. In this case, the wireless communication terminal apparatuses 2a and 2b perform wireless communications compliant to the wireless LAN standard IEEE802.11 with an access point apparatus 1 connected to a backbone network such as Ethernet (registered trademark). Moreover, in the present embodiment, the wireless communication terminal apparatuses 2a and 2b are wirelessly connected with each other by using the communication system of either one of the following the Wi-Fi system and the WiGig system, and perform data communications.

### (A) Wi-Fi System

The Wi-Fi system is, for example, a wireless communication system using a microwave frequency band (hereinafter referred to as an OBand (Omni directional Band)) of 36 channels in the 2.4-GHz band. In the present disclosure, for example, a wireless communication system compliant to IEEE802.11n standardized by the Wi-Fi Alliance is used as the wireless communication system of the Wi-Fi system. When the wireless communication terminal apparatuses 2a and 2b perform data communications by the Wi-Fi system, each of the wireless communication terminal apparatuses 2a and 2b executes a predetermined authentication information acquiring process in the beginning to acquire authentication information preset in the access point apparatus 1 and BSSID that is the identification information of the wireless network provided by the access point apparatus 1. The BSSID is concretely the MAC address of the access point apparatus 1.

FIG. 2 is a table showing an authentication information set in the access point apparatus 1 of FIG. 1 and the BSSID of the access point apparatus 1. Referring to FIG. 2, the authentication information includes SSID that is the identifier of the access point apparatus 1, an encryption method to encrypt data, and encryption key information distributed through a key distribution process (also referred to as a key exchange process) to distribute an encryption key. In the example of FIG. 2, the SSID is WIFI, and the encryption method is AES (Advanced Encryption Standard). The authentication method is WPA2-PSK (Wi-Fi Protected Access 2 Pre-Shared Key), the key information is 12345678, and the BSSID is 00:11:22:33:44:55. The access point apparatus 1 and the wireless communication terminal apparatus 2a execute an authentication process compliant to, for example, IEEE802.11i for the access point apparatus 1 to authenticate the wireless communication terminal apparatus 2a by using the authentication information of FIG. 2, and a key distribution process compliant to, for example, IEEE802.11i for sharing an encryption key between the access point apparatus 1 and the wireless communication terminal apparatus 2a to establish wireless connection subsequently to the authentication information acquiring process. Moreover, the access point apparatus 1 and the wireless communication terminal apparatus 2b execute an authentication process compliant to, for example, IEEE802.11i for the access point apparatus 1 to authenticate the wireless communication terminal apparatus 2b by using the authentication information of FIG. 2, and a key distribution process compliant to, for example, IEEE802.11i for sharing an encryption key between the access point apparatus 1 and the wireless communication terminal apparatus 2b to establish wireless connection subsequently to the authentication information acquiring process. By this operation, the wireless communication terminal apparatuses 2a and 2b are wirelessly connected with each other by the Wi-Fi system via the access point apparatus 1. Hereinafter, the authentication information and the BSSID of FIG. 2 are collectively referred to as connection information.

The wireless communication terminal apparatus 2a is connected to the Internet via the access point apparatus 1 when wirelessly connected to the access point apparatus 1. Moreover, in order to transmit data to the wireless communication terminal apparatus 2b, the wireless communication terminal apparatus 2a transmits the data not to the wireless communication terminal apparatus 2b but to the access point apparatus 1. The data from the wireless communication terminal apparatus 2a is relayed by the access point apparatus 1, and wirelessly transmitted to the wireless communication terminal apparatus 2b. Therefore, a twofold band is necessary when the data is transmitted by the Wi-Fi system from the wireless communication terminal apparatus 2a to the wireless communication terminal apparatus 2b as compared with the case where the data is directly transmitted from the wireless communication terminal apparatus 2a to the wireless communication terminal apparatus 2b. Moreover, when the wireless communication terminal apparatuses 2a and 2b are served under the domination of the common access point apparatus 1 and included in an identical wireless network, the wireless communication terminal apparatuses 2a and 2b are connected to the access point apparatus 1 by using identical authentication information.

### (B) WiGig System

The WiGig system is a wireless communication system using a millimeter wave band (hereinafter referred to as a DBand (Directional Band)). In the present disclosure, a wireless communication system compliant to, for example, IEEE802.11ad standardized by the Wireless Gigabit Alliance is used as the wireless communication system of the WiGig system. When the wireless communication terminal apparatuses 2a and 2b perform data communications by the WiGig system, the wireless communication terminal apparatuses 2a and 2b execute an authentication process and a key distribution process by using authentication information having a configuration similar to that of the authentication information of FIG. 2 to establish wireless connection. It is noted that a method for acquiring the authentication information is described later. Moreover, in the present embodiment, according to the communications by the WiGig system, the wireless communication terminal apparatus 2a operates as a client apparatus in WPS, and the wireless communication terminal apparatus 2b operates as a group owner apparatus corresponding to the access point apparatus and a registrar apparatus in WPS. According to the wireless communications by the WiGig system, the wireless communication terminal apparatus 2a directly transmits data to the wireless communication terminal apparatus 2b, and the wireless communication terminal apparatus 2b directly transmits data to the wireless communication terminal apparatus 2a. In this case, the access point apparatus 1 does not mediate in the data communications between the wireless communication terminal apparatuses 2a and 2b.

According to the WiGig system using the DBand, data communications can be performed at a speed higher than the speed by the Wi-Fi system using the OBand. Therefore, the user can perform proper use of utilizing the Wi-Fi system when performing ordinary data communications such as Internet communications and utilizing the WiGig system when performing data communications at a higher speed.

### Configuration of Wireless Communication Terminal Apparatuses 2a and 2b

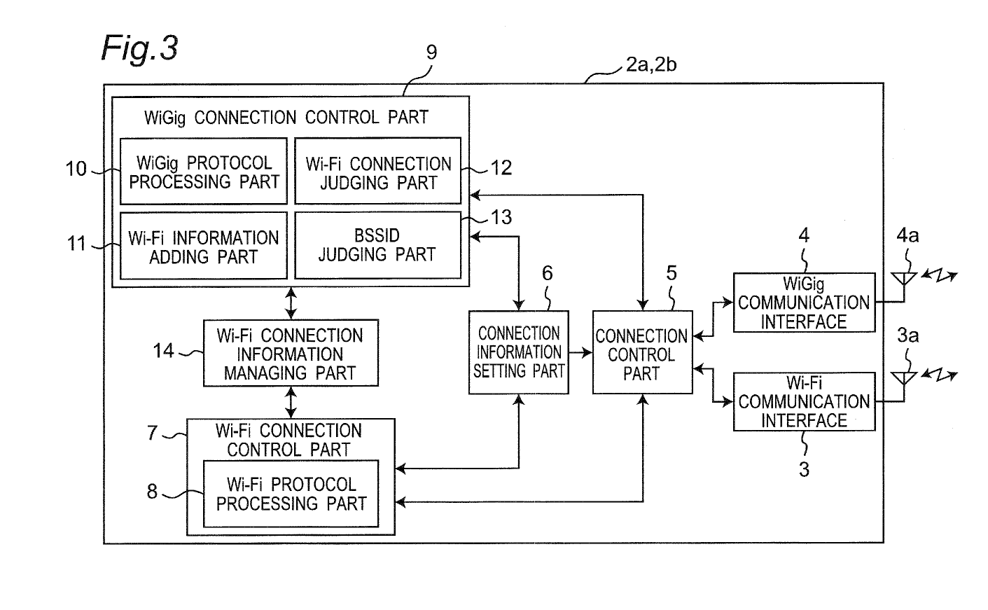

FIG. 3 is a block diagram showing a configuration of the wireless communication terminal apparatuses 2a and 2b of FIG. 1. It is noted that the wireless communication terminal apparatuses 2a and 2b have the same function and configuration as each other as shown in FIG. 3. Therefore, the function and configuration of the wireless communication terminal apparatus 2a are only described with reference to FIG. 3. Referring to FIG. 3, the wireless communication terminal apparatus 2a is configured to include a Wi-Fi communication interface 3, a WiGig communication interface 4, a connection control part 5, a connection information setting part 6, a Wi-Fi connection control part 7 including a Wi-Fi protocol processing part 8, a WiGig connection control part 9, and a Wi-Fi connection information managing part 14. Further, the WiGig connection control part 9 is configured to include a WiGig protocol processing part 10, a Wi-Fi information adding part 11, a Wi-Fi connection judging part 12, and a BSSID judging part 13.

The functions of the Wi-Fi connection control part 7, the Wi-Fi protocol processing part 8, the WiGig connection control part 9, the WiGig protocol processing part 10, the Wi-Fi information adding part 11, the Wi-Fi connection judging part 12 and the BSSID judging part 13 are implemented by executing an application software program corresponding to each of the functions by a CPU (Central Processing Unit) or a DSP (Digital Signal Processor) or providing a hardware logic circuit such as an FPGA (Field-Programmable Gate Array) to execute calculations corresponding to each of the functions. Moreover, the connection information setting part 6 and the Wi-Fi connection information managing part 14 are implemented by a hardware apparatus such as a memory or a hard disk for recording and holding information. It is noted that arbitrary components of the parts 5 to 14 of the wireless communication terminal apparatuses 2a and 2b may be implemented by hardware.

The Wi-Fi communication interface 3 is a wireless communication circuit for physically performing wireless communications by the Wi-Fi system under the control of the connection control part 5, and is configured to include an antenna 3a and a high-frequency circuit connected to the antenna 3a. The Wi-Fi communication interface 3 receives a communication frame transmitted by the Wi-Fi system by using the antenna 3a, executes a predetermined interfacing process for the received communication frame, and outputs the resultant processed frame to the Wi-Fi protocol processing part 8 via the connection control part 5. Moreover, the Wi-Fi communication interface 3 performs a predetermined interfacing process for the communication frame from the Wi-Fi protocol processing part 8, and transmits the resultant processed frame by using the antenna 3a.

The WiGig communication interface 4 is a wireless communication circuit for physically performing wireless communications by the WiGig system under the control of the connection control part 5, and is configured to include an antenna 4a and a high-frequency circuit connected to the antenna 4a. The WiGig communication interface 4 receives a communication frame transmitted by the WiGig system by using the antenna 4a, performs a predetermined interfacing process for the received communication frame, and outputs the resultant processed frame to the WiGig protocol processing part 10 via the connection control part 5. Moreover, the WiGig communication interface 4 performs a predetermined interfacing process for the communication frame from the WiGig protocol processing part 10, and transmits the resultant processed frame by using the antenna 4a.

The Wi-Fi connection control part 7 receives the authentication information and the BSSID for establishing wireless connection by the Wi-Fi system from the access point apparatus 1 via the Wi-Fi communication interface 3 and the connection control part 5, and stores the same received authentication information and BSSID into the Wi-Fi connection information managing part 14 and the connection information setting part 6. In this case, when authentication information and a BSSID have been already stored in the Wi-Fi connection information managing part 14, the Wi-Fi connection control part 7 deletes the stored authentication information and BSSID in the beginning. Further, the Wi-Fi connection control part 7 controls the connection control part 5 to perform wireless communications by using the connection information (authentication information and BSSID) stored in the connection information setting part 6 by the Wi-Fi communication interface 3. Moreover, the Wi-Fi protocol processing part 8 generates a communication frame to be transmitted according to the communication protocol compliant to the Wi-Fi system, and outputs the same communication frame to the Wi-Fi communication interface 3 via the connection control part 5. Further, the Wi-Fi protocol processing part 8 executes a predetermined process such as a frame analysis process conforming to the communication protocol compliant to the Wi-Fi system for the communication frame inputted from the Wi-Fi communication interface 3 via the connection control part 5.

The Wi-Fi connection information managing part 14 receives the authentication information and BSSID for establishing wireless connection by the Wi-Fi system from the Wi-Fi connection control part 7, and stores the same received authentication information and BSSID. Moreover, the connection information setting part 6 receives and holds the connection information (authentication information and BSSID) to be used in the connection control part 5 from the Wi-Fi connection control part 7 or the WiGig connection control part 9, and outputs the held connection information to the connection control part 5 according to a request from the connection control part 5.

The WiGig connection control part 9 outputs the authentication information and BSSID for establishing wireless connection by the WiGig system to the connection information setting part 6. Further, the WiGig connection control part 9 controls the connection control part 5 to perform wireless communications by using the connection information (authentication information and BSSID) stored in the connection information setting part 6 by the WiGig communication interface 4. Moreover, the WiGig protocol processing part 10 generates a communication frame to be transmitted according to a communication protocol compliant to the WiGig system, and outputs the same communication frame to the WiGig communication interface 4 via the connection control part 5. Further, the WiGig protocol processing part 10 executes a predetermined process such as a frame analysis process conforming to the communication protocol compliant to the WiGig system for the communication frame inputted from the WiGig communication interface 4 via the connection control part 5.

The Wi-Fi information adding part 11 sets the BSSID of the access point apparatus 1 stored in the Wi-Fi connection information managing part 14 into the network identification information field F1 of a group owner negotiation request (GO (Group Owner) Negotiation Request) frame 100 described in detail later, and wirelessly transmits the same by using the WiGig communication interface 4. Moreover, the Wi-Fi connection judging part 12 judges whether or not the wireless communication terminal apparatus 2a has already established wireless communications by the Wi-Fi system before establishing wireless connection of the WiGig system. Further, the BSSID judging part 13 judges whether or not the BSSID set in the network identification information field F2 of a group owner negotiation response (GO (Group Owner) Negotiation Response) frame 200 described in detail later is matched with the BSSID stored in the Wi-Fi connection information managing part 14.

Process for Switchover of Communication System for Data Communications from Wi-Fi System to WiGig System

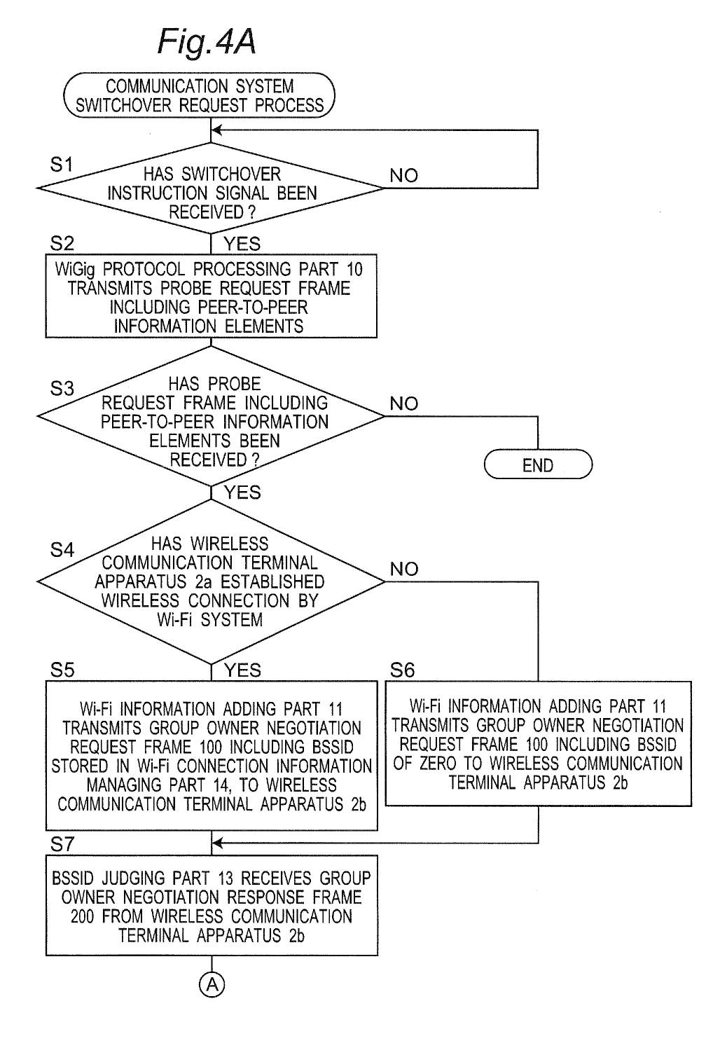

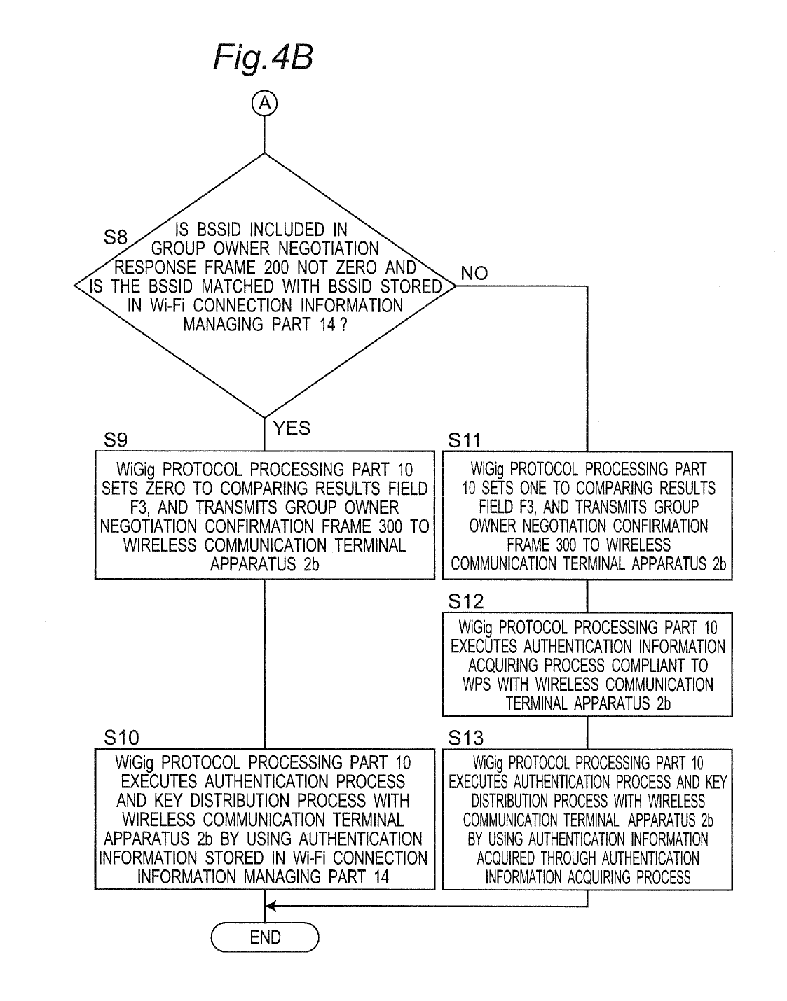

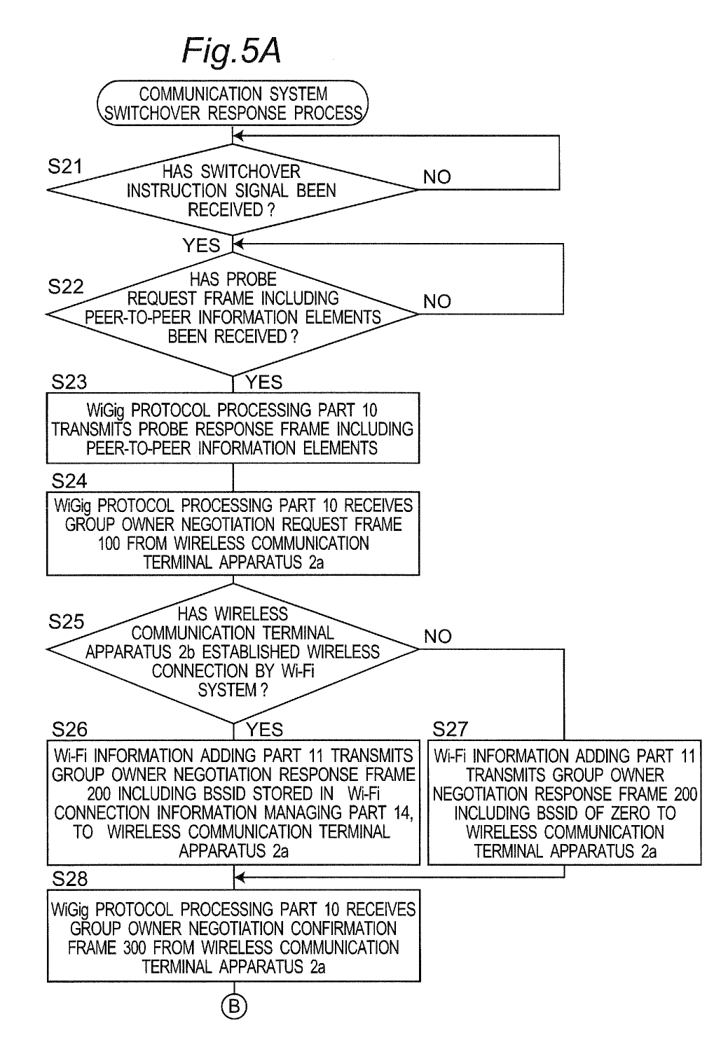

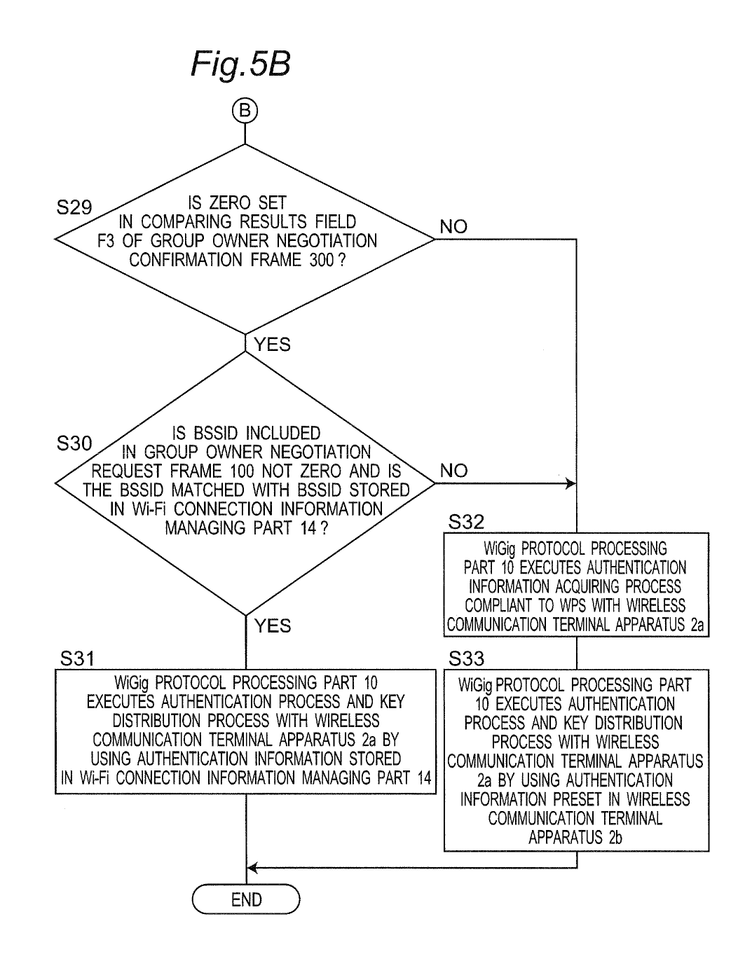

When the wireless communication terminal apparatus 2a requests the wireless communication terminal apparatus 2b to perform switchover of the communication system for performing data communications between the wireless communication terminal apparatuses 2a and 2b from the Wi-Fi system to the WiGig system in the wireless communication system of FIG. 1, a communication system switchover request process executed by the WiGig connection control part 9 of the wireless communication terminal apparatus 2a of FIG. 3 is described with reference to FIGS. 4A and 4B, and a communication system switchover response process executed by the WiGig connection control part 9 of the wireless communication terminal apparatus 2b of FIG. 3 is described with reference to FIGS. 5A and 5B. It is noted that the communication system switchover request process of FIGS. 4A and 4B, and the communication system switchover response process of FIGS. 5A and 5B are executed by using a communication protocol compliant to Wi-Fi Direct planned by the Wi-Fi Alliance.

FIGS. 4A and 4B are flow charts showing a communication system switchover request process executed by the WiGig connection control part 9 of the wireless communication terminal apparatus 2a of FIG. 3. In the beginning, the WiGig connection control part 9 judges at step S1 of FIG. 4A whether or not a switchover instruction signal to instruct switchover of the communication system for performing data communications with the wireless communication terminal apparatus 2b to the WiGig system has been received. In concrete, the WiGig connection control part 9 judges whether or not the switchover instruction signal from the application software executed inside the wireless communication terminal apparatus 2a or a switchover instruction signal inputted by predetermined operation by the user of the wireless communication terminal apparatus 2a has been received. The control flow proceeds to step S2 when the answer is YES at step S1 or the process of step S1 is repetitively executed when the answer is NO.

At step S2, the WiGig protocol processing part 10 transmits a probe request frame to retrieve the wireless communication terminal apparatus capable of performing wireless communications by the WiGig system via the connection control part 5 and the WiGig communication interface 4. In this case, the probe request frame includes peer-to-peer (P2P) information elements, that are the information elements indicating that the wireless communication terminal apparatus 2a can directly communicate with another wireless communication terminal apparatus. It is noted that the wireless communication terminal apparatus, which has received the probe request frame including the peer-to-peer information elements, transmits a probe response frame including the peer-to-peer information elements (Peer-to-Peer (P2P) Information Elements) when it can directly communicate with another wireless communication terminal apparatus according to Wi-Fi Direct.

Next, the WiGig protocol processing part 10 judges at step S3 whether or not the probe response frame including the peer-to-peer information elements has been received via the WiGig communication interface 4 and the connection control part 5 within a predetermined period. The control flow proceeds to step S4 when the answer is YES at step S3 or ends the communication system switchover request process when the answer is NO. It is noted that the answer is judged to be YES at step S3 when the wireless communication terminal apparatus 2a receives the probe response frame including the peer-to-peer information elements from the wireless communication terminal apparatus 2b in the present embodiment. The Wi-Fi connection judging part 12 judges at step S4 whether or not the wireless communication terminal apparatus 2a has established wireless connection by the Wi-Fi system by judging whether or not the authentication information and BSSID for establishing wireless connection with another wireless communication terminal apparatus by the Wi-Fi system are stored in the Wi-Fi connection information managing part 14. Then, the control flow proceeds to step S5 when the answer is YES at step S4 or proceeds to step S6 when the answer is NO. At step S5, the Wi-Fi information adding part 11 transmits a group owner negotiation request frame 100 including the BSSID stored in the Wi-Fi connection information managing part 14, to the wireless communication terminal apparatus 2b via the connection information control part 5 and the WiGig communication interface 4. In concrete, the Wi-Fi information adding part 11 sets the BSSID stored in the Wi-Fi connection information managing part 14 into the network identification information field F1 of the group owner negotiation request frame 100 generated by the WiGig protocol processing part 10. Since the wireless communication terminal apparatus 2a is wirelessly connected to the access point apparatus 1 in the present embodiment, the BSSID stored in the Wi-Fi connection information managing part 14 of the wireless communication terminal apparatus 2a is the BSSID of the access point apparatus 1. The format of the group owner negotiation request frame 100 is described in detail later.

On the other hand, at step S6, the Wi-Fi information adding part 11 transmits the group owner negotiation request frame 100 including BSSID of zero to the wireless communication terminal apparatus 2b via the connection information control part 5 and the WiGig communication interface 4.

As described in detail later, the wireless communication terminal apparatus 2b transmits a group owner negotiation response frame 200 to the wireless communication terminal apparatus 2a in response to the group owner negotiation request frame 100. In this case, when the wireless communication terminal apparatus 2b has established wireless connection by the Wi-Fi system, the group owner negotiation response frame 200 includes the BSSID stored in the Wi-Fi connection information managing part 14 of the wireless communication terminal apparatus 2b. When the wireless communication terminal apparatus 2b has not established wireless connection by the Wi-Fi system, the group owner negotiation response frame 200 includes BSSID of 0.

Subsequently to steps S5 and S6, the BSSID judging part 13 receives at step S7 the group owner negotiation response frame 200 from the wireless communication terminal apparatus 2b via the WiGig communication interface 4 and the connection control part 5. Next, the BSSID judging part 13 judges at step S8 of FIG. 4B whether or not the BSSID included in the group owner negotiation response frame 200 is not zero and is matched with the BSSID stored in the Wi-Fi connection information managing part 14. Then, the control flow proceeds to step S9 when the answer is YES at step S8 or proceeds to step S11 when the answer is NO. It is noted that the control flow proceeds to step S11 also when the judging process cannot be executed at step S8.

At step S9, the WiGig protocol processing part 10 sets a value of zero indicating that the two BSSIDs are matched with each other at step S8 into the comparing results field F3 of a group owner negotiation confirm (GO (Group Owner) Negotiation Confirm) frame 300 described in detail later, and transmits the group owner negotiation confirmation frame 300 to the wireless communication terminal apparatus 2b via the connection control part 5 and the WiGig communication interface 4. The format of the group owner negotiation confirmation frame 300 is described in detail later.

At step S10 subsequent to step S9, the WiGig protocol processing part 10 executes the authentication process and the key distribution process with the wireless communication terminal apparatus 2b by using the authentication information stored in the Wi-Fi connection information managing part 14, and ends the communication system switchover request process.

On the other hand, at step S11, the WiGig protocol processing part 10 sets a value of 1 indicating that the two BSSIDs are not matched with each other at step S8 into the comparing results field F3 of the group owner negotiation confirmation frame 300, and transmits the group owner negotiation confirmation frame 300 to the wireless communication terminal apparatus 2b via the connection control part 5 and the WiGig communication interface 4.

At step S12 subsequent to step S11, the WiGig protocol processing part 10 executes an authentication information acquisition information process compliant to WPS with the wireless communication terminal apparatus 2b. At this time, the WiGig connection control part 9 of the wireless communication terminal apparatus 2a acquires, for example, the authentication information shown in FIG. 2 from the wireless communication terminal apparatus 2b that operates as a registrar apparatus in WPS. Next, when the authentication information acquiring process normally ends, the WiGig protocol processing part 10 executes at step S 13 the authentication process and the key distribution process with the wireless communication terminals 2b by using the authentication information acquired through the authentication information acquiring process, and ends the communication system switchover request process.

FIGS. 5A and 5B are flow charts showing a communication system switchover response process executed by the WiGig connection control part 9 of the wireless communication terminal apparatus 2b of FIG. 3. In the beginning, the WiGig connection control part 9 judges at step S21 of FIG. 5A whether or not a switchover instruction signal indicating the switchover to the WiGig system for performing data communications with the wireless communication terminal apparatus 2b has been received. The process at step S21 is similar to the process at step S1 of FIG. 4A. The control flow proceeds to step S22 when the answer is YES at step S21 or the process of step S21 is repetitively executed when the answer is NO.

The WiGig protocol processing part 10 judges at step S22 whether or not a probe request frame including the peer-to-peer information elements has been received via the WiGig communication interface 4 and the connection control part 5. The control flow proceeds to step S23 when the answer is YES or the process of step S22 is repetitively executed when the answer is NO. At step S23, the WiGig protocol processing part 10 transmits a probe response frame including the peer-to-peer information elements indicating the possibility of directly communicating with another wireless communication terminal apparatus via the connection control part 5 and the WiGig communication interface 4. Next, at step S24, the WiGig protocol processing part 10 receives the group owner negotiation request frame 100 from the wireless communication terminal apparatus 2a.

At step S25 subsequent to step S24, the Wi-Fi connection judging part 12 judges whether or not the wireless communication terminal apparatus 2b has established wireless connection by the Wi-Fi system by judging whether or not the authentication information and the BSSID for establishing wireless connection with another wireless communication terminal apparatus by the Wi-Fi system are stored in the Wi-Fi connection information managing part 14. Then, the control flow proceeds to step S26 when the answer is YES at step S54 or proceeds to step S27 when the answer is NO. It is noted that the process at step S25 is similar to the process at step S4 of FIG. 4A.

At step S26, the Wi-Fi information adding part 11 transmits the group owner negotiation response frame 200 including the BSSID stored in the Wi-Fi connection information managing part 14 to the wireless communication terminal apparatus 2a via the connection information control part 5 and the WiGig communication interface 4. In concrete, the Wi-Fi information adding part 11 sets the BSSID stored in the Wi-Fi connection information managing part 14 into the network identification information field F2 of the group owner negotiation response frame 200 generated by the WiGig protocol processing part 10. Since the wireless communication terminal apparatus 2b is wirelessly connected to the access point apparatus 1 in the present embodiment, the BSSID stored in the Wi-Fi connection information managing part 14 of the wireless communication terminal apparatus 2b is the BSSID of the access point apparatus 1.

On the other hand, at step S27, the Wi-Fi information adding part 11 transmits the group owner negotiation response frame 200 including BSSID of zero to the wireless communication terminal apparatus 2a via the connection information control part 5 and the WiGig communication interface 4.

At step S28 subsequent to steps S26 and S27, the WiGig protocol processing part 10 receives the group owner negotiation confirmation frame 300 from the wireless communication terminal apparatus 2a via the WiGig communication interface 4 and the connection control part 5. Next, the WiGig protocol processing part 10 judges at step S29 whether or not zero is set in the comparing results field F3 of the group owner negotiation confirmation frame 300. The control flow proceeds to step S30 when the answer is YES or proceeds to step S32 when the answer is NO. The BSSID judging part 13 judges at step S30 whether or not the BSSID included in the group owner negotiation request frame 100 is not zero and is matched with the BSSID stored in the Wi-Fi connection information managing part 14. Then, the control flow proceeds to step S31 when the answer is YES at step S30 or proceeds to step S32 when the answer is NO.

At step S31, the WiGig protocol processing part 10 executes the authentication process and the key distribution process with the wireless communication terminal apparatus 2a by using the authentication information stored in the Wi-Fi connection information managing part 14, and ends the communication system switchover response process. In concrete, the WiGig protocol processing part 10 executes the authentication process and the key distribution process by the connection control part 5 and the WiGig communication interface 4 by using the authentication information outputted to the connection information setting part 6 after outputting the authentication information stored in the Wi-Fi connection information managing part 14 to the connection information setting part 6. At this time, the WiGig connection control part 9 operates the wireless communication terminal apparatus 2b as a group owner apparatus, and accepts a request for connection from the wireless communication terminal apparatus 2a.

On the other hand, at step S32, the WiGig protocol processing part 10 executes an authentication information acquiring process compliant to WPS with the wireless communication terminal apparatus 2a. By this operation, the WiGig connection control part 9 transmits the authentication information preset in the wireless communication terminal apparatus 2b to the wireless communication terminal apparatus 2a that operates as a client apparatus in WPS. Next, at step S33, the WiGig protocol processing part 10 executes the authentication process and the key distribution process with the wireless communication terminals 2a by using the authentication information preset in the wireless communication terminal apparatus 2b, and ends the communication system switchover response process.

### Format of Group Owner Negotiation Request Frame 100

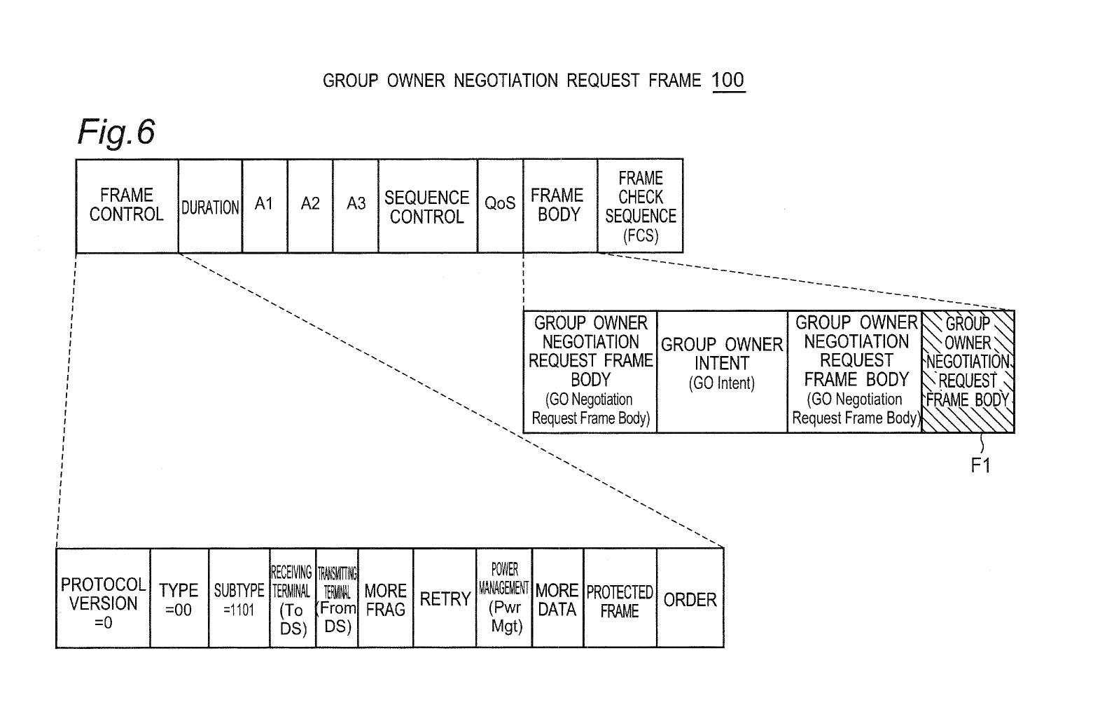

FIG. 6 is a format chart showing a format of the group owner negotiation request frame 100 transmitted at steps S5 and S6 of FIG. 4A. The group owner negotiation request frame 100 has such a configuration that the network identification information field F1 is added to the tail of the same frame body field of the group owner negotiation request frame compliant to Wi-Fi Direct.

Referring to FIG. 6, the group owner negotiation request frame 100 includes a frame control (Frame Control) field, a duration (Duration) field, an A1 field, an A2 field, an A3 field, a sequence control (Sequence Control) field, a QoS field, a frame body (Frame Body) field, and a frame check sequences (Frame Check Sequence (FCS)) field.

The frame control field stores data for identifying the category of the group owner negotiation request frame 100. In this case, the frame control field includes a protocol version (Protocol Version) field, a type (Type) field, a subtypes (SubType) field, a receiving terminal (ToDS) field, a transmitting terminal (FromDS) field, a moreflag (MoreFrag) field, a retry (Retry) field, a power management (PowerMgt) field, a more data (More Data) field, a protected frame (Protected Frame) field, and an order (Order) field.

Into the protocol version field is set a number of zero that is the version of the group owner negotiation request frame 100. Moreover, a value indicating the type of the group owner negotiation request frame 100 is set to the type field, and a value indicating that a more detailed type is set to the subtype field. In concrete, 00 indicating that the management frame is set to the type field of the group owner negotiation request frame 100, and 1101 indicating that the action (Action) frame is set to the subtype field.

Data indicating which of the access point apparatus and the wireless communication terminal apparatus receives the data frame is set to the receiving terminal field. Moreover, data indicating which of the access point apparatus and the wireless communication terminal apparatus has transmitted the data frame is set to the transmitting terminal field. Moreover, the more flag field is used when the packet of the higher-level layer is dividedly transmitted. Further, data indicating whether or not the group owner negotiation request frame 100 is a retransmission frame is set to the retry field. Data indicating the presence or absence of a subsequent packet awaiting to be transmitted is set to the more data field. Then, data indicating the presence or absence of encryption is set to the protected frame field, and data indicating whether or not the class of the group owner negotiation request frame 100 is a strict ordered service class is set to the order field.

Moreover, data indicating the scheduled duration during which the wireless line is used is set to the duration field, and a destination MAC address of the communication frame, a source MAC address and a BSSID are set to the A1 field, the A2 field and the A3 field, respectively. Moreover, a sequence number of the communication frame and the fragment number for fragment are set to the sequence control field. Further, data indicating the quality of the communication frame of priority control and the like is set to the QoS field, and the MAC header of the communication frame and the error-detecting code of the frame body are set in the frame check sequence field.

The transmission data is stored into the frame body field. The frame body field of the group owner negotiation request frame 100 includes a group owner negotiation request frame body field and a network identification information field F1. In this case, predetermined transmission data including a group owner intent (GO Intent) is set to the group owner negotiation request frame body field. The group owner intent is a parameter for determining the group owner apparatus in peer-to-peer communications such as wireless communication of the WiGig system, and is preset every wireless communication terminal apparatus. In the present embodiment, the group owner intent of the wireless communication terminal apparatus 2b is smaller than the group owner intent of the wireless communication terminal apparatus 2a. In this case, the wireless communication apparatus 2b operates as a group owner apparatus in the wireless communications of the WiGig system with the wireless communication terminal apparatus 2a.

The BSSID stored in the Wi-Fi connection information managing part 14 of the source wireless communication terminal apparatus 2a of the group owner negotiation request frame 100 is set to the network identification information field F1. In the present embodiment, the BSSID stored in the Wi-Fi connection information managing part 14 of the wireless communication terminal apparatus 2a is the BSSID of the access point apparatus 1 to which the wireless communication terminal apparatus 2a is connected by the Wi-Fi system.

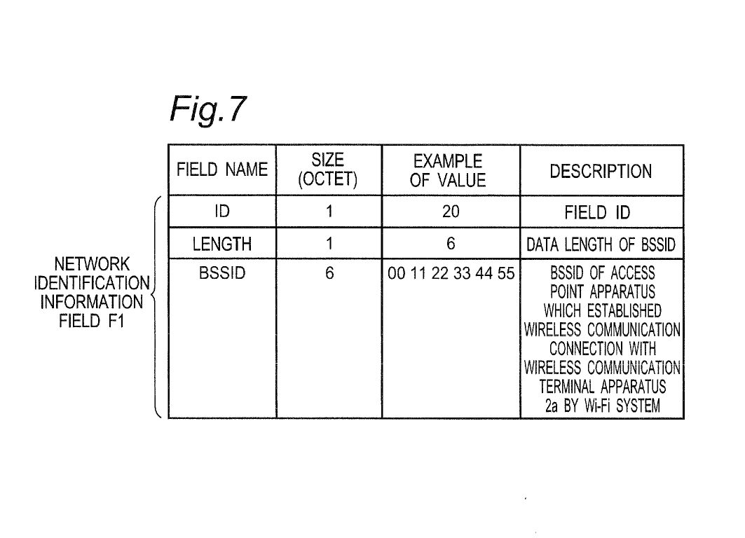

FIG. 7 is a table showing a format of the network identification information field F1 of FIG. 6. Referring to FIG. 7, the network identification information field F1 includes an ID field, a length field, and a BSSID field. In this case, a number of 20 that is the identifier of the network identification information field F1 is set to the ID field. Moreover, the data length (six bytes) of the BSSID field is set to the length field, and a value corresponding to the BSSID of the access point apparatus that has established wireless connection by the Wi-Fi system with the wireless communication terminal apparatus 2a is set to the BSSID field. Since the wireless communication terminal apparatus 2a has established wireless connection by the Wi-Fi system with the access point apparatus 1 in the present embodiment, a value (00 11 22 33 44 55) corresponding to the BSSID of the access point apparatus 1 is set to the BSSID field.

As described above, the group owner negotiation request frame 100 includes the BSSID of the access point apparatus 1 corresponding to the identification information of the wireless network to which the wireless communication terminal apparatus 2a belongs.

### Format of Group Owner Negotiation Response Frame 200

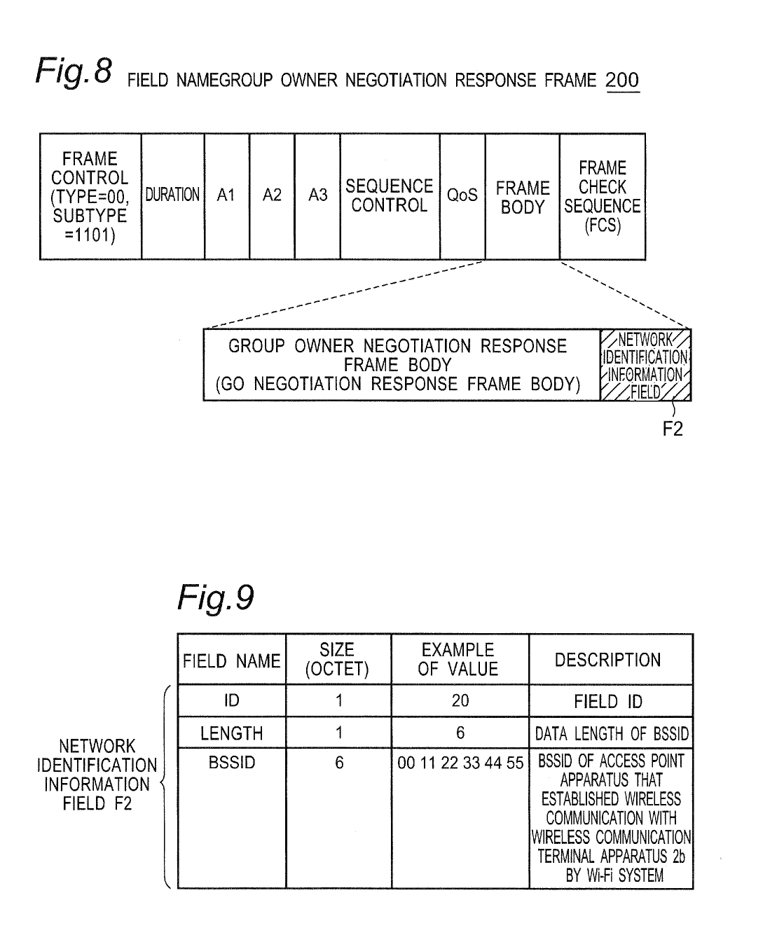

FIG. 8 is a format chart showing a format of the group owner negotiation response frame 200 transmitted at steps S26 and S27 of FIG. 5A. The group owner negotiation response frame 200 has such a configuration that the network identification information field F2 is added to the tail of the frame body field of the group owner negotiation request frame compliant to Wi-Fi Direct.

Referring to FIG. 8, the group owner negotiation response frame 200 includes a frame control field, a duration field, an A1 field, an A2 field, an A3 field, a sequence control field, a QoS field, a frame body field, and a frame check sequence field. The frame control field, the duration field, the A1 field, the A2 field, the A3 field, the sequence control field, the QoS field, and the frame check sequence field of the group owner negotiation response frame 200 are configured in a manner similar to that of the frame control field, the duration field, the A1 field, the A2 field, the A3 field, the sequence control field, the QoS field, and the frame check sequence field of the group owner negotiation request frame 100, and therefore, no description is provided for them.

Referring to FIG. 8, the frame body field of the group owner negotiation response frame 200 includes a group owner negotiation response frame body field into which predetermined transmission data is set, and a network identification information field F2. The BSSID stored in the Wi-Fi connection information managing part 14 of the source wireless communication terminal apparatus 2b of the group owner negotiation response frame 200 is set to the network identification information field F2. In the present embodiment, the BSSID stored in the Wi-Fi connection information managing part 14 of the wireless communication terminal apparatus 2b is the BSSID of the access point apparatus 1 to which the wireless communication terminal apparatus 2b is wirelessly connected by the Wi-Fi system.

FIG. 9 is a table showing a format of the network identification information field F2 of FIG. 8. Referring to FIG. 9, the network identification information field F2 includes an ID field, a length field, and a BSSID field. In this case, a number of 20 that is the identifier of the network identification information field F2 is set to the ID field. Moreover, the data length (six bytes) of the BSSID field is set to the length field, and a value corresponding to the BSSID of the access point apparatus that has established wireless connection by the Wi-Fi system with the wireless communication terminal apparatus 2b is set to the BSSID field. Since the wireless communication terminal apparatus 2b has established wireless connection by the Wi-Fi system with the access point apparatus 1 in the present embodiment, the value (00 11 22 33 44 55) corresponding to the BSSID of the access point apparatus 1 is set to the BSSID field.

As described above, the group owner negotiation response frame 200 includes the BSSID of the access point apparatus 1 corresponding to the identification information of the wireless network to which the wireless communication terminal apparatus 2b belongs.

### Format of Group Owner Negotiation Confirmation Frame 300

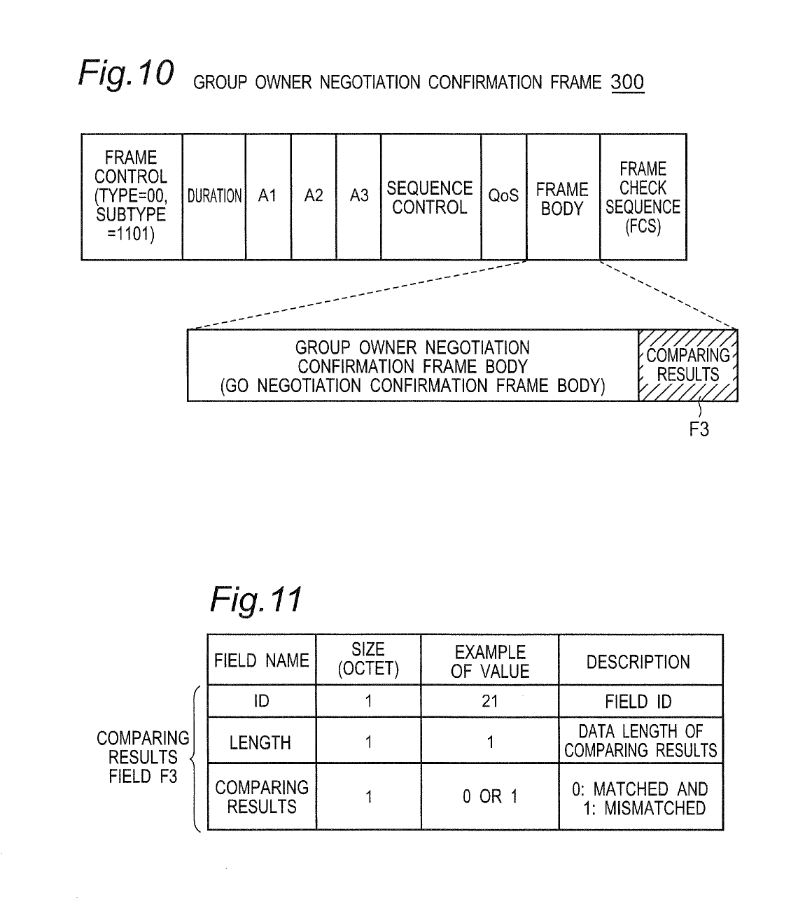

FIG. 10 is a format chart showing a format of the group owner negotiation confirmation frame 300 transmitted at steps S9 and S11 of FIG. 4B. The group owner negotiation confirmation frame 300 has such a configuration that the comparing results field F3 is added to the tail of the frame body field of the group owner negotiation confirmation frame compliant to Wi-Fi Direct.

Referring to FIG. 10, the group owner negotiation confirmation frame 300 includes a frame control field, a duration field, an A1 field, an A2 field, an A3 field, a sequence control field, a QoS field, a frame body field, and a frame check sequence field. The frame control field, the duration field, the A1 field, the A2 field, the A3 field, the sequence control field, the QoS field, and the frame check sequence field of the group owner negotiation continuation frame 300 are configured in a manner similar to that of the frame control field, the duration field, the A1 field, the A2 field, the A3 field, the sequence control field, the QoS field, and the frame check sequence field of the group owner negotiation request frame 100, and therefore, no description is provided for them.

Referring to FIG. 10, the frame body field of the group owner negotiation confirmation frame 300 includes a group owner negotiation confirmation frame body field into which predetermined transmission data is set, and the comparing results field F3.

FIG. 11 is a table showing a format of the comparing results field F3 of FIG. 10. Referring to FIG. 11, the comparing results field F3 includes an ID field, a length field, and comparing results field. In this case, a number of 21 that is the identifier of the comparing results field F3 is set to the ID field. Moreover, the data length (one byte) of the comparing results field is set to the length field, and data indicating the comparing results of the BSSID stored in the Wi-Fi connection information managing part 14 of the wireless communication terminal apparatus 2a with the BSSID included in the group owner negotiation response frame 200 is set to the comparing results field. In concrete, a number of zero is set when the BSSID stored in the Wi-Fi connection information managing part 14 of the wireless communication terminal apparatus 2a is matched with the BSSID included in the group owner negotiation response frame 200 or a number of 1 is set when they are not matched with each other.

As described above, the group owner negotiation confirmation frame 300 includes the data indicating that the comparing results of the BSSID of the access point apparatus 1 that is included in the group owner negotiation response frame 200 and corresponds to the identification information of the wireless network to which the wireless communication terminal apparatus 2b belongs with the BSSID of the access point apparatus 1 corresponding to the identification information of the wireless network to which the wireless communication terminal apparatus 2a belongs.

### Operation Example of Wireless Communication System

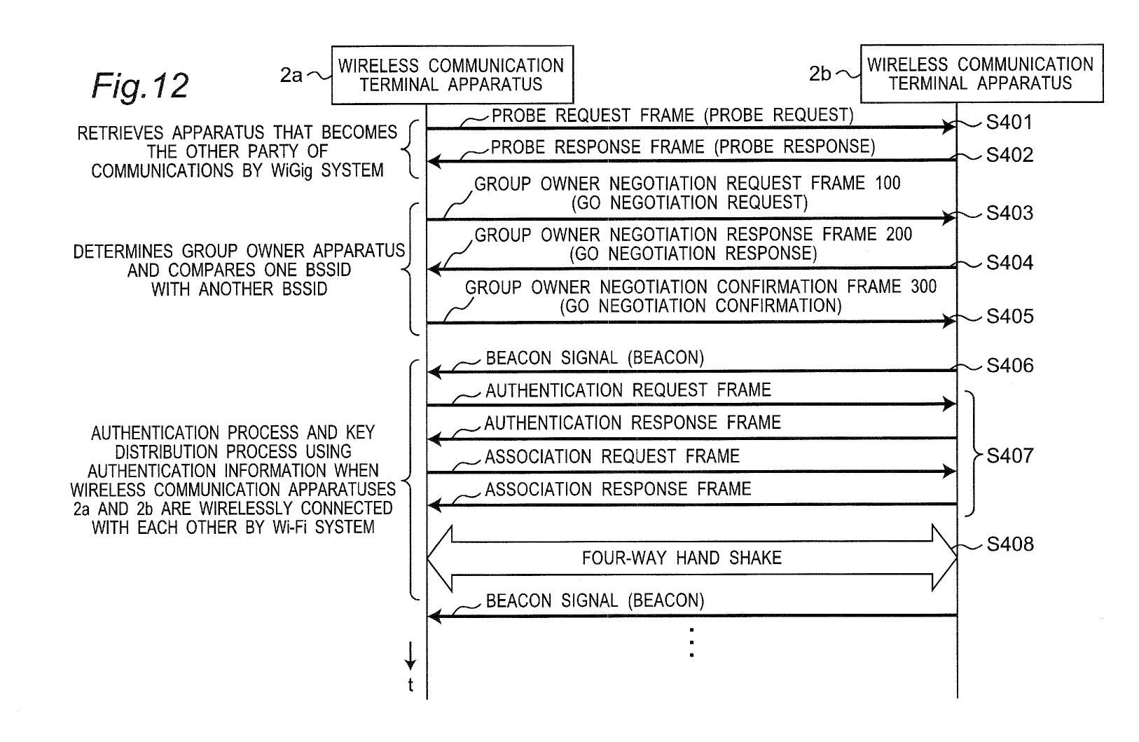

FIG. 12 is a timing chart showing one example of the operation of the wireless communication system of FIG. 1. At step S401, the wireless communication terminal apparatus 2a transmits a probe request frame including the peer-to-peer information elements in order to retrieve the apparatus that becomes the other party of communications by the WiGig system. In response to this, the wireless communication terminal apparatus 2b transmits a probe response frame including the peer-to-peer information elements at step S402.

Next, at step S403, the wireless communication terminal apparatus 2a transmits the group owner negotiation request frame 100 including the BSSID of the access point apparatus 1 to which the wireless communication terminal apparatus 2a is wirelessly connected by the Wi-Fi system to the wireless communication terminal apparatus 2b in response to the probe response frame including the peer-to-peer information elements. In response to this, the wireless communication terminal apparatus 2b transmits the group owner negotiation response frame 200 including the BSSID of the access point apparatus 1 to which the wireless communication terminal apparatus 2b is wirelessly connected by the Wi-Fi system to the wireless communication terminal apparatus 2a at step S404.

Next, at step S405, the wireless communication terminal apparatus 2a compares the BSSID stored in the Wi-Fi connection information managing part 14 of the wireless communication terminal apparatus 2a with the BSSID included in the group owner negotiation response frame 200, and transmits the group owner negotiation confirmation frame 300 including the comparing results to the wireless communication terminal apparatus 2b. In the operation example of FIG. 12, as shown in, for example, FIGS. 7 and 9, the BSSID stored in the Wi-Fi connection information managing part 14 of the wireless communication terminal apparatus 2a is matched with the BSSID included in the group owner negotiation response frame 200. Moreover, the wireless communication terminal apparatus 2b operates as a group owner apparatus.

Next, at step S406, the wireless communication terminal apparatus 2b serving as the group owner apparatus transmits a Beacon signal by the wireless communication of the WiGig system to the wireless communication terminal apparatus 2a. In this case, the Beacon signal includes the connection information that has been acquired through the authentication information acquiring process by the wireless communication of the Wi-Fi system, and stored in the Wi-Fi connection information managing part 14 of the wireless communication terminal apparatus 2b.

Further, at step S407, the wireless communication apparatuses 2a and 2b execute the authentication process compliant to IEEE802.11i for authenticating the wireless communication terminal apparatus 2a without executing the prior art authentication information acquiring process such as WPS. In concrete, the wireless communication terminal apparatus 2a transmits an authentication request frame to request authentication to the wireless communication terminal apparatus 2b by using the authentication information included in the Beacon signal. In response to this, the wireless communication terminal apparatus 2b authenticates the wireless communication terminal apparatus 2a, and transmits an authentication response frame to the wireless communication terminal apparatus 2a. Next, the wireless communication terminal apparatus 2a transmits an association request frame to request the wireless communication terminal apparatus 2b to establish wireless connection to the wireless communication terminal apparatus 2b. In response to this, the wireless communication terminal apparatus 2b receives the request from the wireless communication terminal apparatus 2a, and transmits an association response frame to the wireless communication terminal apparatus 2a.

Next, at step S408, the wireless communication terminal apparatuses 2a and 2b execute, for example, four-way handshake that is a key distribution process compliant to IEEE802.11i for sharing an encryption key between the access point apparatus 1 and the wireless communication terminal apparatus 2a. In this case, the wireless communication terminal apparatuses 2a and 2b use the authentication information when wirelessly connected to the access point apparatus 1 by the Wi-Fi system. When the four-way handshake ends, the wireless communication terminal apparatuses 2a and 2b encrypt transmission data to be able to perform wireless transceiving.

As described above, the wireless communication system of the present disclosure is configured to include the wireless communication terminal apparatuses 2a and 2b that are wirelessly connected with each other by the Wi-Fi system or the WiGig system by executing the authentication process by using the authentication information for establishing wireless connection. In this case, the wireless communication terminal apparatus 2a is configured to include the Wi-Fi connection information managing part 14 that sores the authentication information used when the wireless communication terminal apparatus 2a have established wireless connection by the Wi-Fi system, and the first network identification information of the first network to which the wireless communication terminal apparatus 2a has belonged when the wireless communication terminal apparatus 2a have established wireless connection by the Wi-Fi system, and the WiGig connection control part 9 that establishes wireless connection by the WiGig system. Moreover, the wireless communication terminal apparatus 2b is configured to include the Wi-Fi connection information managing part 14 that sores the authentication information used when the wireless communication terminal apparatus 2b have established wireless connection by the Wi-Fi system, and the second network identification information of the second network to which the wireless communication terminal apparatus 2b has belonged when the wireless communication terminal apparatus 2b have established wireless connection by the Wi-Fi system, and the WiGig connection control part 9 that establishes wireless connection by the WiGig system.

The WiGig connection control part 9 of the wireless communication terminal apparatus 2a transmits the group owner negotiation request frame 100 that requests establishing wireless connection by the WiGig system and includes the first network identification information to the wireless communication terminal apparatus 2b. The WiGig connection control part 9 of the wireless communication terminal apparatus 2b transmits the group owner negotiation response frame 200 including the second network identification information to the wireless communication terminal apparatus 2a in response to the group owner negotiation request frame 100.

The WiGig connection control part 9 of the wireless communication terminal apparatus 2a compares the second network identification information included in the group owner negotiation response frame 200 with the first network identification information stored in the Wi-Fi connection information managing part 14 of the wireless communication terminal apparatus 2a in response to the group owner negotiation response frame 200, and executes the authentication process with the wireless communication terminal apparatus 2b by using the authentication information stored in the Wi-Fi connection information managing part 14 of the wireless communication terminal apparatus 2a when the second network identification information included in the group owner negotiation response frame 200 is matched with the first network identification information stored in the Wi-Fi connection information managing part 14 of the wireless communication terminal apparatus 2a, and establishes wireless connection with the wireless communication terminal apparatus 2b by the WiGig system.

Moreover, the WiGig connection control part 9 of the wireless communication terminal apparatus 2a acquires the authentication information for establishing wireless connection with the wireless communication terminal apparatus 2b by the WiGig system by executing a predetermined authentication information acquiring process such as WPS when the second network identification information included in the group owner negotiation response frame 200 is not matched with the first network identification information stored in the Wi-Fi connection information managing part 14 of the wireless communication terminal apparatus 2a, and executes the authentication with the wireless communication terminal apparatus 2b by using the acquired authentication information.

Further, the WiGig connection control part 9 of the wireless communication terminal apparatus 2a transmits a confirmation frame that includes the comparing results between the second network identification information included in the group owner negotiation response frame 200 and the first network identification information stored in the Wi-Fi connection information managing part 14 of the wireless communication terminal apparatus 2a to the wireless communication terminal apparatus 2b.

Furthermore, the group owner negotiation request frame 100 is a group owner negotiation request frame compliant to Wi-Fi Direct. Moreover, the group owner negotiation response frame 200 is a group owner negotiation response frame compliant to Wi-Fi Direct. Further, the group owner negotiation confirmation frame 300 is a group owner negotiation confirmation frame compliant to Wi-Fi Direct.

Moreover, the authentication information includes a service set identifier, an encryption method, an authentication method, and encryption key information.

Further, the frequency band used by the Wi-Fi system and the frequency band used by the WiGig system are different from each other.

Furthermore, the Wi-Fi system is a communication system by which the wireless communication terminal apparatuses 2a and 2b perform wireless communications via the access point apparatus 1, and the WiGig system is the WiGig system by which the wireless communication terminal apparatus 2a nor 2b perform wireless communications without via the access point apparatus 1. In this case, the network identification information is the BSSID of the access point apparatus 1.

Therefore, according to the wireless communication system of the present embodiment, the wireless communication terminal apparatuses 2a and 2b use the authentication information acquired when connected to the access point apparatus 1 by the Wi-Fi system when wirelessly connected with each other by the Wi-Fi system via the access point apparatus 1 for the authentication process and the key distribution process for establishing wireless connection by the WiGig system. Therefore, the wireless communication terminal apparatuses 2a and 2b need not execute a process for matching the authentication information acquiring process such as WPS and the encryption method of a comparatively large data processing amount before starting the wireless communication by the WiGig system. Therefore, also after the communication system for performing communications between the wireless communication terminal apparatuses 2a and 2b is switched over to the WiGig system, the communication system can be switched over more promptly than that of the prior art with the security and confidentiality of information maintained in a manner similar to that before the switchover.

Although the judging process at step S21 of FIG. 5A is executed in the present embodiment, the present disclosure is not limited to this. It is acceptable to execute the process at step S22 regardless of whether or not the wireless communication terminal apparatus 2b has received the switchover instruction signal without executing the judging process at step S21. Moreover, although the wireless communication terminal apparatus 2a sets the number of zero into the network identification information field F1 of the group owner negotiation request frame 100 when wireless connection has not been established by the Wi-Fi system in the present embodiment, the present disclosure is not limited to this. The value of a BSSID that does not actually exist other than the number of zero may be set to the network identification information field F1 of the group owner negotiation request frame 100. Moreover, the network identification information field F1 may be deleted from the group owner negotiation request frame 100. That is, it is proper to transmit the group owner negotiation request frame 100 indicating that no wireless connection has been established by the Wi-Fi system.

Further, although the wireless communication terminal apparatus 2b sets the number of zero into the network identification information field F2 of the group owner negotiation response frame 200 when wireless connection has not been established by the Wi-Fi system in the present embodiment, the present disclosure is not limited to this. The value of a BSSID that does not actually exist other than the number of zero may be set to the network identification information field F2 of the group owner negotiation response frame 200. Moreover, the network identification information field F2 may be deleted from the group owner negotiation response frame 200. That is, it is proper to transmit the group owner negotiation response frame 200 indicating that no wireless connection has been established by the Wi-Fi system.

Furthermore, although the process at step S30 of FIG. 5B is executed in the present embodiment, the present disclosure is not limited to this. Since the process at step S8 of FIG. 4B is executed in the wireless communication terminal apparatus 2a, the process at step S30 may be omitted.

Moreover, although the probe request frame, the probe response frame, the group owner negotiation request frame 100, the group owner negotiation response frame 200 and the group owner negotiation confirmation frame 300 are transmitted by using the DBand through the wireless communications of the WiGig system in the present embodiment, the present disclosure is not limited to this, and they may be transmitted by using the OBand.

Further, in the present embodiment, the group owner negotiation request frame 100 is generated by adding the network identification information field F1 to the group owner negotiation request frame compliant to Wi-Fi Direct. Moreover, the group owner negotiation response frame 200 is generated by adding the network identification information field F2 to the group owner negotiation response frame compliant to Wi-Fi Direct. However, the present disclosure is not limited to this, and the group owner negotiation request frame 100 is required to include the BSSID of the access point apparatus 1 corresponding to the identification information of the wireless network to which the wireless communication terminal apparatus 2a belongs. Moreover, the group owner negotiation response frame 200 is required to include the BSSID of the access point apparatus 1 corresponding to the identification information of the wireless network to which the wireless communication terminal apparatus 2b belongs.

Furthermore, in the present embodiment, the group owner negotiation confirmation frame 300 is generated by adding the network comparing results field F3 to the group owner negotiation confirmation frame compliant to Wi-Fi Direct. However, the present disclosure is not limited to this. The group owner negotiation confirmation frame 300 is required to include the data indicating whether or not the BSSID of the access point apparatus 1 corresponding to the identification information of the wireless network to which the wireless communication terminal apparatus 2a belongs is matched with the BSSID of the access point apparatus 1 corresponding to the identification information of the wireless network which is included in the group owner negotiation response frame 200 and to which the wireless communication terminal apparatus 2b belongs.

Furthermore, although the communication system switchover request process of FIGS. 4A and 4B and the communication system switchover response process of FIGS. 5A and 5B are executed by using the communication protocol compliant to Wi-Fi Direct in the present embodiment, the present disclosure is not limited to this.

Moreover, although it is judged whether or not the authentication information used in the wireless communications by the Wi-Fi system can be used in the wireless communications by the WiGig system by judging whether or not the BSSID stored in the Wi-Fi connection information managing parts 14 of the wireless communication terminal apparatuses 2a and 2b are matched with each other in the present embodiment, the present disclosure is not limited to this. It is acceptable to judge whether or not the authentication information used in the wireless communications by the Wi-Fi system can be used in the wireless communications by the WiGig system by judging whether or not the identification information of the network to which the wireless communication terminal apparatus 2a belongs is matched with the identification information of the network to which the wireless communication terminal apparatus 2b belongs.

Further, although the authentication information used for the wireless communications in the Wi-Fi format is entirely used for the wireless communications in the WiGig format in the present embodiment, the present disclosure is not limited to this, and part of the authentication information used for the wireless communications in the Wi-Fi format may be used for the wireless communications in the WiGig format. For example, it is acceptable to use only the encryption key information of the authentication information used for the wireless communications in the Wi-Fi format for the wireless communications in the WiGig format. With this arrangement, the transmitting process of the encryption key information that needs most processing time in WPS can be omitted.

### Second Embodiment

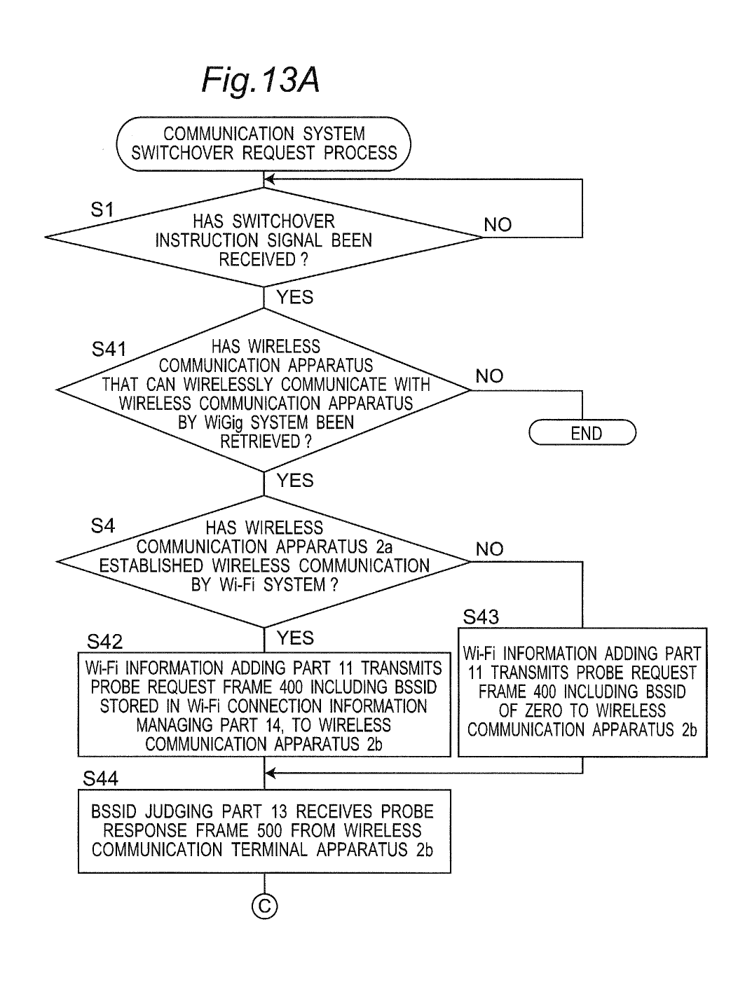

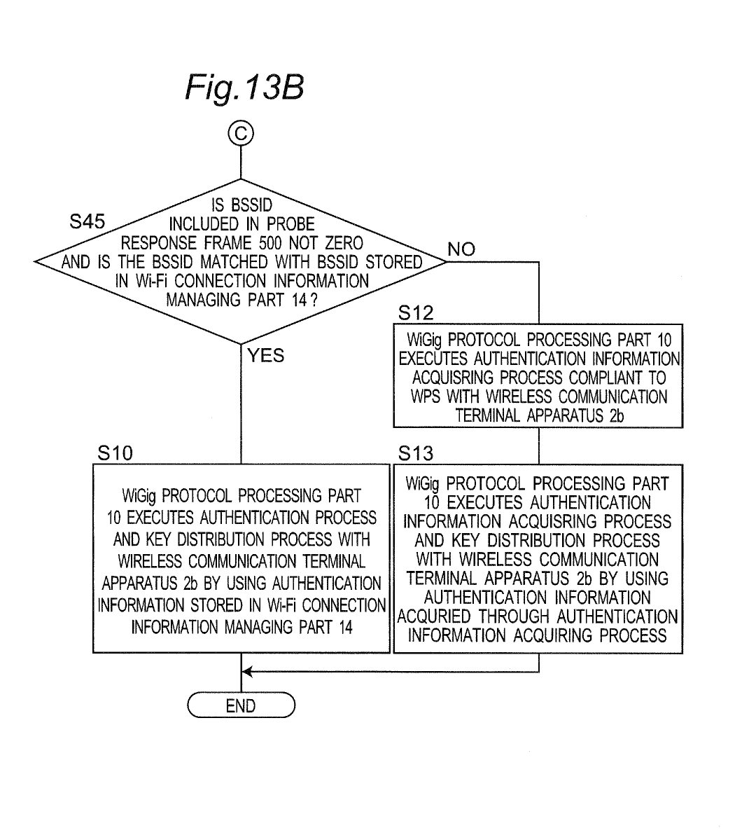

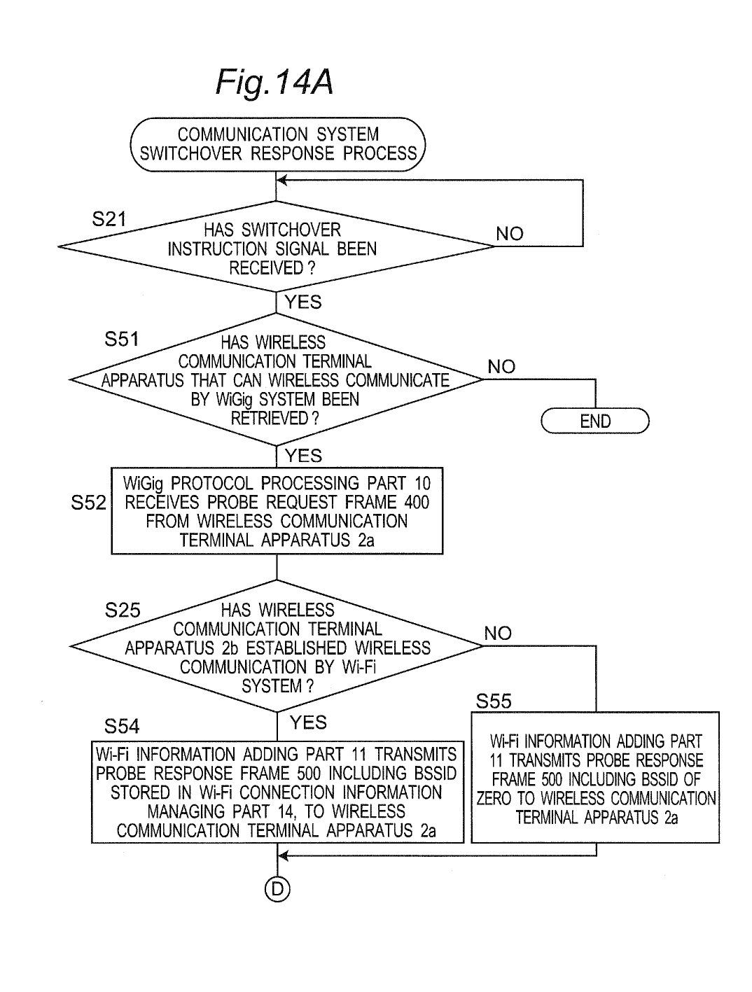

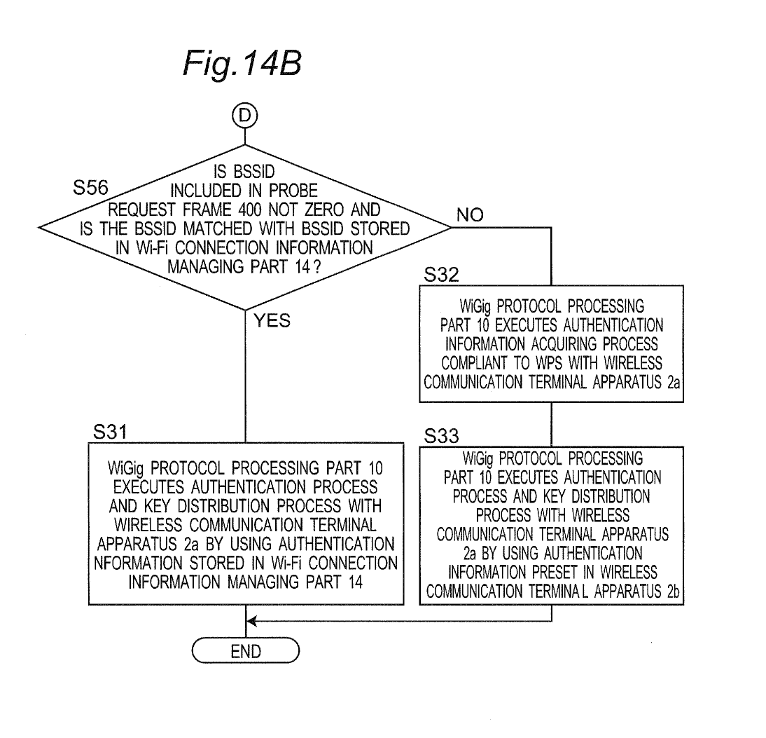

In the first embodiment, the communication system switchover request process of FIGS. 4A and 4B and the communication system switchover response process of FIGS. 5A and 5B are executed by using the communication protocol compliant to Wi-Fi Direct planned by the Wi-Fi Alliance. In contrast to this, in the present embodiment, the communication system switchover request process of FIGS. 13A and 13B and the communication system switchover response process of FIGS. 14A and 14B are executed by a communication protocol compliant to WiGig standardized by the Wireless Gigabit Alliance in the wireless communication system of FIG. 1. Moreover, according to the wireless communications of the WiGig system in the present embodiment, the wireless communication terminal apparatus 2a operates as a client apparatus in WPS, and the wireless communication terminal apparatus 2b operates as an access point apparatus. In the present embodiment, the wireless communication terminal apparatuses 2a and 2b are configured in a manner similar to that of the wireless communication terminal apparatuses 2a and 2b of the first embodiment. Only the points of difference from the first embodiment are described below.

Process for Performing Switchover of Communication System for Data Communication from Wi-Fi System to WiGig System

When the wireless communication terminal apparatus 2a requests the wireless communication terminal apparatus 2b to perform switchover of the communication system for performing data communications between the wireless communication terminal apparatuses 2a and 2b from the Wi-Fi system to the WiGig system in the wireless communication system of FIG. 1, the communication system switchover request process executed by the WiGig connection control part 9 of the wireless communication terminal apparatus 2a of FIG. 3 is described with reference to FIGS. 13A and 13B, and the communication system switchover response process executed by the WiGig connection control part 9 of the wireless communication terminal apparatus 2b of FIG. 3 is described with reference to FIGS. 14A and 14B.

FIGS. 13A and 13B are flow charts showing a communication system switchover request process according to the second embodiment executed by the WiGig connection control part 9 of the wireless communication terminal apparatus 2a of FIG. 3. It is noted in FIGS. 13A and 13B that processes identical to those in FIGS. 4A and 4B are denoted by identical step numbers, and no detailed description is provided for them. At step S1 of FIG. 13A, the WiGig connection control part 9 judges whether or not a switchover instruction signal to instruct switchover of the communication system for performing data communication with the wireless communication terminal apparatuses 2b to the WiGig system has been received. The control flow proceeds to step S41 when the answer is YES at step S1 or the process of step S1 is repetitively executed when the answer is NO.

At step S41, the WiGig protocol processing part 10 judges whether or not a wireless communication terminal apparatus capable of performing wireless communications by the WiGig system has been retrieved. In concrete, the WiGig protocol processing part 10 transmits a Beacon signal for retrieving the wireless communication terminal apparatus capable of performing wireless communications by the WiGig system via the connection control part 5 and the WiGig communication interface 4. According to the communication protocol compliant to WiGig, the wireless communication terminal apparatus that has received the aforementioned Beacon signal sends a reply of the Beacon signal when the wireless communications by the WiGig system can be performed. The WiGig protocol processing part 10 executes the judging process of step S41 depending on whether or not the Beacon signal has been received from another wireless communication terminal apparatus. Then, the control flow proceeds to step S4 when the answer is YES at step S41 or the communication system switchover request process is ended when the answer is NO.

At step S4, the Wi-Fi connection judging part 12 judges whether or not the wireless communication terminal apparatus 2a has established wireless connection by the Wi-Fi system by judging whether or not the authentication information and BSSID that the wireless communication terminal apparatus 2a establishes wireless connection by the Wi-Fi system with another wireless communication terminal apparatus are stored in the Wi-Fi connection information managing part 14. Then, the control flow proceeds to step S42 when the answer is YES at step S4 or proceeds to step S43 when the answer is NO.

At step S42, the Wi-Fi information adding part 11 transmits a probe request frame 400 including the BSSID stored in the Wi-Fi connection information managing part 14 to the wireless communication terminal apparatus 2b via the connection information control part 5 and the WiGig communication interface 4. In concrete, the Wi-Fi information adding part 11 sets the BSSID stored in the Wi-Fi connection information managing part 14 into the network identification information field F4 of the probe request frame 400 generated by the WiGig protocol processing part 10. Since the wireless communication terminal apparatus 2a is wirelessly connected to the access point apparatus 1 in the present embodiment, the BSSID stored in the Wi-Fi connection information managing part 14 of the wireless communication terminal apparatus 2a is the BSSID of the access point apparatus 1. The format of the probe request frame 400 is described in detail later.

On the other hand, at step S43, the Wi-Fi information adding part 11 transmits the probe request frame 400 including the BSSID of zero to the wireless communication terminal apparatus 2b via the connection information control part 5 and the WiGig communication interface 4.

As described in detail later, the wireless communication terminal apparatus 2b transmits a probe response frame 500 to the wireless communication terminal apparatus 2a in response to the probe request frame 400. In this case, when the wireless communication terminal apparatus 2b has established wireless connection by the Wi-Fi system, the probe response frame 500 includes the BSSID stored in the Wi-Fi connection information managing part 14 of the wireless communication terminal apparatus 2b. When the wireless communication terminal apparatus 2b has not established wireless connection by the Wi-Fi system, the probe response frame 500 includes the BSSID of 0.

At step S44 subsequent to steps S42 and S43, the BSSID judging part 13 receives the probe response frame 500 from the wireless communication terminal apparatus 2b via the WiGig communication interface 4 and the connection control part 5. Next, at step S45 of FIG. 13B, the BSSID judging part 13 judges whether or not the BSSID included in the probe response frame 500 is not zero and is matched with the BSSID stored in the Wi-Fi connection information managing part 14. Then, the control flow proceeds to step S 10 when the answer is YES at step S45 or proceeds to step S12 when the answer is NO. It is noted that the control flow proceeds to step S11 also when the judging process cannot be executed at step S45. Since the processes of step S10 and subsequent steps and the processes of step S 12 and subsequent steps are identical to the processes of FIG. 4B, no description is provided for them.

FIGS. 14A and 14B are flow charts showing a communication system switchover response process according to the second embodiment executed by the WiGig connection control part 9 of the wireless communication terminal apparatus 2b of FIG. 3. Referring to FIGS. 14A and 14B, the processes identical to those of FIGS. 5A and 5B are denoted by identical step numbers, and no detailed description is provided for them. At step S21 of FIG. 14A, the WiGig connection control part 9 judges whether or not a switchover instruction signal to instruct switchover of the communication system for performing data communications with the wireless communication terminal apparatus 2b to the WiGig system has been received. The control flow proceeds to step S51 when the answer is YES at step S21 or the process of step S21 is repetitively executed when the answer is NO.

At step S51, the WiGig protocol processing part 10 judges whether or not a wireless communication terminal apparatus capable of performing wireless communications by the WiGig system could be retrieved. In concrete, the WiGig protocol processing part 10 transmits a Beacon signal for retrieving the wireless communication terminal apparatus capable of performing wireless communications by the WiGig system via the connection control part 5 and the WiGig communication interface 4. Further, the WiGig protocol processing part 10 executes the judging process of step S51 depending on whether or not the Beacon signal has been received from another wireless communication terminal apparatus. Then, the control flow proceeds to step S52 when the answer is YES at step S51 or the communication system switchover response process is ended when the answer is NO.

At step S52, the WiGig protocol processing part 10 receives the probe request frame 400 from the wireless communication terminal apparatus 2a. Next, at step S25, the Wi-Fi connection judging part 12 judges whether or not the wireless communication terminal apparatus 2b has established wireless connection by the Wi-Fi system by judging whether or not the authentication information and BSSID for establishing wireless connection with another wireless communication terminal apparatus by the Wi-Fi system are stored in the Wi-Fi connection information managing part 14. Then, the control flow proceeds to step S54 when the answer is YES at step S25 or proceeds to step S55 when the answer is NO.

At step S54, the Wi-Fi information adding part 11 transmits the probe response frame 500 that includes the BSSID stored in the Wi-Fi connection information managing part 14 to the wireless communication terminal apparatus 2a via the connection information control part 5 and the WiGig communication interface 4. In concrete, the Wi-Fi information adding part 11 sets the BSSID stored in the Wi-Fi connection information managing part 14 into the network identification information field F5 of the probe response frame 500 generated by the WiGig protocol processing part 10. Since the wireless communication terminal apparatus 2b is wirelessly connected to the access point apparatus 1 in the present embodiment, the BSSID stored in the Wi-Fi connection information managing part 14 of the wireless communication terminal apparatus 2b is the BSSID of the access point apparatus 1.

On the other hand, at step S55, the Wi-Fi information adding part 11 transmits the probe response frame 500 including the BSSID of zero to the wireless communication terminal apparatus 2a via the connection information control part 5 and the WiGig communication interface 4.

At step S56 of FIG. 14B subsequent to step S54 and step S55, the BSSID judging part 13 judges whether or not the BSSID included in the probe request frame 400 is not zero and is matched with the BSSID stored in the Wi-Fi connection information managing part 14. Then, the control flow proceeds to step S31 when the answer is YES at step S56 or proceeds to step S32 when the answer is NO. Since the process of step S31 and subsequent steps and the process of step S32 and subsequent steps are identical to the processes of FIG. 5B, no description is provided for them.

### Format of Probe Request Frame 400

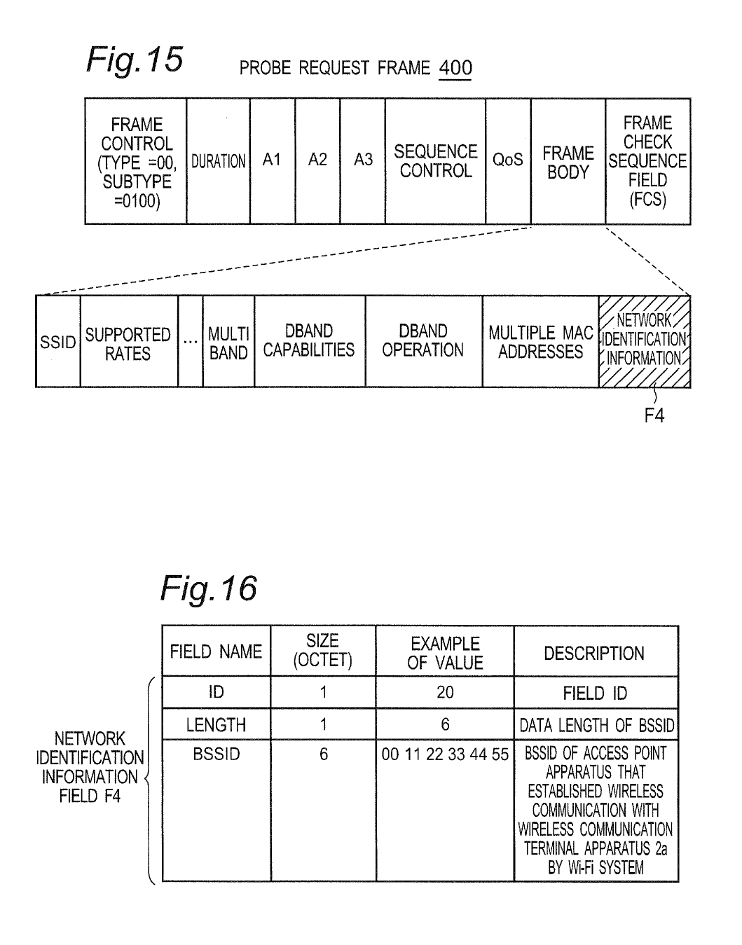

FIG. 15 is a format chart showing a format of the probe request frame 400 transmitted at steps S42 and S43 of FIG. 13A. The probe request frame 400 has such a configuration that the network identification information field F4 is added to the tail of the frame body field of the probe request frame compliant to WiGig. Referring to FIG. 15, the probe request frame 400 includes a frame control field, a duration field, an A1 field, an A2 field, an A3 field, a sequence control field, a QoS field, a frame body field, and a frame check sequence field. In this case, since the fields other than the frame body field are configured in a manner similar to that of the respective fields of the group owner negotiation request frame 100 of FIG. 6, no description is provided for them. It is noted that a number of 00 is set to the type field, and a number of 0100 is set to the subtype field in the probe request frame 400.

Referring to FIG. 15, transmission data is stored in the frame body field. The frame body field of the probe request frame 400 includes an SSID field, a supported rate, a multiband field, a DBand capabilities field, a DBand operation field, a multiple MAC address field, and a network identification information field F4. In this case, predetermined values compliant to WiGig are stored in the fields other than the network identification information field F4. It is noted that identification information of the network to which the wireless communication terminal apparatus 2a belongs is stored in the SSID field.

FIG. 16 is a table showing a format of the network identification information field F4 of FIG. 15. As shown in FIG. 16, since the format of the network identification information field F4 is identical to the format (See FIG. 7) of the network identification information field F1 of the group owner negotiation request frame 100, no description is provided therefor.

As described above, the probe request frame 400 includes the BSSID of the access point apparatus 1 corresponding to the identification information of the wireless network to which the wireless communication terminal apparatus 2a belongs.

### Format of Probe Response Frame 500

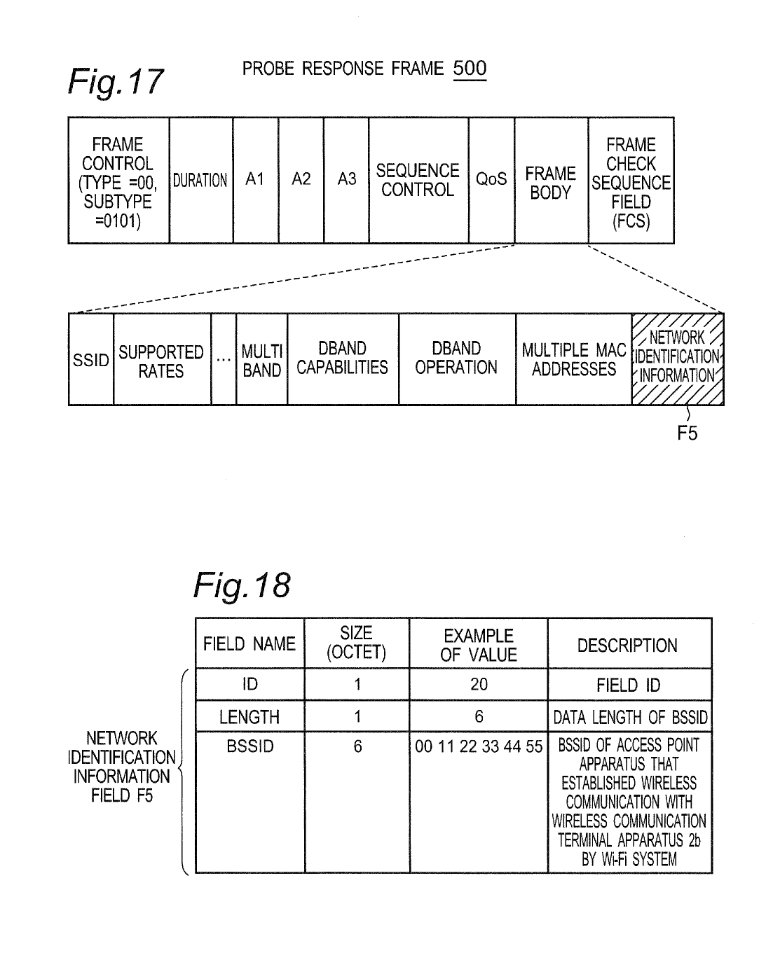

FIG. 17 is a format chart showing a format of the probe response frame 500 transmitted at steps S54 and S55 of FIG. 14A. The probe response frame 500 has such a configuration that the network identification information field F5 is added to the tail of the frame body field of the probe response frame compliant to WiGig.

Referring to FIG. 17, the probe response frame 500 includes a frame control field, a duration field, an A 1 field, an A2 field, an A3 field, a sequence control field, a QoS field, a frame body field, and a frame check sequence field. In this case, since the fields other than the frame body field are configured in a manner similar to that of the respective fields of the group owner negotiation response frame 200 of FIG. 8, no description is provided for them. It is noted that a number of 00 is set to the type field, and a number of 0101 is set to the subtype field in the probe response frame 500.

Referring to FIG. 17, transmission data is stored in the frame body field. The frame body field of the probe response frame 500 includes an SSID field, a supported rate, a multiband field, a DBand capabilities field, a DBand operation field, a multiple MAC address field, and a network identification information field F4. In this case, predetermined values compliant to WiGig are stored in the fields other than the network identification information field F4. It is noted that identification information of the network to which the wireless communication terminal apparatus 2a belongs is stored in the SSID field.

FIG. 18 is a table showing a format of the network identification information field F5 of FIG. 17. As shown in FIG. 16, since the format of the network identification information field F5 is identical to the format (See FIG. 9) of the network identification information field F2 of the group owner negotiation response frame 200, no description is provided therefor.

As described above, the probe response frame 500 includes the BSSID of the access point apparatus 1 corresponding to the identification information of the wireless network to which the wireless communication terminal apparatus 2b belongs.

### Operation Example of Wireless Communication System

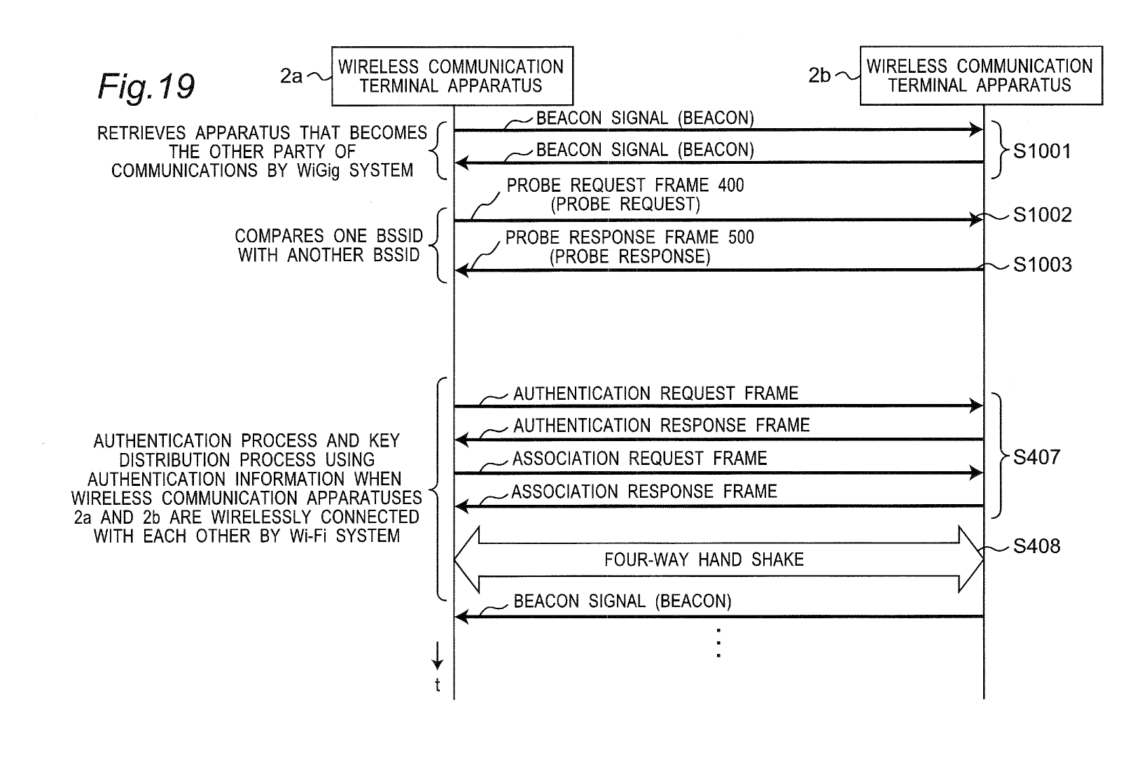

FIG. 19 is a timing chart showing one example of the operation of the second embodiment of the wireless communication system of FIG. 1. At step S1001, the wireless communication terminal apparatuses 2a and 2b transmit and receive a Beacon signal to retrieve the apparatus that becomes the other party of communications by the WiGig system. Upon receiving the Beacon signal, each of the wireless communication terminal apparatuses 2a and 2b judges that the wireless communication terminal apparatus capable of performing wireless communications by the WiGig system has been retrieved. Next, at step S 1002, the wireless communication terminal apparatus 2a transmits the probe request frame 400 including the BSSID of the access point apparatus 1 to which the wireless communication terminal apparatus 2a is wirelessly connected by the Wi-Fi system to the wireless communication terminal apparatus 2b. In response to this, at step S1003, the wireless communication terminal apparatus 2b transmits the probe response frame 500 including the BSSID of the access point apparatus 1 to which the wireless communication terminal apparatus 2b is wirelessly connected by the Wi-Fi system to the wireless communication terminal apparatus 2a.

Upon receiving the probe response frame 500, the wireless communication terminal apparatus 2a compares the BSSID of the access point apparatus 1 stored in the Wi-Fi connection information managing part 14 with the BSSID included in the probe response frame 500. When the BSSID of the access point apparatus 1 stored in the Wi-Fi connection information managing part 14 of the wireless communication terminal apparatus 2a is matched with the BSSID included in the probe response frame 500, the control flow proceeds to step S407. Since the processes of step S407 and subsequent steps are similar to the processes of step S407 and subsequent steps of FIG. 12, no description is provided for them.

As described above, the WiGig connection control part 9 of the wireless communication terminal apparatus 2a of the present disclosure transmits the probe request frame 400 that requests establishing wireless connection by the WiGig system and includes the first network identification information to the wireless communication terminal apparatus 2b. The WiGig connection control part 9 of the wireless communication terminal apparatus 2b transmits the probe response frame 500 including the second network identification information to the wireless communication terminal apparatus 2a in response to the probe request frame 400.

The WiGig connection control part 9 of the wireless communication terminal apparatus 2a compares the second network identification information included in the probe response frame 500 with the first network identification information stored in the Wi-Fi connection information managing part 14 of the wireless communication terminal apparatus 2a in response to the probe response frame 500, and executes the authentication process with the wireless communication terminal apparatus 2b by using the identification information stored in the Wi-Fi connection information managing part 14 of the wireless communication terminal apparatus 2a when the second network identification information included in the probe response frame 500 is matched with the first network identification information stored in the Wi-Fi connection information managing part 14 of the wireless communication terminal apparatus 2a, and this leads to establishment of wireless connection by the WiGig system with the wireless communication terminal apparatus 2b.

Therefore, according to the wireless communication system of the present embodiment, the wireless communication terminal apparatuses 2a and 2b use the authentication information, which has been acquired when connected by the Wi-Fi system to the access point apparatus 1 when wirelessly connected with each other by the Wi-Fi system via the access point apparatus 1, for the authentication process and the key distribution process for establishing wireless connection by the WiGig system. Therefore, the wireless communication terminal apparatuses 2a and 2b need not execute a process for matching the authentication information acquiring process such as WPS and the encryption method of a comparatively large data processing amount before starting wireless communications by the WiGig system. Therefore, also after the communication system for performing communications between the wireless communication terminal apparatuses 2a and 2b is switched over to the WiGig system, the communication system can be switched over more promptly than that of the prior art with the security and confidentiality of information maintained in a manner similar to that before the switchover. Further, when the communication system for data communications can reliably be switched over from the Wi-Fi system to the WiGig system, the user needs not perform operation for executing connection information input operation and WPS. Therefore, the user interface of the wireless communication terminal apparatuses 2a and 2b can be simplified as compared with the prior art.

Moreover, in the present embodiment, unlike the first embodiment, the BSSID of the access point apparatus 1 corresponding to the identification information of the wireless network to which the wireless communication terminal apparatus 2a belongs is included in the probe request frame 400, and the BSSID of the access point apparatus 1 corresponding to the identification information of the wireless network to which the wireless communication terminal apparatus 2b belongs is included in the probe response frame 500. Moreover, in the present embodiment, the frame corresponding to the group owner negotiation confirmation frame 300 of the first embodiment needs not be transmitted. Therefore, as compared with the first embodiment, the communication system for data communications can be switched over more easily and promptly from the Wi-Fi system to the WiGig system.

Although it is judged whether or not the authentication information used for wireless communications by the Wi-Fi system can be used for wireless communications by the WiGig system by judging whether or not the BSSIDs stored in the Wi-Fi connection information managing parts 14 of the wireless communication terminal apparatuses 2a and 2b are matched with each other in the present embodiment, the present disclosure is not limited to this. It is acceptable to judge whether or not the authentication information used for wireless communications by the Wi-Fi system can be used for wireless communications by the WiGig system by judging whether or not the identification information of the network to which the wireless communication terminal apparatus 2a belongs is matched with the identification information of the network to which the wireless communication terminal apparatus 2b belongs.

Moreover, although the authentication information used for wireless communications in the Wi-Fi format has been used for wireless communications in the WiGig format in the present embodiment, the present disclosure is not limited to this, and part of the authentication information used for wireless communications in the Wi-Fi format may be used for wireless communications in the WiGig format. For example, only the encryption key information of the authentication information used for wireless communications in the Wi-Fi format may be used for wireless communications in the WiGig format. With this arrangement, the transmitting process of the encryption key information that needs most processing time in WPS can be omitted.

Further, although it is judged that the answer is YES when the Beacon signal is sent as a reply to the transmitted Beacon signal at step S41 of FIG. 13A and step S51 of FIG. 14A, the present disclosure is not limited to this. At step S41 of FIG. 13A and step S51 of FIG. 14A, it is acceptable to make a judgment that the answer is YES when the Beacon signal is received.

Furthermore, although the wireless communication terminal apparatus 2a sets the number of zero into the network identification information field F4 of the probe request frame 400 when no wireless connection has been established by the Wi-Fi system in the present embodiment, the present disclosure is not limited to this. It is acceptable to set a BSSID value that does not actually exist other than the number of zero into the network identification information field F4 of the probe request frame 400. Moreover, the network identification information field F4 may be deleted from the probe request frame 400. That is, it is proper to transmit the probe request frame 400 indicating that no wireless connection has been established by the Wi-Fi system.

Moreover, although the wireless communication terminal apparatus 2b sets the number of zero into the network identification information field F5 of the probe response frame 500 when no wireless connection has been established by the Wi-Fi system in the present embodiment, the present disclosure is not limited to this. It is acceptable to set a BSSID value that does not actually exist other than the number of zero into the network identification information field F5 of the probe response frame 500. Moreover, the network identification information field F5 may be deleted from the probe response frame 500. That is, it is proper to transmit the probe response frame 500 indicating that no wireless connection has been established by the Wi-Fi system.

### Third Embodiment

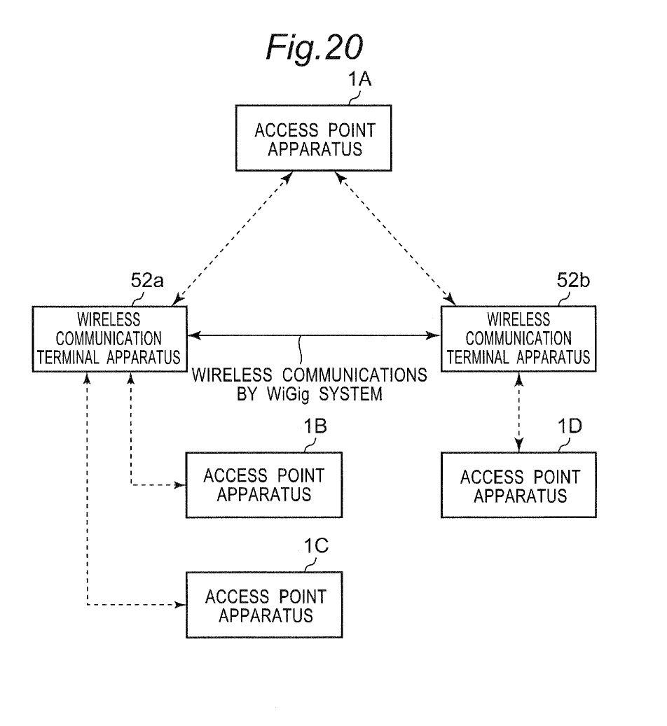

FIG. 20 is a block diagram showing a configuration of a wireless communication system according to the third embodiment of the present disclosure. In the present embodiment, components similar to the components described in the first embodiment are denoted by identical reference numerals. Only the points of difference from the first embodiments are described below.

### Configuration of Wireless Communication System

Referring to FIG. 20, the wireless communication system of the present embodiment is configured to include wireless communication terminal apparatuses 52a and 52b. Access point apparatuses 1A, 1B, 1C and 1D connected to a backbone network of Ethernet (registered trademark) or the like and the wireless communication terminal apparatus 52a and 52b perform wireless communications compliant to IEEE802.11 of a wireless LAN standard. Moreover, in the present embodiment, the wireless communication terminal apparatuses 52a and 52b perform data communications by using either of the communication systems of the Wi-Fi system and the WiGig system described in the first embodiment.

In the example shown in FIG. 20, the wireless communication terminal apparatus 52a establishes wireless connection with the access point apparatuses 1A, 1B or 1C, and is connected to the backbone network via the access point apparatus with which wireless connection has been established. Moreover, the wireless communication terminal apparatus 52b establishes wireless connection with the access point apparatuses 1A or 1D, and is connected to the backbone network via the access point apparatus with which wireless connection has been established.

### Configuration of Wireless Communication Terminal Apparatuses 52a and 52b

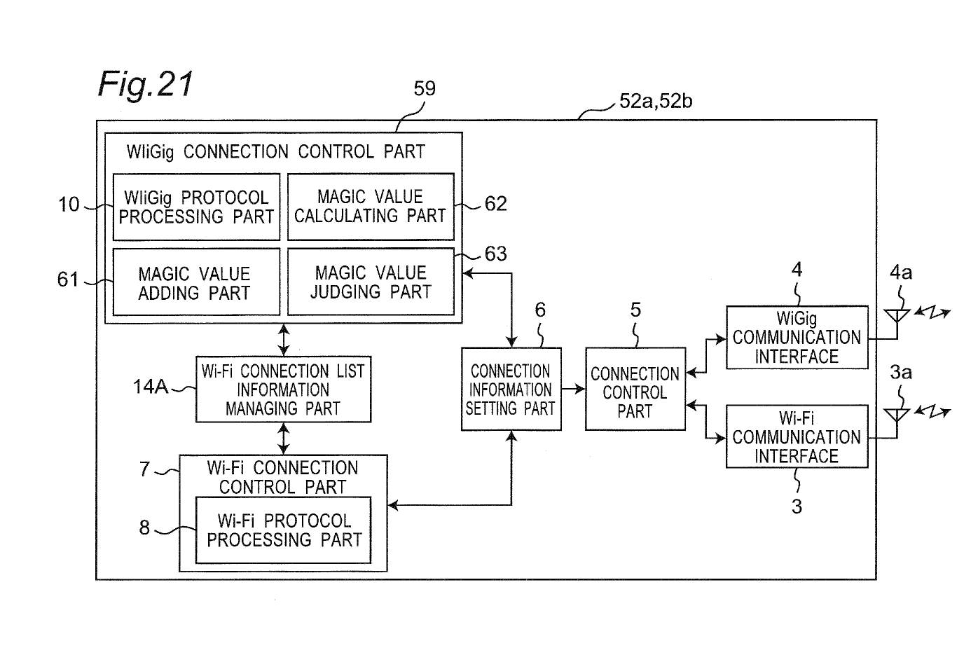

FIG. 21 is a block diagram showing a configuration of the wireless communication terminal apparatuses 52a and 52b of FIG. 20. It is noted that the wireless communication terminal apparatuses 52a and 52b have the same functions and configurations as each other as shown in FIG. 21. Therefore, only the functions and the configuration of the wireless communication terminal apparatus 52a are described with reference to FIG. 21. The wireless communication terminal apparatus 52a is configured to include a Wi-Fi communication interface 3, a WiGig communication interface 4, a connection control part 5, a connection information setting part 6, a Wi-Fi connection control part 7 including a Wi-Fi protocol processing part 8, a WiGig connection control part 59, and a Wi-Fi connection list information managing part 14A. Further, the WiGig connection control part 59 is configured to include a WiGig protocol processing part 10, a magic value adding part 61, a magic value calculating part 62, and a magic value judging part 63.

The functions of the Wi-Fi connection control part 7, the Wi-Fi protocol processing part 8, the WiGig connection control part 59, the WiGig protocol processing part 10, the magic value adding part 61, the magic value calculating part 62 and the magic value judging part 63 are implemented by executing an application software program corresponding to each of the functions by a CPU or DSP or providing a hardware logic circuit such as an FPGA to execute calculations corresponding to each of the functions. Moreover, the connection information setting part 6 is implemented by a hardware apparatus such as a memory or a hard disk for recording and holding information. It is noted that the arbitrary components of the parts 5 to 8, and 61 to 63 of the wireless communication terminal apparatuses 52a and 52b may be implemented by hardware.

Referring to FIG. 21, since the Wi-Fi communication interface 3, the WiGig communication interface 4, the connection control part 5, the connection information setting part 6, and the WiGig protocol processing part 10 are configured in a manner similar to that of the Wi-Fi communication interface 3, the WiGig communication interface 4, the connection control part 5, the connection information setting part 6, and the WiGig protocol processing part 10 of the wireless communication terminal apparatuses 2a and 2b of the first embodiment, no description is provided for them.

In the present embodiment, the Wi-Fi connection control part 7 of the wireless communication terminal apparatus 52a receives the authentication information and the BSSID for establishing wireless connection by the Wi-Fi system when establishing wireless connection with, for example, any one of the access point apparatuses 1A to 1D of FIG. 20 by the Wi-Fi system from the access point apparatus via the Wi-Fi communication interface 3 and the connection control part 5, and stores the same into the Wi-Fi connection list information managing part 14A and the connection information setting part 6. At this time, when authentication information and BSSID have been already stored in the Wi-Fi connection list information managing part 14A, the Wi-Fi connection control part 7 adds and stores new authentication information and BSSID without deleting the stored neither authentication information and BSSID.

The Wi-Fi connection list information managing part 14A stores combinations of the authentication information and the identification information when the wireless communication terminal apparatus 52a has established wireless connection by the Wi-Fi system so far as list data. The Wi-Fi connection list information managing part 14A can be implemented by using a memory apparatus accessible from, for example, the CPU or the like. When the list data is retained even when power supply to the wireless communication terminal apparatus 52a is lost, it is preferable to use a nonvolatile type storage apparatus as the memory apparatus. When the list data may be deleted when the power supply to the wireless communication terminal apparatus 52a is lost, a volatile type memory apparatus can be used as the memory apparatus.

The magic value adding part 61 sets a magic value described in detail later into a group owner negotiation request frame 100A and a group owner negotiation response frame 200A, which are described in detail later. Moreover, the magic value calculating part 62 calculates a magic value that uniquely identifies the authentication information stored in the Wi-Fi connection list information managing part 14A. Further, the magic value judging part 63 compares the magic value corresponding to each authentication information stored in the Wi-Fi connection list information managing part 14A of the wireless communication terminal apparatus 52a as described in detail later with the magic values included in the group owner negotiation response frame 200A received from the wireless communication terminal apparatus to perform data communications by the WiGig system. Then, it is judged whether or not at least one of the magic values corresponding to each authentication information stored in the Wi-Fi connection list information managing part 14A is matched with at least one of the magic values included in the received group owner negotiation response frame 200A.

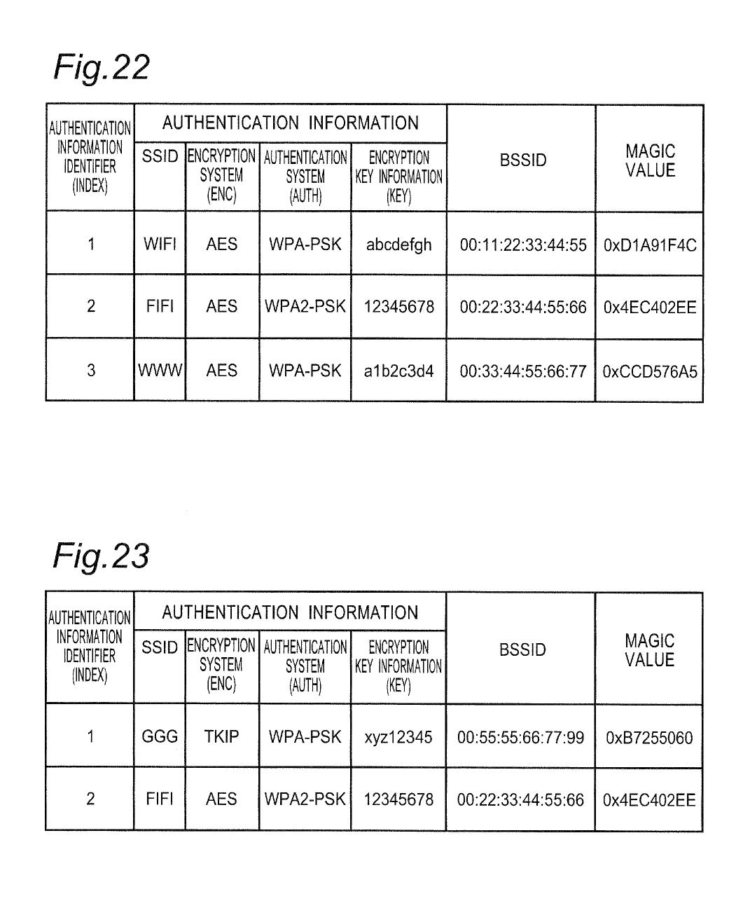

FIG. 22 is a table showing one example of a list of authentication information identifiers, authentication information and BSSIDs stored in the Wi-Fi connection list information managing part 14A of the wireless communication terminal apparatus 52a of FIG. 21, and magic values calculated by the magic value calculator part 62 of the wireless communication terminal apparatus 52a of FIG. 21. FIG. 23 is a table showing one example of a list of authentication information identifiers, authentication information and BSSIDs stored in the Wi-Fi connection list information managing part 14A of the wireless communication terminal apparatus 52b of FIG. 21, and magic values calculated by the magic value calculator part 62 of the wireless communication terminal apparatus 52b of FIG. 21.

In the example of FIG. 22, three pieces of authentication information are stored in the Wi-Fi connection list information managing part 14A of the wireless communication terminal apparatus 52a. In the present embodiment, the authentication information includes the SSID that is the identifier of the access point apparatus, an encryption method for encrypting data, and encryption key information distributed through a key distribution process (also referred to as a key exchange process) to distribute an encryption key in a manner similar to that of each of the aforementioned embodiments. Moreover, an authentication information identifier for identifying the authentication information in the wireless communication terminal apparatus 52a is assigned to each authentication information. The magic value calculating part 62 calculates a magic value inherent to the authentication information on the basis of the authentication information. In the example of FIG. 22, the authentication information to which the authentication information identifiers “1”, “2” and “3” have been assigned correspond to the access point apparatuses 1A, 1B and 1C, respectively, of FIG. 20.

Moreover, two pieces of authentication information are stored in the Wi-Fi connection list information managing part 14A of the wireless communication terminal apparatus 52b in the example of FIG. 23. Moreover, the authentication information to which the authentication information identifiers “1” and “2” have been assigned correspond to the access point apparatuses 1D and 1B, respectively, of FIG. 20. Since the magic value calculating parts 62 of the wireless communication terminal apparatus 52a and 52b calculate the magic value by an identical calculation method, the magic value of the authentication information corresponding to the authentication information identifier “2” of FIG. 22 is matched with the magic value of the authentication information corresponding to is matched with authentication information identifier “2” of FIG. 2.

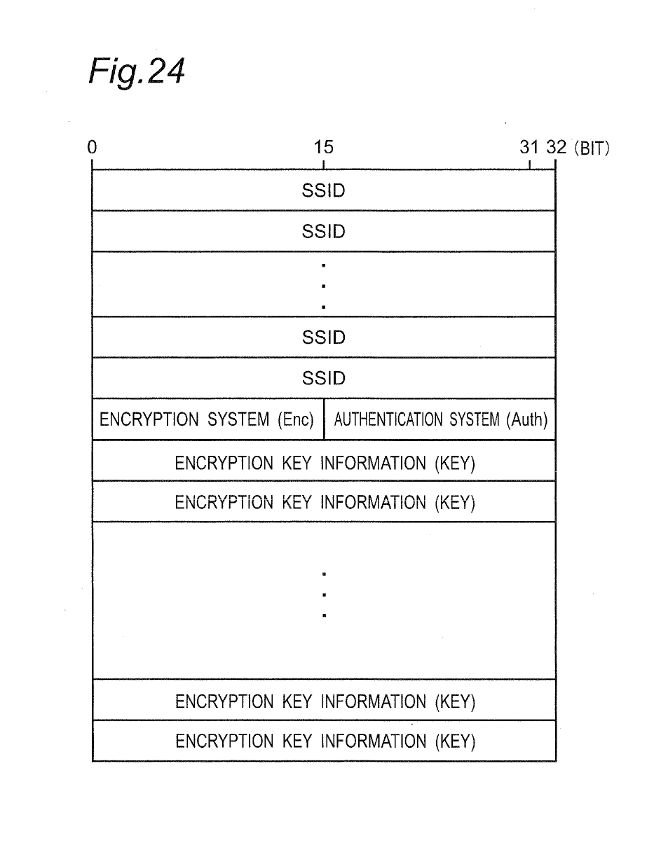

FIG. 24 is a format chart showing a storing method of the authentication information into the Wi-Fi connection list information managing part 14A of FIG. 21. As shown in FIG. 24, the data of the SSID, the encryption method, the authentication method and the key information are stored into the storage regions of four bytes, two bytes, two bytes, and eight bytes, respectively, as shown in FIG. 24. When the data length of each data is smaller than the size of the assigned storage region, the storage region is subjected to padding with predetermined data of “0” or the like.

Referring to FIG. 24, the encryption method is converted into numerical data to identify the encryption method, and stored into the Wi-Fi connection list information managing part 14A. For example, in the case of no encryption, the method is converted into a number of 0, WEP is converted into a number of 1, TKIP is converted into a number of 2, and AES is converted into a number of 3. Moreover, the authentication method is also converted into numerical data to identify the authentication method, and stored into the Wi-Fi connection list information managing part 14A. For example, an open method is converted into a number of 0, an open share (Open-Share) method is converted into a number of 1, a shared (Shared) method is converted into a number of 2, WEP-PSK is converted into a number of 3, and WPA2-PSK is converted into a number of 4.

Process for Switchover of Communication System for Data Communications from Wi-Fi System to WiGig System

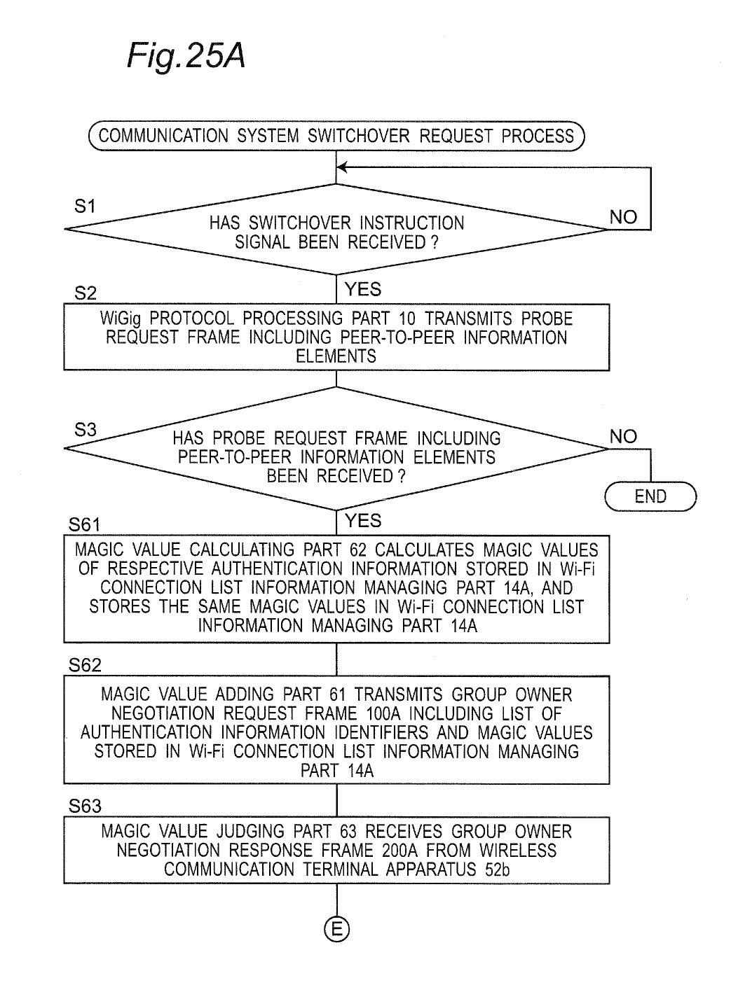

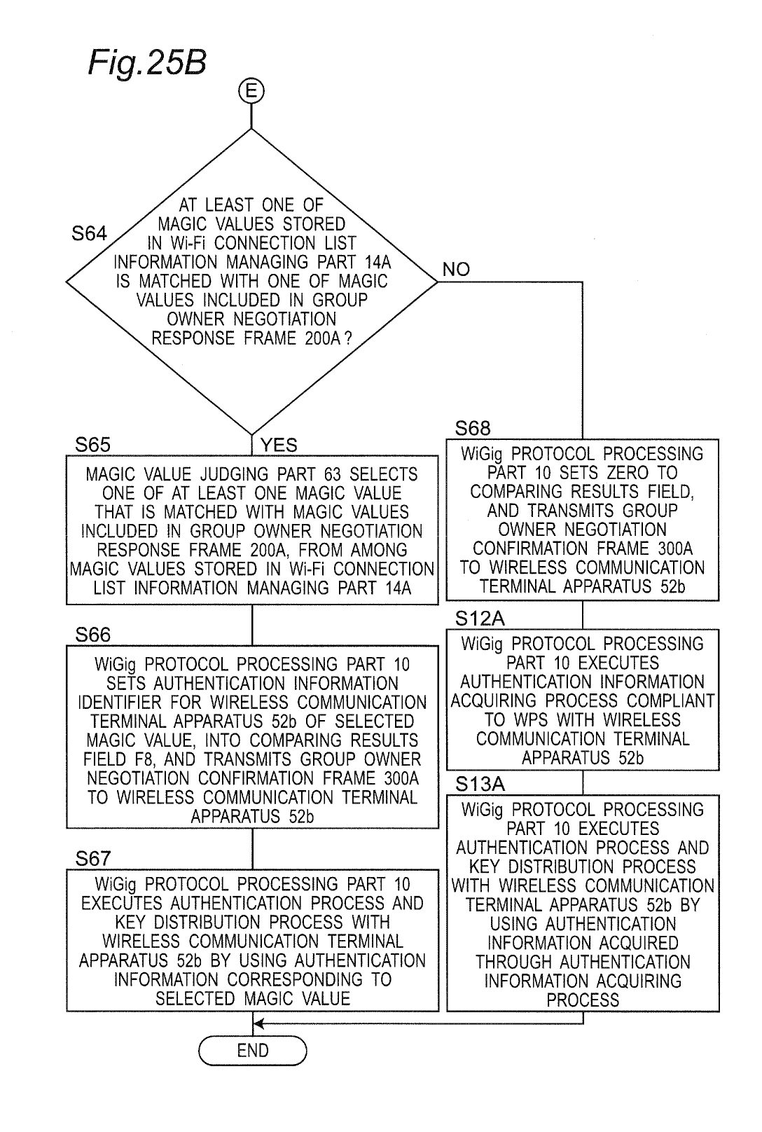

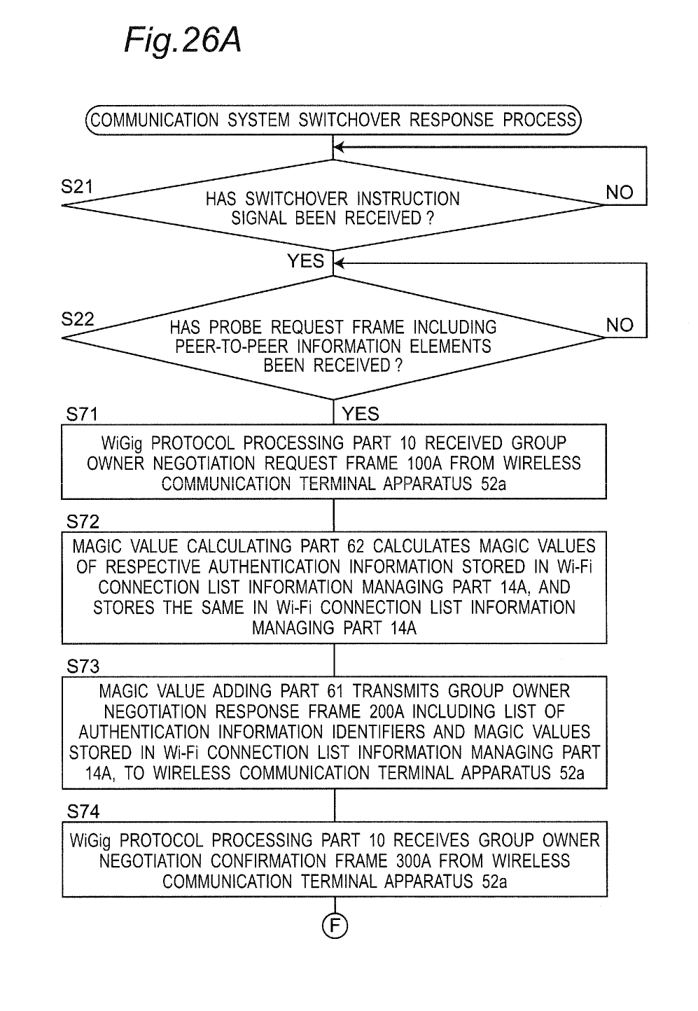

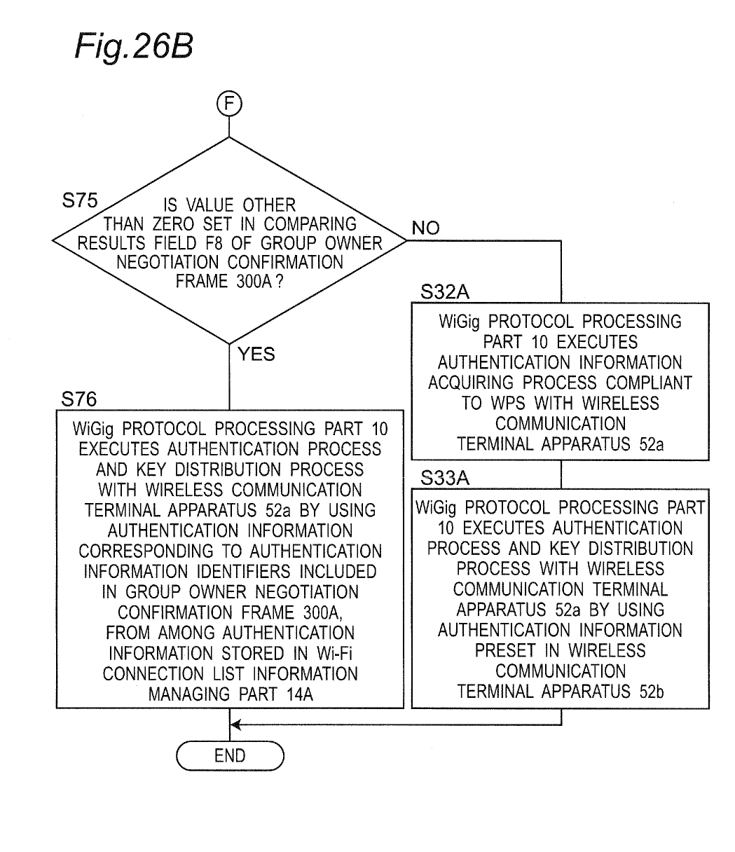

When the wireless communication terminal apparatus 52a requests the wireless communication terminal apparatus 52b to perform switchover of the communication system for performing data communications between the wireless communication terminal apparatuses 52a and 52b from the Wi-Fi system to the WiGig system in the wireless communication system of FIG. 20, a communication system switchover request process executed by the WiGig connection control part 59 of the wireless communication terminal apparatus 52a of FIG. 21 is described with reference to FIGS. 25A and 25B, and a communication system switchover response process executed by the WiGig connection control part 59 of the wireless communication terminal apparatus 52b of FIG. 21 is described with reference to FIGS. 26A and 26B. It is noted that the communication system switchover request process of FIGS. 25A and 25B and the communication system switchover response process of FIGS. 26A and 26B are executed by using a communication protocol compliant to Wi-Fi Direct planned by the Wi-Fi Alliance.

FIGS. 25A and 25B are flow charts showing a communication system switchover request process executed by the WiGig connection control part 59 of the wireless communication terminal apparatus 52a of FIG. 21. Since the processes of steps S1 to S3 of FIG. 25A are similar to the processes of steps S1 to S3 of FIG. 4A, no description is provided for them. The control flow proceeds to step S61 when the answer is YES at step S3 of FIG. 25A. At step S61, the magic value calculating part 62 calculates the magic value of each authentication information stored in the Wi-Fi connection list information managing part 14A, and stores the value into the Wi-Fi connection list information managing part 14A.

Next, at step S62, the magic value adding part 61 transmits the group owner negotiation request frame 100A including the list of the authentication information identifiers and the magic values stored in the Wi-Fi connection list information managing part 14A of the wireless communication terminal apparatus 52a to the wireless communication terminal apparatus 52b via the connection information control part 5 and the WiGig communication interface 4. In concrete, the magic value adding part 61 sets the list of the authentication information identifiers and the magic values stored in the Wi-Fi connection list information managing part 14A into the network identification information field F6 of the group owner negotiation request frame 100A generated by the WiGig protocol processing part 10. The format of the group owner negotiation request frame 100A is described in detail later.

As described in detail later, the wireless communication terminal apparatus 52b transmits the group owner negotiation response frame 200A to the wireless communication terminal apparatus 52a in response to the group owner negotiation request frame 100A. The group owner negotiation response frame 200A includes the list of the authentication information identifiers and the magic values stored in the Wi-Fi connection list information managing part 14A of the wireless communication terminal apparatus 52a.

At step S63 subsequent to step S62, the magic value judging part 63 receives the group owner negotiation response frame 200A from the wireless communication terminal apparatus 52b via the WiGig communication interface 4 and the connection control part 5. Next, at step S64 of FIG. 25B, the magic value judging part 63 judges whether or not at least one of the magic values stored in the Wi-Fi connection list information managing part 14A is matched with at least one of the magic values included in the group owner negotiation response frame 200A. Then, the control flow proceeds to step S65 when the answer is YES at step S64 or proceeds to step S68 when the answer is NO. In this case, when the wireless communication terminal apparatuses 52a and 52b have been connected to a common access point apparatus by the Wi-Fi system, the answer is judged to be YES at step S64.

At step S65, the magic value judging part 63 selects one magic value from the at least one magic value that is matched with the magic values included in the group owner negotiation response frame 200A among the magic values stored in the Wi-Fi connection list information managing part 14A. In concrete, the magic value judging part 63 selects the magic value of the authentication information corresponding to the minimum authentication information identifier. It is noted that the magic value judging part 63 may select the magic value of the authentication information that can achieve a maximum transmission rate.

Next, at step S66, the WiGig protocol processing part 10 sets the authentication information identifier of the selected magic value in the wireless communication terminal apparatus 52b into the comparing results field F8 of the group owner negotiation confirmation frame 300A described in detail later, and transmits the group owner negotiation confirmation frame 300A to the wireless communication terminal apparatus 52b via the connection control part 5 and the WiGig communication interface 4. The format of the group owner negotiation confirmation frame 300A is described in detail later.

Next, at step S67, the WiGig protocol processing part 10 executes the authentication process and the key distribution process with the wireless communication terminal apparatus 52b by using the authentication information corresponding to the selected magic value, and ends the communication system switchover request process. The process of step S67 is similar to the process of step S10 of FIG. 4B.

On the other hand, at step S68, the WiGig protocol processing part 10 sets a number of zero into the comparing results field F8 of the group owner negotiation confirmation frame 300A described in detail later, and transmits the group owner negotiation confirmation frame 300A to the wireless communication terminal apparatus 52b via the connection control part 5 and the WiGig communication interface 4.

Next, at step S12A, the WiGig protocol processing part 10 executes an authentication information acquisition information process compliant to WPS with the wireless communication terminal apparatuses 52b. At this time, the WiGig connection control part 59 of the wireless communication terminal apparatus 52a acquires the authentication information from the wireless communication terminal apparatus 52b that operates as a registrar apparatus in WPS. The process of step S 12A is similar to the process of step S 12 of FIG. 4B. Next, when the authentication information acquiring process normally ends, the WiGig protocol processing part 10 executes the authentication process and the key distribution process at step S 13A by using the authentication information acquired through the authentication information acquiring process with the wireless communication terminals 52b, and ends the communication system switchover request process. The process of step S13A is similar to the process of step S13 of FIG. 4B.

FIGS. 26A and 26B are flow charts showing a communication system switchover response process executed by the WiGig connection control part 59 of the wireless communication terminal apparatus 52b of FIG. 21. Since the processes of steps S21 and S22 of FIG. 26A are similar to the processes of steps S21 and S22 of FIG. 5A, no description is provided for them. Referring to FIG. 26A, the control flow proceeds to step S71 when the answer is YES at step S22. At step S71, the WiGig protocol processing part 10 receives the group owner negotiation request frame 100A from the wireless communication terminal apparatus 52a. Next, at step S72, the magic value calculating part 62 calculates the magic value of each authentication information stored in the Wi-Fi connection list information managing part 14A, and stores the value into the Wi-Fi connection list information managing part 14A.

Next, at step S73, the magic value adding part 61 transmits the group owner negotiation response frame 200A including the list of the authentication information identifiers and the magic values stored in the Wi-Fi connection list information managing part 14A of wireless communication terminal apparatus 52b to the wireless communication terminal apparatus 52b via the connection information control part 5 and the WiGig communication interface 4. In concrete, the magic value adding part 61 sets the list of the authentication information identifiers and the magic values stored in the Wi-Fi connection list information managing part 14 into the network identification information field F6 of the group owner negotiation response frame 200A generated by the WiGig protocol processing part 10. The format of the group owner negotiation response frame 200A is described in detail later.

Next, at step S74, the WiGig protocol processing part 10 receives the group owner negotiation confirmation frame 300a from the wireless communication terminal apparatus 52a. Next, at step S76, the WiGig protocol processing part 10 executes the authentication process and the key distribution process with the wireless communication terminal apparatus 52a by using the authentication information corresponding to the authentication information identifiers included in the group owner negotiation confirmation frame 300A among the authentication information stored in the Wi-Fi connection list information managing part 14A, and ends the communication system switchover response process. At this time, the WiGig connection control part 59 operates the wireless communication terminal apparatus 52b as a group owner apparatus by using the authentication information when wireless connection has been established by the Wi-Fi system as it is, and accepts a connection request from the wireless communication terminal apparatus 52a.

On the other hand, at step S32A, the WiGig protocol processing part 10 executes the authentication information acquiring process compliant to WPS with the wireless communication terminal apparatuses 52a. By this operation, the WiGig connection control part 59 transmits the authentication information preset in the wireless communication terminal apparatus 52b to the wireless communication terminal apparatus 52a that operates as a client apparatus in WPS. Next, at step S33A, the WiGig protocol processing part 10 executes the authentication process and the key distribution process with the wireless communication terminals 52a by using the authentication information preset in the wireless communication terminal apparatus 52b, and ends the communication system switchover response process.

### Format of Group Owner Negotiation Request Frame 100A

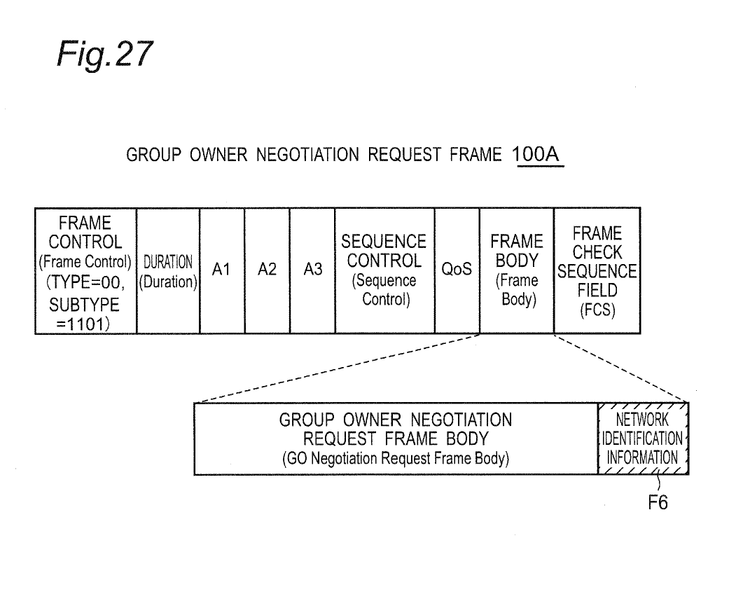

FIG. 27 is a format chart showing a format of the group owner negotiation request frame 100A transmitted at steps S62 of FIG. 25A. The group owner negotiation request frame 100A differs from the group owner negotiation request frame 100 of the first embodiment in that a network identification information field F6 is provided in place of the network identification information field F 1, and the other portions are identical to those of the group owner negotiation request frame 100.

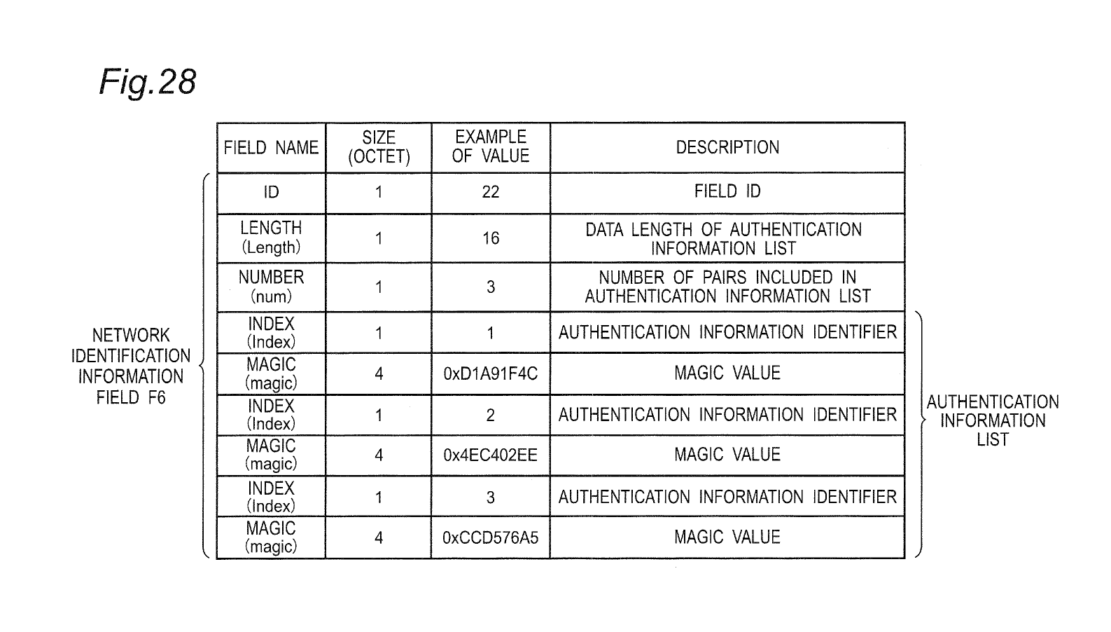

FIG. 28 is a table showing a format of the network identification information field F6 of FIG. 27. Referring to FIG. 28, the network identification information field F6 includes an ID field, a length field, a number field, and at least one pair of index fields and a magic field. In this case, a number of 22, which is the identifier of the network identification information field F6, is set to the ID field. Moreover, a total data length (six bytes) of the number field, the index field, and the magic field is set to the length field. It is noted that the number field, at least one pair of index fields and the magic field are referred to as an authentication information list.

Moreover, the number of pairs of the subsequent index fields and magic fields is set to the number field. In the example of FIG. 28, a number of 3 is set to the number field, and three pairs of index fields and magic fields are provided. In each index field, the authentication information identifiers are set in the ascending order into the wireless communication terminal apparatus 52a, and a magic value corresponding to the authentication information identifier is set to each magic field.

As described above, the group owner negotiation request frame 100A includes the authentication information identifier of the authentication information corresponding to the access point apparatus to which the wireless communication terminal apparatus 52a has been connected in the past, and the magic value.

### Format of Group Owner Negotiation Response Frame 200A

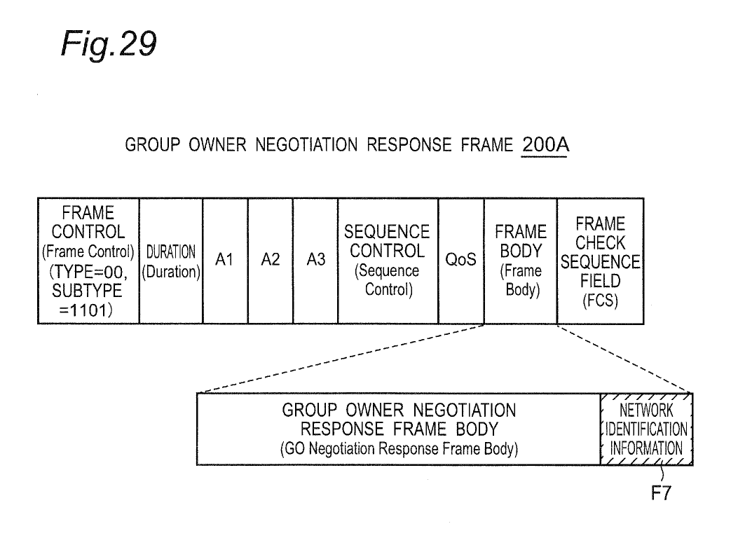

FIG. 29 is a format chart showing a format of the group owner negotiation response frame 200A transmitted at step S73 of FIG. 26A. The group owner negotiation response frame 200A differs from the group owner negotiation response frame 200 of the first embodiment in that a network identification information field F7 is provided in place of the network identification information field F2, and the other portions are identical to those of the group owner negotiation response frame 200.

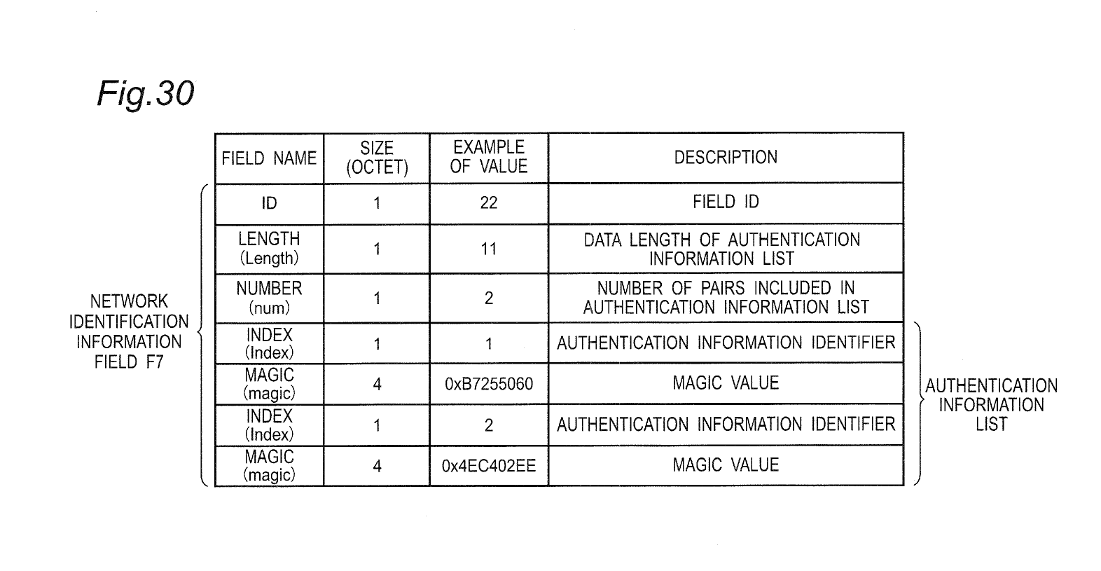

FIG. 30 is a table showing a format of the network identification information field F7 of FIG. 29. Referring to FIG. 30, the network identification information field F7 is configured in a manner similar to that of the network identification information field F6. In the example of FIG. 30, a number of 2 is set to the number field, and two pairs of index fields and magic fields are provided. The authentication information identifiers are set in the ascending order in the wireless communication terminal apparatus 52b into each index field, and a magic value corresponding to the authentication information identifier is set in each magic field.

As described above, the group owner negotiation response frame 200A includes the authentication information identifier of the authentication information corresponding to the access point apparatus to which the wireless communication terminal apparatus 52b has been connected in the past, and the magic value.

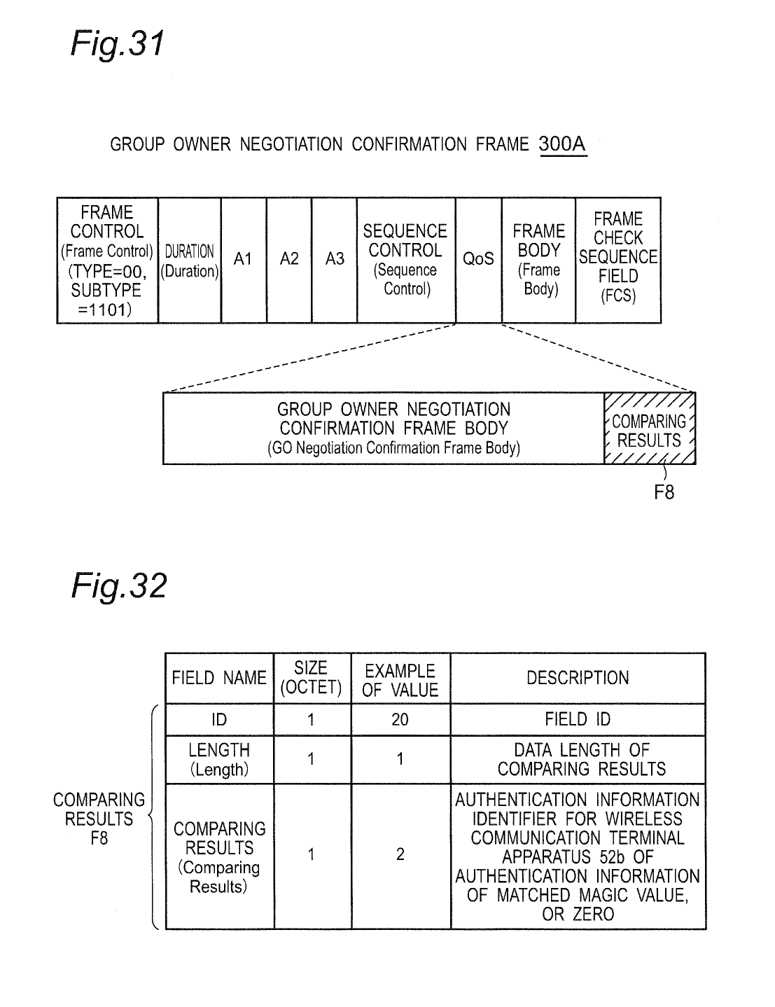

FIG. 31 is a format chart showing a format of the group owner negotiation confirmation frame 300A transmitted at steps S66 and S68 of FIG. 25B. The group owner negotiation confirmation frame 300A differs from the group owner negotiation confirmation frame 300 of the first embodiment in that comparing results field F8 is provided in place of the comparing results field F3, and the other portions are identical to those of the group owner negotiation confirmation frame 300.

FIG. 32 is a table showing a format of the comparing results field F8 of FIG. 31. Referring to FIG. 32, the comparing results field F8 includes an ID field, a length field, and comparing results field. In this case, a number of 22 that is the identifier of the comparing results field F8 is set to the ID field. Moreover, the data length of the comparing results field is set to the length field. Further, the authentication information identifier in the wireless communication terminal apparatus 52b of the authentication information with which the magic value is matched is set to the comparing results field.

### Operation Example of Wireless Communication System

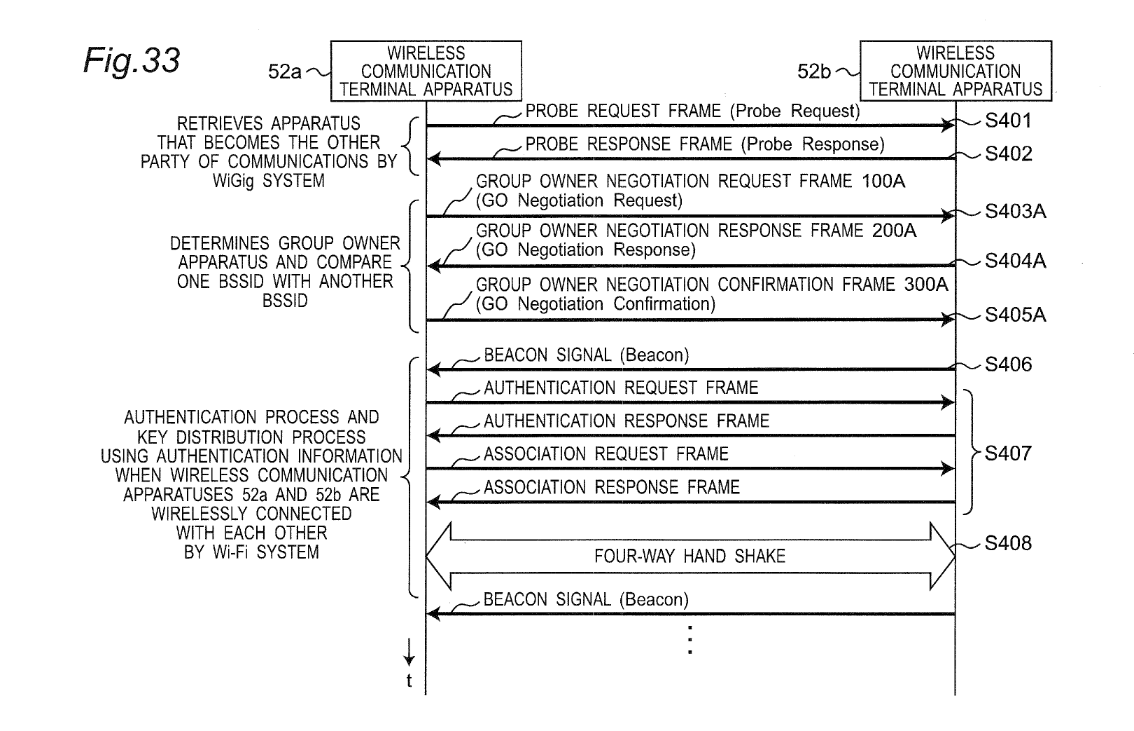

FIG. 33 is a timing chart showing one example of the operation of the wireless communication system of FIG. 20. In the timing chart of FIG. 33, steps S403 to S406 of the timing chart of FIG. 12 are replaced by steps S403A to S406A. Since the other processes are similar to the processes of FIG. 12, no description is provided for them.

Upon receiving the probe response frame, the wireless communication terminal apparatus 52a transmits at step S403A the group owner negotiation request frame 100A including the authentication information identifier of the authentication information (See, for example, FIG. 22) when the wireless communication terminal apparatus 52a has established wireless connection by the Wi-Fi system so far and the magic value to the wireless communication terminal apparatus 52b. In response to this, the wireless communication terminal apparatus 52b transmits at step S404A the group owner negotiation response frame 200A including the authentication information identifier of the authentication information (See, for example, FIG. 23) when the wireless communication terminal apparatus 52b has established wireless connection by the Wi-Fi system so far, and the magic value to the wireless communication terminal apparatus 52a.

Next, the wireless communication terminal apparatus 52a judges at step S404A whether or not at least one of the magic values stored in the Wi-Fi connection list information managing part 14A of the wireless communication terminal apparatus 52a is matched with at least one of the magic values included in the group owner negotiation response frame 200A. Further, the wireless communication terminal apparatus 52a selects one magic value from the at least one magic value that is matched with the magic values included in the group owner negotiation response frame 200A among the magic values stored in the Wi-Fi connection list information managing part 14A. Then, the wireless communication terminal apparatus 52a transmits the group owner negotiation confirmation frame 300A including data indicating the absence of the authentication information identifier in the wireless communication terminal apparatus 52b of the selected magic value or the combination of magic values to the wireless communication terminal apparatus 52b.

According to the present embodiment, it is not necessarily required that wireless connection by the WiGig system has been established when wireless communication is established by the Wi-Fi system. The wireless communication terminal apparatuses 52a and 52b store the authentication information when wireless communication by the Wi-Fi system has been established by then into each Wi-Fi connection list information managing part 14A. When at least one piece of the authentication information when the wireless communication terminal apparatus 52a has established wireless connection by the Wi-Fi system is matched with the authentication information when the wireless communication terminal apparatus 52b has established wireless connection by the Wi-Fi system, the matched authentication information is used as it is for the authentication process and the key distribution process for establishing wireless connection by the WiGig system between the wireless communication terminal apparatuses 52a and 52b. Therefore, the wireless communication terminal apparatuses 52a and 52b need not execute a process for matching the authentication information acquiring process such as WPS and the encryption method of a comparatively large data processing amount before starting the wireless communications by the WiGig system. Therefore, also after the communication system for performing communications between the wireless communication terminal apparatuses 52a and 52b is switched over to the WiGig system, the communication system can be switched over more promptly than that of the prior art with the security and confidentiality of information maintained in a manner similar to that before the switchover.

That is, according to the present embodiment, security can be maintained to an extent equivalent to that when wireless communications are performed by the Wi-Fi system when wireless communications are performed by the WiGig system. Moreover, since the wireless the processing amount in the authentication process and the key distribution process for establishing wireless connection by the WiGig system can be reduced and simplified as compared with the prior art, wireless connection by the WiGig system can be established more rapidly than that of the prior art.

Moreover, according to the present embodiment, the wireless communication terminal apparatuses 52a and 52b preparatorily store at least one piece of authentication information when wireless communication by the Wi-Fi system has been established by then into each Wi-Fi connection list information managing part 14A. Therefore, the possibility that the answer is judged to be YES at step 64 of FIG. 25B increases as the number of pieces of authentication information stored in each Wi-Fi connection list information managing part 14A is increased when wireless connection is established by the WiGig system between the wireless communication terminal apparatuses 52a and 52b. As a result, the possibility that the authentication information used for wireless connection by the Wi-Fi system can be used increases. Therefore, communications by the WiGig system can be established more promptly than in the first and second embodiments without requesting the user to operate for acquiring the authentication information.

### Fourth Embodiment

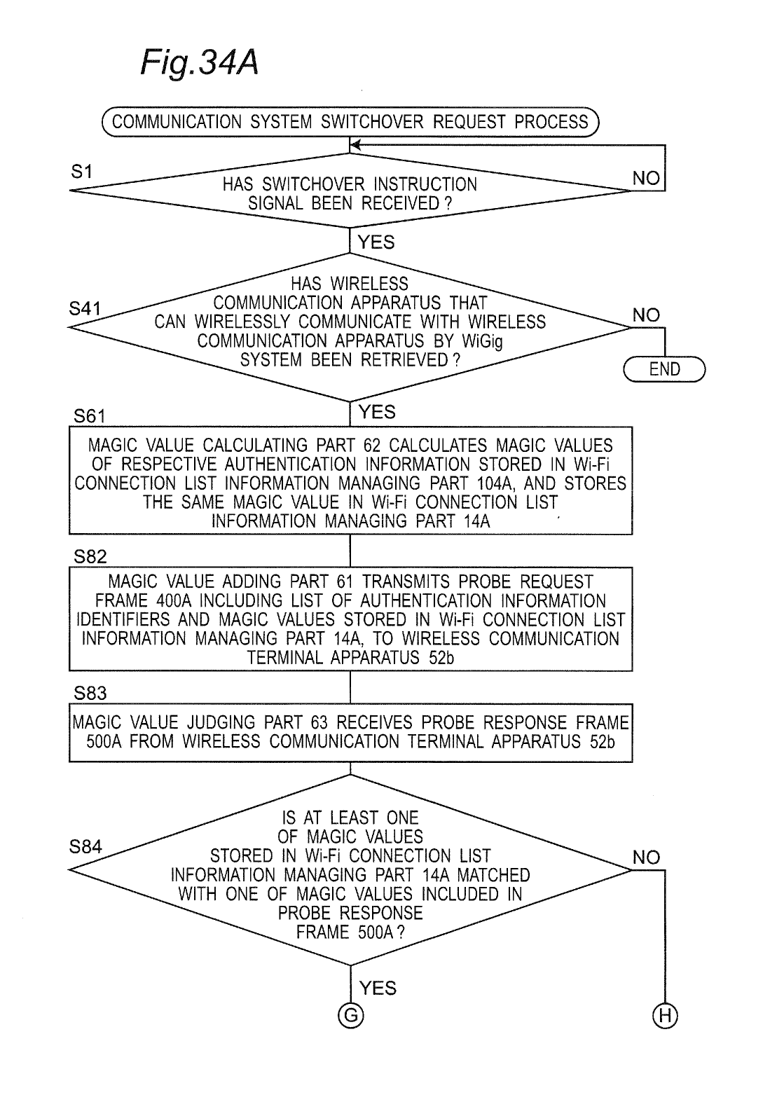

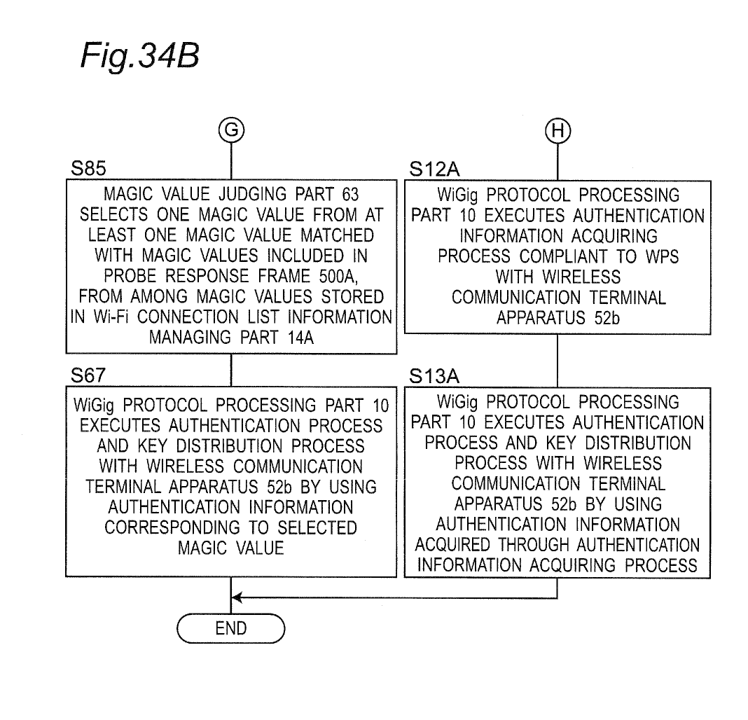

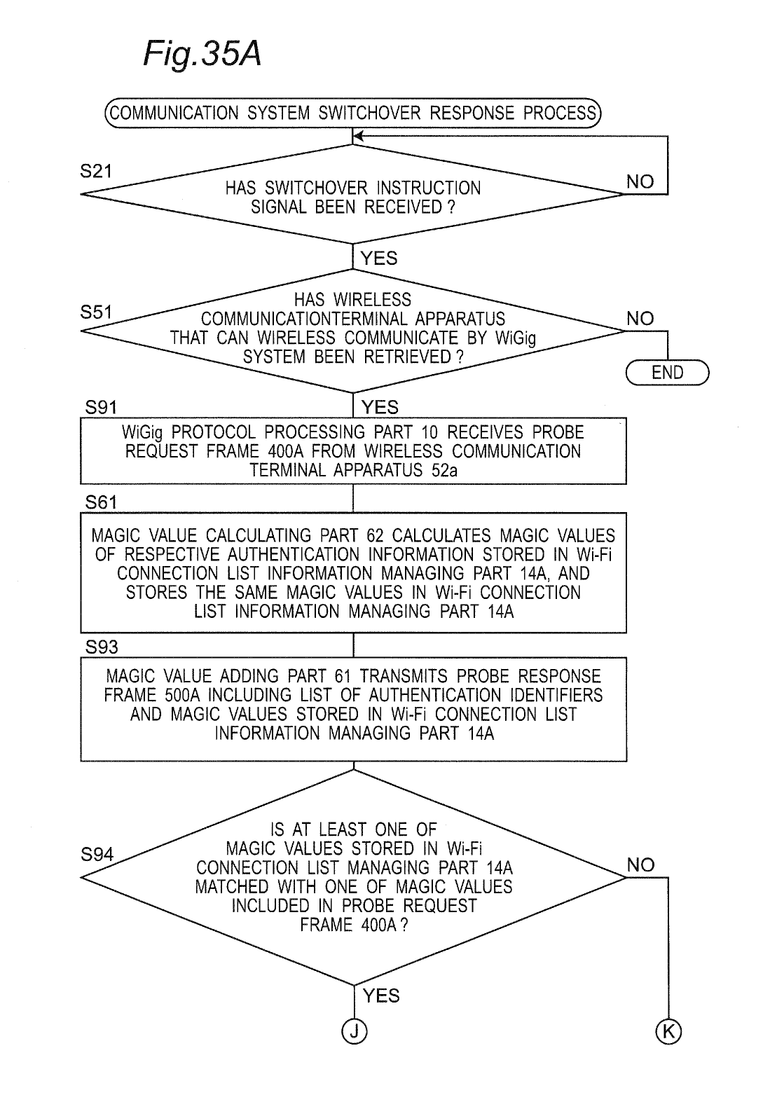

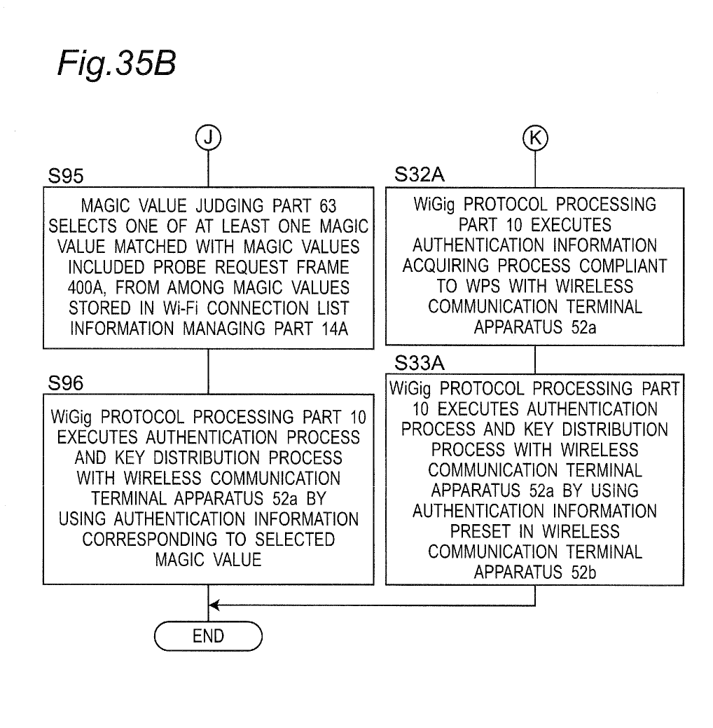

In the third embodiment, the communication system switchover request process of FIGS. 25A and 25B and the communication system switchover response process of FIGS. 26A and 26B are executed by using the communication protocol compliant to Wi-Fi Direct. In contrast to this, in the present embodiment, the communication system switchover request process of FIGS. 34A and 34B and the communication system switchover response process of FIGS. 35A and 35B are executed by using the communication protocol compliant to WiGig in the wireless communication system of FIG. 20. Moreover, in the present embodiment, the wireless communication terminal apparatus 52a operates as a client apparatus, and the wireless communication terminal apparatus 52b operates as an access point apparatus in WPS according to the wireless communications of the WiGig system. In the present embodiment, the wireless communication terminal apparatuses 52a and 52b are configured in a manner similar to that of the wireless communication terminal apparatuses 52a and 52b of the third embodiment. Only the points of difference from the third embodiment are described below.

Process for Switchover of Communication System for Data Communications from Wi-Fi System to WiGig System

In the wireless communication system of FIG. 20, when the wireless communication terminal apparatus 52a requests the wireless communication terminal apparatus 52b to perform switchover of the communication system for performing data communications between the wireless communication terminal apparatuses 52a and 52b from the Wi-Fi system to the WiGig system, the communication system switchover request process executed by the WiGig connection control part 59 of the wireless communication terminal apparatus 52a of FIG. 21 are described with reference to FIGS. 34A and 34B, and the communication system switchover response process executed by the WiGig connection control part 59 of the wireless communication terminal apparatus 52b of FIG. 21 are described with reference to FIGS. 35A and 35B. Referring to FIGS. 34A and 34B, processes identical to those of FIG. 13A, 13B, 25A or 25B are denoted by identical step numbers, and no detailed description is provided for them. Moreover, in FIGS. 35A and 35B, processes identical to those of FIG. 14A, 14B, 26A or 26B are denoted by identical step numbers, and no detailed description is provided for them.

At step S1 of FIG. 34A, the WiGig connection control part 59 judges whether or not a switchover instruction signal to instruct performing switchover of the communication system for performing data communications with the wireless communication terminal apparatuses 52b to the WiGig system has been received. The control flow proceeds to step S41 when the answer is YES at step S1 or the process of step S1 is repetitively executed when the answer is NO.

At step S41, the WiGig protocol processing part 10 judges whether or not a wireless communication terminal apparatus capable of performing wireless communications by the WiGig system could be retrieved. Then, the control flow proceeds to step S61 when the answer is YES at step S41 or the communication system switchover request process is ended when the answer is NO. At step S61, the magic value calculating part 62 calculates the magic value of each authentication information stored in the Wi-Fi connection list information managing part 14A, and stores the value into the Wi-Fi connection list information managing part 14A.

Next, at step S82, the magic value adding part 61 transmits the probe request frame 400A including the list of the authentication information identifiers and the magic values stored in the Wi-Fi connection list information managing part 14A of the wireless communication terminal apparatus 52a to the wireless communication terminal apparatus 52b via the connection information control part 5 and the WiGig communication interface 4. In concrete, the magic value adding part 61 sets the list of the authentication information identifiers and the magic values stored in the Wi-Fi connection list information managing part 14A into the network identification information field F9 of the probe request frame generated by the WiGig protocol processing part 10. The format of the probe request frame 400A is described in detail later.

As described in detail later, the wireless communication terminal apparatus 52b transmits a probe response frame 500A to the wireless communication terminal apparatus 52a in response to the probe request frame 400A. The probe response frame 500A includes the list of the authentication information identifiers and the magic values stored in the Wi-Fi connection list information managing part 14A of the wireless communication terminal apparatus 52a.

At step S83 subsequent to step S82, the magic value judging part 63 receives the probe response frame 500A from the wireless communication terminal apparatus 52b via the WiGig communication interface 4 and the connection control part 5. Next, the magic value judging part 63 judges at step S84 whether or not at least one of the magic values stored in the Wi-Fi connection list information managing part 14A is matched with at least one of the magic values included in the probe response frame 500A. Then, the control flow proceeds to step S85 of FIG. 34B when the answer is YES at step S84 or proceeds to step S12A when the answer is NO. In this case, when the wireless communication terminal apparatuses 52a and 52b have been connected to a common access point apparatus by the Wi-Fi system, it is judged that the answer is YES at step S84. Since the processes of step S12A and subsequent steps are identical to the processes of step S12A and subsequent steps of FIG. 25B, no description is provided for them.

At step S85, the magic value judging part 63 selects one magic value from the at least one magic value that is matched with a magic values included in the probe response frame 500A among the magic values stored in the Wi-Fi connection list information managing part 14A. In concrete, the magic value judging part 63 selects the magic value of the authentication information corresponding to the minimum authentication information identifier. It is noted that the magic value judging part 63 may select the magic value of the authentication information capable of achieving the maximum transmission rate. Next, at step S67, the WiGig protocol processing part 10 executes the authentication process and the key distribution process with the wireless communication terminal apparatus 52b by using the authentication information corresponding to the selected magic value, and ends the communication system switchover request process. The process of step S67 is similar to the process of step S10 of FIG. 4B.

It is noted in the present embodiment that the judging process of step S25 of FIG. 14A needs not be executed as compared with the second embodiment. This is because no wireless connection is required to be established by the Wi-Fi system in the present embodiment when wireless connection is established by the WiGig system in a manner similar to that of the third embodiment. In the present embodiment, it is only required that wireless connection is established by the Wi-Fi system in the past and the authentication information when the connection has been established is stored in the Wi-Fi connection list information managing part 14A.

FIGS. 35A and 35B are flow charts showing a communication system switchover request process executed by the WiGig connection control part 59 of the wireless communication terminal apparatus 52b of FIG. 21. Since the processes at steps S21 and S51 of FIG. 35A are similar to the processes at steps S21 and S51 of FIG. 14A, no description is provided for them. The control flow proceeds to step S91 when the answer is YES at step S51 of FIG. 35A. At step S91, the WiGig connection control part 59 receives the probe request frame 400A from the wireless communication terminal apparatus 52a. Subsequently, at step S61, the magic value calculating part 62 calculates the magic value of each authentication information stored in the Wi-Fi connection list information managing part 14A, and stores the value into the Wi-Fi connection list information managing part 14A.

Further, at step S93, the magic value adding part 61 transmits the probe response frame 500A including the list of the authentication information identifiers and the magic values stored in the Wi-Fi connection list information managing part 14A of the wireless communication terminal apparatus 52b to the wireless communication terminal apparatus 52a via the connection information control part 5 and the WiGig communication interface 4. In concrete, the magic value adding part 61 sets the list of the authentication information identifiers and the magic values stored in the Wi-Fi connection list information managing part 14A into the network identification information field F 10 of the probe response frame 500A generated by the WiGig protocol processing part 10. The format of the probe response frame 500A is described in detail later.

Next, the magic value judging part 63 judges at step S94 whether or not at least one of the magic values stored in the Wi-Fi connection list information managing part 14A of the wireless communication terminal apparatus 52a is matched with one of the magic values included in the probe request frame 400A. Then, the control flow proceeds to step S95 of FIG. 35B when the answer is YES at step S94 or proceeds to step S32A of FIG. 35B when the answer is NO. Since the processes of step S32A and subsequent steps are identical to the processes of step S32A and subsequent steps of FIG. 26B, no description is provided for them.

At step S95, the magic value judging part 63 selects one magic value from the at least one magic value that is matched with a magic values included in the probe request frame 400A among the magic values stored in the Wi-Fi connection list information managing part 14A. In concrete, the magic value judging part 63 selects the magic value of the authentication information corresponding to the minimum authentication information identifier. It is noted that the magic value judging part 63 may select the magic value of the authentication information capable of achieving the maximum transmission rate. Next, at step S96, the WiGig protocol processing part 10 executes the authentication process and the key distribution process with the wireless communication terminal apparatus 52a by using the authentication information corresponding to the selected magic value, and ends the communication system switchover request process.

### Format of Probe Request Frame 400a

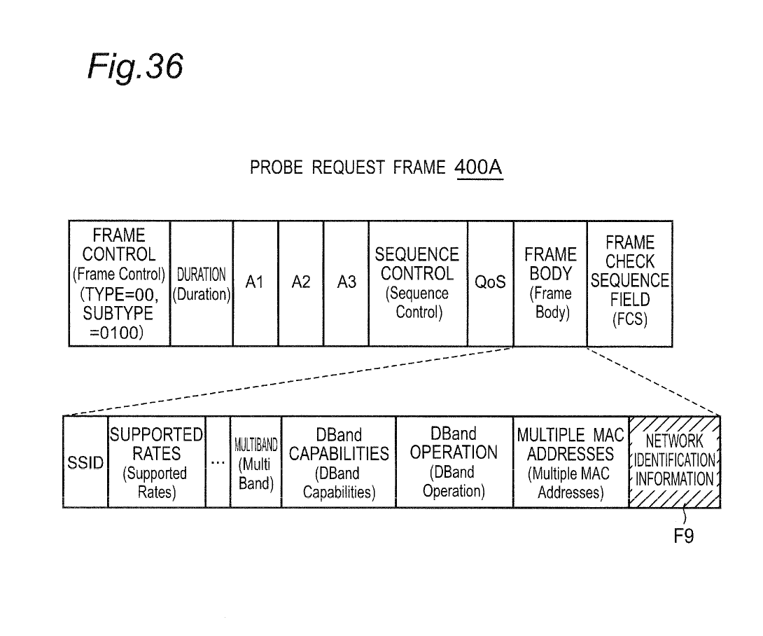

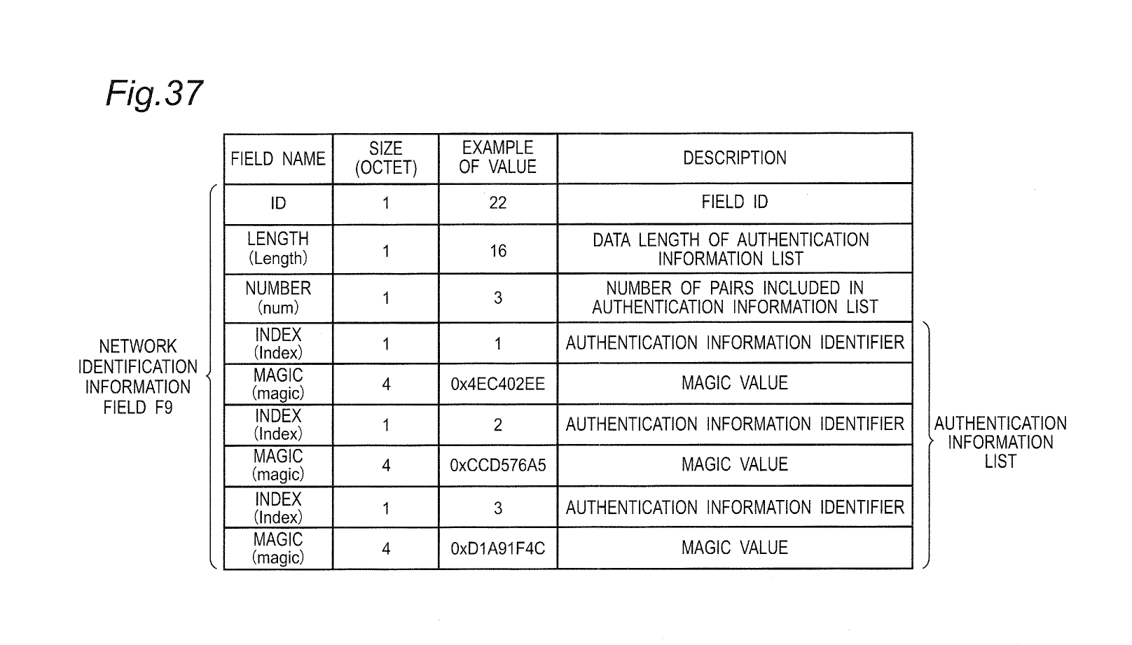

FIG. 36 is a format chart showing a format of the probe request frame 400A transmitted at step S82 of FIG. 34A. Referring to FIG. 36, the probe request frame 400A differs from the probe request frame 400 of FIG. 15 only in that a network identification information field F9 is provided in place of the network identification information field F4 of FIG. 15. FIG. 37 is a table showing a format of the network identification information field F9 of FIG. 36. Referring to FIG. 37, the network identification information field F9 is configured in a manner similar to that of the network identification information field F6 of FIG. 28.

### Format of Probe Response Frame 500A

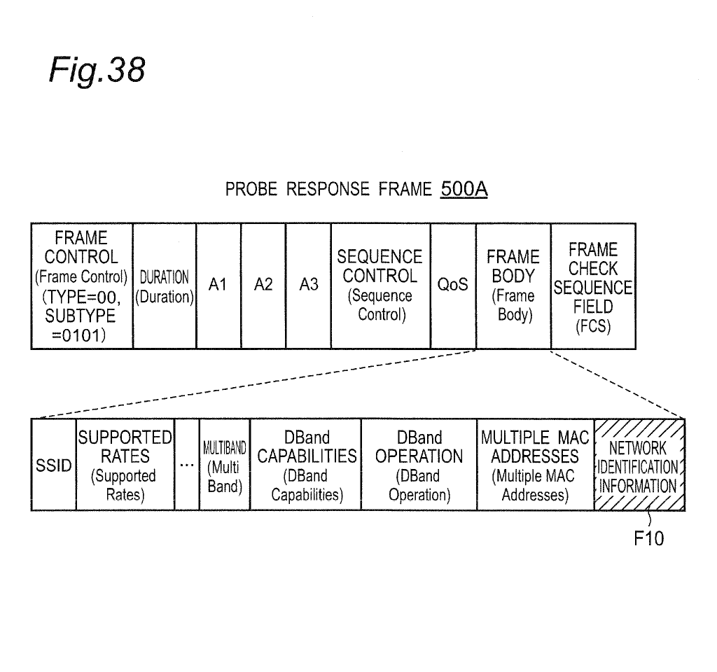

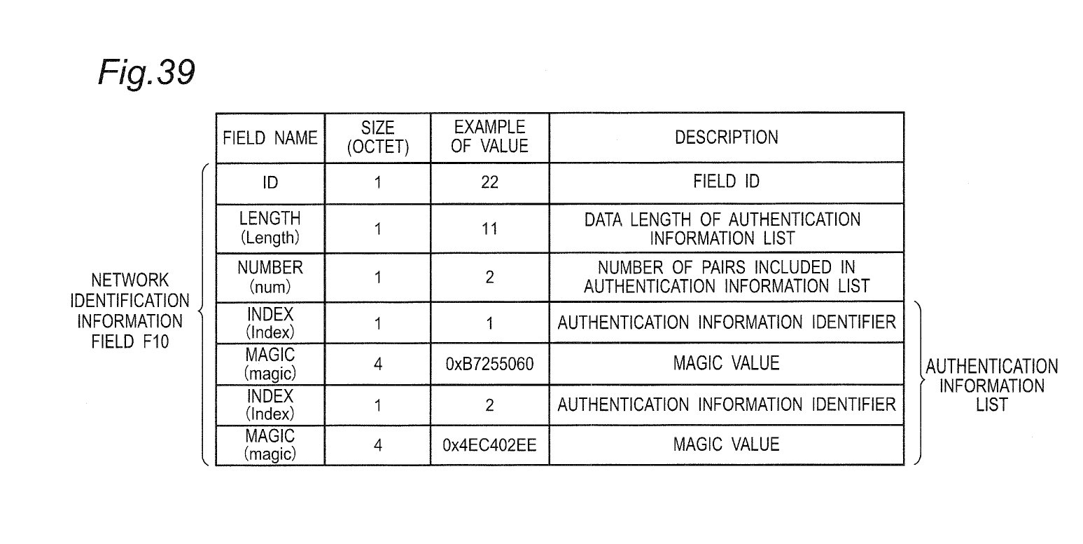

FIG. 38 is a table showing a format of the probe response frame 500A transmitted at step S93 of FIG. 35A. Referring to FIG. 38, the probe response frame 500A differs from the probe response frame 500 of FIG. 17 only in that a network identification information field F10 is provided in place of the network identification information field F5. FIG. 39 is a table showing a format of the network identification information field F10 of FIG. 38. Referring to FIG. 39, the network identification information field F10 is configured in a manner similar to that of the network identification information field F7 of FIG. 30.

### Operation Example of Wireless Communication System

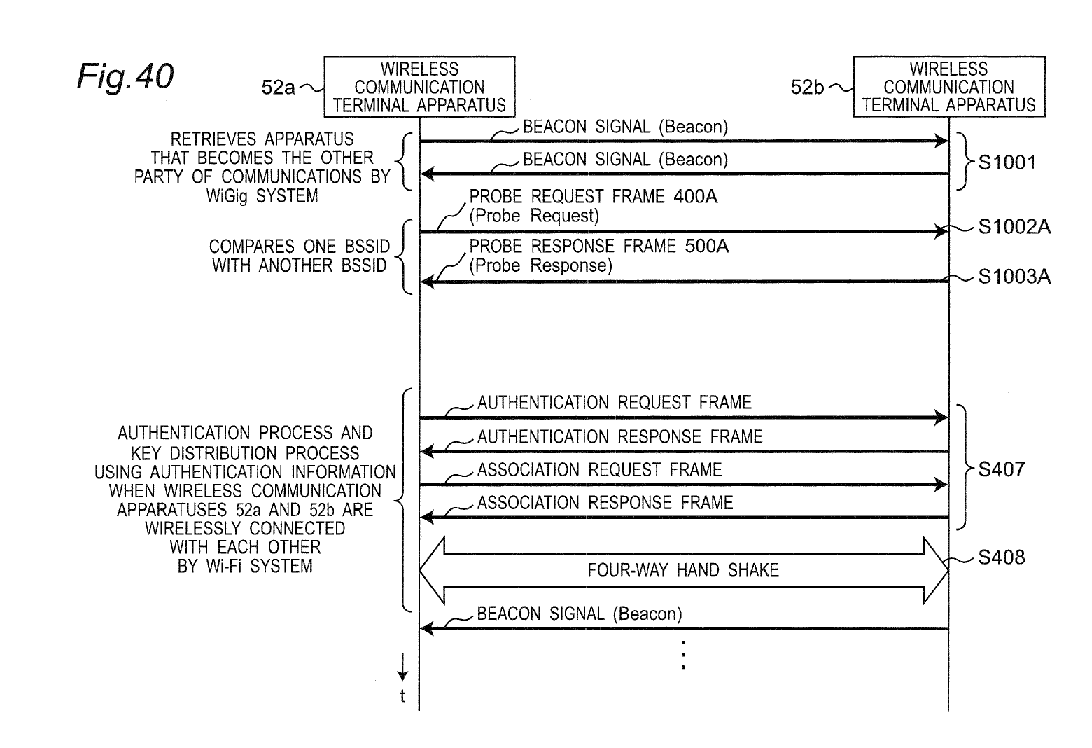

FIG. 40 is a timing chart showing one example of the operation of the wireless communication system of FIG. 20 according to the fourth embodiment. In the timing chart of FIG. 40, steps S1002 and S 1003 of the timing chart of FIG. 20 are replaced by steps S1002A and S1003A. Only the points of difference from FIG. 20 are described below.

At step S 1002A, the wireless communication terminal apparatus 52a transmits the probe request frame 400A to the wireless communication terminal apparatus 52b. In response to this, the wireless communication terminal apparatus 52b transmits the probe response frame 500A to the wireless communication terminal apparatus 52a at step S1003A. Subsequently, the wireless communication terminal apparatus 52a compares the magic values included in the probe response frame as a reply from the wireless communication terminal apparatus 52b with the magic values stored in the Wi-Fi connection list information managing part 14A of the wireless communication terminal apparatus 52a, and judges whether or not a coinciding magic value exists. As a result, when there is a coinciding magic value, wireless connection by the WiGig system is established by executing the sequence of steps S407 and S408 by using the authentication information corresponding to the magic value.

The wireless communication system of the present embodiment has actions and advantageous effects similar to those of the wireless communication system of the third embodiment. Further, according to the present embodiment, there is no need to transmit a frame corresponding to the group owner negotiation confirmation frame 300A as compared with the third embodiment. Therefore, the communication system for data communications can be switched over from the Wi-Fi system to the WiGig system more easily and promptly than in the third embodiment.

### Other Embodiments

As described above, the aforementioned embodiments have been described as illustrations of the technology disclosed in the present application. However, the technology of the present disclosure is not limited to this but applicable to embodiments that are arbitrarily subjected to alterations, replacements, additions and omissions. Moreover, it is also possible to provide a new embodiment by combining the constituent elements described in each of the aforementioned embodiments. Accordingly, other embodiments are illustrated below.

Although the wireless communication system of each of the aforementioned embodiments is configured to include the two wireless communication terminal apparatuses 2a and 2b or the two wireless communication terminal apparatuses 52a and 52b, the present disclosure is not limited to this. The wireless communication system may be configured to include three or more wireless communication terminal apparatuses.

Moreover, although the present disclosure has been described by taking the Wi-Fi system and the WiGig system as examples in each of the aforementioned embodiments, the present disclosure is not limited to this. The present disclosure can be applied to two communication systems that can execute the authentication process by using common authentication information. In this case, at least one of the communication frequency band and the modulation method may be different in terms of the physical level or the logical level.

Further, although the wireless communication terminal apparatuses 2b and 52b operate as the group owner apparatuses in each of the aforementioned embodiments, the present disclosure is not limited to this. The wireless communication terminal apparatuses 2a and 52a may operate as the group owner apparatuses.

Further, although the authentication information includes the SSID, the encryption method, the authentication method, and the encryption key information (See FIG. 2) in the third and fourth embodiments, the present disclosure is not limited to this. The authentication information may include information of communication characteristics of throughput or the like. In this case, it is acceptable to select one magic value on the basis of the information of the communication characteristics included in the authentication information at step S65 of FIG. 25B and step S85 of FIG. 34B. With this arrangement, suitable authentication information can be selected according to, for example, the purpose of communications when connection is newly established by the WiGig system.

Although it is judged whether or not the wireless communication terminal apparatuses 52a and 52b have common authentication information for wireless communications by the Wi-Fi system by using the magic value corresponding to the authentication information in the third and fourth embodiments, the present disclosure is not limited to this, and the judgment may be made by using a predetermined value to identify the authentication information. It is noted that a process for making the aforementioned judgment can also be performed by using the authentication information itself. However, the amount of information to be exchanged between the wireless communication terminal apparatuses 52a and 52b increases in this case, and the security of information is degraded when the authentication information is intercepted by the third party at the time of transceiving the authentication information as it is. Therefore, it is preferable to use the information by converting it into another value instead of using the authentication information itself. For example, the magic value calculating part 62 may shorten the data length of the magic value by performing a CRC (Cyclic Redundancy Check) process for the magic value calculated by using the authentication information. With this arrangement, the process for the aforementioned judgment can be executed with securing a small amount of information and high security.

Moreover, although the authentication information used in wireless communications in the Wi-Fi format is entirely used for wireless communications in the WiGig format in the third and fourth embodiments, the present disclosure is not limited to this, and part of the authentication information used in the wireless communications in the Wi-Fi format may be used for the wireless communications in the WiGig format. For example, only the encryption key information in the authentication information used in the wireless communications in the Wi-Fi format may be used for the wireless communications in the WiGig format. With this arrangement, the transmitting process of the information of the encryption key that needs most processing time in WPS can be omitted.

Further, although the authentication information acquired for establishing wireless connection by the Wi-Fi system is utilized for establishing wireless connection by the WiGig system in the third and fourth embodiments, the present disclosure is not limited to this. For example, the authentication information acquired for establishing wireless connection by the WiGig system may be utilized again at the time of establishing wireless connection by the WiGig system.

### SUMMARY OF EMBODIMENTS

As described above, according to the first and second embodiments, the authentication information used when wireless connection has been established by the Wi-Fi system is used for the authentication process at the time of establishing wireless connection by the WiGig system, the process for establishing wireless connection by the WiGig system can be reduced. In this case, it is judged whether or not the authentication information used when wireless connection has been established by the Wi-Fi system can be used as authentication information for establishing wireless connection by the WiGig system on the basis of the network identification information of the network to which, the wireless communication terminal apparatus 2a has belonged when the wireless communication terminal apparatus 2a has established wireless connection by the Wi-Fi system and the network identification information of the network to which the wireless communication terminal apparatus 2b has belonged when the wireless communication terminal apparatus 2b has established wireless connection by the Wi-Fi system. In this case, although the network identification information is BSSID in the first and second embodiments, the present disclosure is not limited to this, and it is only required to be information capable of identifying the network.

Moreover, since the authentication information includes the SSID, the encryption method, the authentication method and the encryption key information in the first to fourth embodiments, the process for establishing wireless connection by the WiGig system can be simplified, and the processing time can be shortened. This is because a mediation process concerning the encryption and mediation processes concerning the authentication is dominant in the processing time for establishing wireless connection by the WiGig system.

Further, the wireless communication terminal apparatuses 2a, 2b, 52a and 52b may transmit the connection information included in the Beacon signal or the communication frame such as the probe request frame or the probe response frame. For example, by using the Beacon signal, detection of the wireless communication terminal apparatus that becomes the other party of communications and acquisition of the connection information and the like owned by the wireless communication terminal apparatus that becomes the other party of communications can be simultaneously performed. On the other hand, by using a communication frame other than the Beacon signal, it becomes possible to transmit the connection information only to a specific wireless communication terminal apparatus, allowing the security of information to be comparatively maintained.

Although the two BSSIDs are compared with each other (step S8 of FIG. 4B and step S45 of FIG. 13B) in the first and second embodiments, the present disclosure is not limited to this. It is acceptable to compare two or more pieces of information included in the connection information. Moreover, when the communication system is switched over from the Wi-Fi system to the WiGig system, it is preferable to use the connection information concerning the communication system by which connection has been established at the point of time. With this arrangement, the process for switchover can be performed more promptly. In particular, when switchover is performed from the communications by the Wi-Fi system via the access point apparatus to the communications by the WiGig system of direct pathway without via the access point apparatus, the process for switchover can be executed more promptly.

When the wireless communication terminal apparatus is a mobile terminal, the wireless communication terminal apparatus moves, and the access point apparatus of the destination of connection changes comparatively frequently. In this case, it is proper to use not limitatively the authentication information used for establishing connection at the present time but also the authentication information used for establishing connection in the past in a manner similar to that of the third and fourth embodiments. With this arrangement, when the access point apparatus of the destination of connection changes, the connecting process can be performed more promptly than that of the prior art also when the communication system is switched over to the WiGig system.

As described above, the embodiments have been described as illustrations of the technology of the present disclosure. For the above purpose, the accompanying drawings and the detailed explanation are provided.

Therefore, the constituent elements described in the accompanying drawings and the detailed description possibly include not only the indispensable constituent elements for solving the problems but also the constituent elements that are not indispensable for solving the problems in illustrating the technology. Therefore, it should not be certified that those dispensable components are immediately accredited to be indispensable with the fact that those dispensable constituent elements are described in the accompanying drawings and the detailed description.

Moreover, the aforementioned embodiments, which illustrate the technology of the present disclosure, are therefore subject to various alterations, replacements, additions and omissions within the scope of the claims or the equivalent scope.

The present disclosure can be utilized for wireless communication terminal apparatuses that support a plurality of communication systems. In this case, the wireless communication terminals are the apparatuses of, for example, portable telephones, personal computers, transmits and receives.

Although the present invention has been fully described in connection with the embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A wireless communication system comprising first and second wireless communication terminal apparatuses that are wirelessly connected with each other by one of a predetermined first communication system and a predetermined second communication system, by executing an authentication process by using authentication information for establishing wireless connection,
wherein the first wireless communication terminal apparatus comprises:
a first connection information managing part configured to store authentication information used when the first wireless communication terminal apparatus has established wireless connection by the first communication system, and first network identification information of a first network to which the first wireless communication terminal apparatus has belonged when the first wireless communication terminal apparatus has established wireless connection by the first communication system; and
a first connection control part configured to establish wireless connection by the second communication system,
wherein the second wireless communication terminal apparatus comprises:
a second connection information managing part configured to store authentication information used when the second wireless communication terminal apparatus has established wireless connection by the first communication system, and second network identification information of a second network to which the second wireless communication terminal apparatus has belonged when the second wireless communication terminal apparatus has established wireless connection by the first communication system; and
a second connection control part configured to establish wireless connection by the second communication system,
wherein the first connection control part transmits a request frame that is provided for requesting establishment of wireless connection by the second communication system and includes the first network identification information, to the second wireless communication terminal apparatus,
wherein the second connection control part transmits a response frame including the second network identification information, to the first wireless communication terminal apparatus in response to the request frame, and
wherein the first connection control part compares the second network identification information included in the response frame with the first network identification information stored in the first connection information managing part in response to the response frame, and executes an authentication process with the second wireless communication terminal apparatus by using the authentication information stored in the first connection information managing part when the second network identification information included in the response frame is matched with the first network identification information stored in the first connection information managing part, thereby establishing wireless connection with the second wireless communication terminal apparatus by the second communication system.

2. The wireless communication system as claimed in claim 1,
wherein, when the second network identification information included in the response frame is not matched with the first network identification information stored in the first connection information managing part, the first connection control part acquires authentication information for establishing wireless connection with the second wireless communication terminal apparatus by the second communication system by executing a predetermined authentication information acquiring process, and executes an authentication process with the second wireless communication terminal apparatus by using the acquired authentication information.

3. The wireless communication system as claimed in claim 1,
wherein the first connection control part transmits a confirmation frame that includes comparing results between the second network identification information included in the response frame and the first network identification information stored in the first connection information managing part, to the second wireless communication terminal apparatus.

4. The wireless communication system as claimed in claim 3,
wherein the request frame is a group owner negotiation request frame compliant to Wi-Fi Direct,
wherein the response frame is a group owner negotiation response frame compliant to Wi-Fi Direct, and
wherein the confirmation frame is a group owner negotiation confirmation frame compliant to Wi-Fi Direct.

5. The wireless communication system as claimed in claim 1,
wherein the authentication information includes a service set identifier, an encryption method, an authentication method, and encryption key information.

6. The wireless communication system as claimed in claim 1,
wherein a frequency band used by the first communication system and a frequency band used by the second communication system are different from each other.

7. The wireless communication system as claimed in claim 1,
wherein the first communication system is a Wi-Fi system by which the first and second wireless communication terminal apparatuses perform wireless communications via an access point apparatus,
wherein the second communication system is a WiGig system by which the first and second wireless communication terminal apparatuses perform wireless communications without via the access point apparatus, and
wherein the network identification information is a basic service set identifier of the access point apparatus.

8. A control method for use in a wireless communication system comprising first and second wireless communication terminal apparatuses that are wirelessly connected with each other by one of a predetermined first communication system and a predetermined second communication system, by executing an authentication process by using authentication information for establishing wireless connection,
wherein the first wireless communication terminal apparatus comprises:
a first connection information managing part configured to store authentication information used when the first wireless communication terminal apparatus has established wireless connection by the first communication system, and first network identification information of a first network to which the first wireless communication terminal apparatus has belonged when the first wireless communication terminal apparatus has established wireless connection by the first communication system; and
a first connection control part configured to establish wireless connection by the second communication system,
wherein the second wireless communication terminal apparatus comprises:
a second connection information managing part configured to store authentication information used when the second wireless communication terminal apparatus has established wireless connection by the first communication system, and second network identification information of a second network to which the second wireless communication terminal apparatus has belonged when the second wireless communication terminal apparatus has established wireless connection by the first communication system; and
a second connection control part configured to establish wireless connection by the second communication system,
wherein the control method includes steps of:
by the first connection control part, transmitting a request frame that is provided for requesting establishment of wireless connection by the second communication system and includes the first network identification information, to the second wireless communication terminal apparatus;
by the second connection control part, transmitting a response frame including the second network identification information, to the first wireless communication terminal apparatus in response to the request frame; and
by the first connection control part, comparing the second network identification information included in the response frame with the first network identification information stored in the first connection information managing part in response to the response frame by the first connection control part, and executing an authentication process with the second wireless communication terminal apparatus by using the authentication information stored in the first connection information managing part when the second network identification information included in the response frame is matched with the first network identification information stored in the first connection information managing part, thereby establishing wireless connection with the second wireless communication terminal apparatus by the second communication system.

9. A wireless communication terminal apparatus serving as a first wireless communication terminal apparatus for use in a wireless communication system comprising first and second wireless communication terminal apparatuses that are wirelessly connected with each other by one of a predetermined first communication system and a predetermined second communication system by executing an authentication process by using authentication information for establishing wireless connection,
wherein the first wireless communication terminal apparatus comprises:
a first connection information managing part configured to store authentication information used when the first wireless communication terminal apparatus has established wireless connection by the first communication system, and first network identification information of a first network to which the first wireless communication terminal apparatus has belonged when the first wireless communication terminal apparatus has established wireless connection by the first communication system; and
a first connection control part configured to establish wireless connection by the second communication system,
wherein the second wireless communication terminal apparatus comprises:
a second connection information managing part configured to store authentication information used when the second wireless communication terminal apparatus has established wireless connection by the first communication system, and second network identification information of a second network to which the second wireless communication terminal apparatus has belonged when the second wireless communication terminal apparatus has established wireless connection by the first communication system; and
a second connection control part configured to establish wireless connection by the second communication system,
wherein the first connection control part transmits a request frame that is provided for requesting establishment of wireless connection by the second communication system and includes the first network identification information, to the second wireless communication terminal apparatus, and
wherein the first connection control part compares the second network identification information included in the response frame with the first network identification information stored in the first connection information managing part in response to the response frame, which has been transmitted by the second wireless communication terminal apparatus in response to the request frame and includes the second network identification information of the second network to which the second wireless communication terminal apparatus has belonged when the second wireless communication terminal apparatus has established wireless connection by the first communication system, and
the first connection control part executes an authentication process with the second wireless communication terminal apparatus by using the authentication information stored in the first connection information managing part when the second network identification information included in the response frame is matched with the first network identification information stored in the first connection information managing part, thereby establishing wireless connection with the second wireless communication terminal apparatus by the second communication system.

10. A wireless communication terminal apparatus serving as a second wireless communication terminal apparatus for use in a wireless communication system comprising first and second wireless communication terminal apparatuses that are wirelessly connected with each other by one of a predetermined first communication system and a predetermined second communication system, by executing an authentication process by using authentication information for establishing wireless connection,
wherein the first wireless communication terminal apparatus comprises:
a first connection information managing part configured to store authentication information used when the first wireless communication terminal apparatus has established wireless connection by the first communication system, and first network identification information of a first network to which the first wireless communication terminal apparatus has belonged when the first wireless communication terminal apparatus has established wireless connection by the first communication system; and
a first connection control part configured to establish wireless connection by the second communication system,
wherein the second wireless communication terminal apparatus comprises:
a second connection information managing part configured to store authentication information used when the second wireless communication terminal apparatus has established wireless connection by the first communication system, and second network identification information of a second network to which the second wireless communication terminal apparatus has belonged when the second wireless communication terminal apparatus has established wireless connection by the first communication system; and
a second connection control part configured to establish wireless connection by the second communication system, and
wherein the second connection control part transmits a response frame including the second network identification information, to the first wireless communication terminal apparatus, in response to receiving a request frame that is provided for requesting establishment of wireless connection by the second communication system and includes the first network identification information, from the first wireless communication terminal apparatus.
